(19) United States
(12) Patent Application Publication
(10) Pub. No.: US 2014/0244228 A1
(43) Pub. Date: Aug. 28, 2014

(54) CODON OPTIMIZATION OF A SYNTHETIC GENE(S) FOR PROTEIN EXPRESSION

(71) Applicants: AGENCY FOR SCIENCE, TECHNOLOGY AND RESEARCH, SINGAPORE (SG); NATIONAL UNIVERSITY OF SINGAPORE, SINGAPORE (SG)

(72) Inventors: Dong-Yup LEE, Singapore (SG); Bevan Kai Sheng CHUNG, Singapore (SG); Yuansheng YANG, Singapore (SG)

(73) Assignees: AGENCY FOR SCIENCE, TECHNOLOGY AND RESEARCH, SINGAPORE (SG); NATIONAL UNIVERSITY OF SINGAPORE, SINGAPORE (SG)

(21) Appl. No.: 14/031,426

(22) Filed: Sep. 19, 2013

Related U.S. Application Data
(60) Provisional application No. 61/702,795, filed on Sep. 19, 2012.

(51) Int. Cl. G06F 19/12

(52) U.S. Cl. CPC G06F 19/12
USPC 703/11

(57) ABSTRACT

The present disclosure is related to a method of optimization of a nucleotide coding sequence coding for an amino acid sequence, wherein the nucleotide coding sequence is optimized for expression in a host cell. The present disclosure also relates to system for optimizing a nucleotide coding sequence coding for an amino acid sequence, wherein the nucleotide coding sequence is optimized for expression in a host cell.

### CROSS REFERENCE TO RELATED APPLICATIONS

This application claims priority to and is a conversion of U.S. Provisional Application No. 61/702,795, entitled “Codon Context Optimization for Design of Synthetic Gene” filed on 19 Sep. 2012, which is incorporated herein by reference in its entirety.

### TECHNICAL FIELD

The present disclosure is related to a method of optimization of a nucleotide coding sequence coding for an amino acid sequence, wherein the nucleotide coding sequence is optimized for expression in a host cell. The present disclosure also relates to system for optimizing a nucleotide coding sequence coding for an amino acid sequence, wherein the nucleotide coding sequence is optimized for expression in a host cell. In particular, the present disclosure relates to codon optimization.

### BACKGROUND

Recent developments in artificial gene synthesis have enabled the construction of synthetic gene circuits and even the synthesis of the whole bacterial genome. The introduction of synthetic genes into a living system can either modulate existing biological functions or give rise to novel cellular behavior. In this sense, de novo gene synthesis is a valuable synthetic biological tool for biotechnological studies, which typically aims to improve tolerance to toxic molecules, retrofit existing biosynthetic pathways, design novel biosynthetic pathways and/or enhance heterologous protein production. In the aspect of recombinant protein production, natural genes found in wild-type organisms are usually transformed into the heterologous hosts for recombinant expression. This approach typically results in poorly expressed recombinant protein since the wild-type foreign genes have not been evolved for optimum expression in the host. Thus, it is highly desirable to harness the flexibility in synthetic biology to create customized artificial gene designs that are optimal for heterologous protein expression. To aid the gene design process, computational tools have been developed for designing coding sequences based on some performance criteria. Specifically, the degeneracy of the genetic code, reflected by the use of sixty-four codons to encode twenty amino acids and translation termination signal, leads to the situation whereby all amino acids, except methionine and tryptophan, can be encoded by two to six synonymous codons. Notably, the synonymous codons are not equally utilized to encode the amino acids, thus resulting in phenomenon of codon usage bias which was first reported in a study that examines the frequencies of 61 amino acid codons (i.e. termination codons are excluded) in 90 genes. The emergence of codon usage bias in organisms has been largely attributed to natural selection, mutation, and genetic drift. More importantly, codon usage bias has been shown to be correlated to gene expression level. As a result, this bias has been proposed as an important design parameter for enhancing recombinant protein production in heterologous expression hosts. Consequently, the algorithms implemented in many of the sequence design software tools, such as Codon optimizer, Gene Designer, and OPTIMIZER, are mainly focused on the frequency of individual codon occurrences. Notably, the popular web-based software, known as the Java Codon Adaptation Tool (JCat), is integrated with the PRODORIC database to allow convenient retrieval of prokaryotic genetic information. However, apart from individual codon usage (ICU) bias, non-random utilization of adjacent codon pairs in organisms has also been reported in several studies. This phenomenon is termed “codon context” as it implicates some “rule” for organizing neighboring codons as a result of potential tRNA-tRNA steric interaction within the ribosomes. Codon context (CC) was shown to correlate with translation elongation rate such that the usage of rare codon pairs decreased protein translation rates. Therefore, the incorporation of CC has been proposed in the conventional ICU-based gene optimization algorithm GeneOptimizer. Furthermore, a technology, known as “Translation Engineering”, demonstrated that better enhancement in translational efficiency is achievable by optimizing codon pair usage in addition to ICU optimization.

### SUMMARY

The advent of synthetic biology has allowed biologists great flexibility to modulate an organism's physiology via introduction of synthetic biomolecules. The manipulation of cellular behavior is usually accomplished through recombinant DNA technology. The ability to synthesize artificial DNA de novo allows the flexibility to customize genetic sequences. Therefore, the rational design of synthetic genes can be a crucial component to overcome the frequently encountered problem of low heterologous protein productivity in commonly used expression systems such as Escherichia coli, P. pastoris and S. cerevisiae. Toward this end, the codon context optimization computational framework is developed to optimize synthetic gene such that the designed coding DNA sequence is able to achieve high in vivo protein expression. The codon context optimization algorithm optimizes any DNA sequence by systematically altering the synonymous codons for each amino acid in the target protein sequence, resulting in an optimal DNA sequence with a codon arrangement that allows efficient expression of the protein product. The computational procedure is based on the principle that the interaction between adjacent codons in a coding sequence can affect protein expression efficiency. Hence, by identifying favorable codon pairing arrangements via the processing of omics information obtained from the expression hosts, any coding sequence can be computationally optimized such that it will exhibit a favorable distribution of codon pairs to allow efficient protein expression in the respective host organisms.

A first aspect of the present disclosure provides a computer implemented method of optimization of a nucleotide coding sequence coding for a predetermined amino acid sequence, wherein the nucleotide coding sequence is optimized for expression in a predetermined host cell, wherein the method can comprise: automatically generating at least two initial nucleotide coding sequences coding for the predetermined amino acid sequence to form a first population of initial nucleotide coding sequences coding for the predetermined amino acid sequence; and automatically dividing the first population of initial nucleotide coding sequences.

In some embodiments, the method described above can further comprise: automatically determining a fitness value for each of the initial nucleotide coding sequences of the first population using a fitness function that determines codon context fitness for the predetermined host cell.

In some embodiments, the method described above can further comprise: automatically ranking each of the initial nucleotide coding sequences of the first population according to the fitness value of each of the initial nucleotide coding sequences of the first population.

In some embodiments, the dividing described above can comprise automatically dividing the first population of initial nucleotide coding sequences according to the fitness value ranking of each of the initial nucleotide coding sequences of the first population, wherein the top fifty percent of the initial nucleotide coding sequences having the highest fitness value ranking are selected as first parent nucleotide coding sequences.

In some embodiments, the method described above can further comprise: automatically producing first offspring nucleotide coding sequences via recombination and/or mutation of the first parent nucleotide coding sequences.

In some embodiments, the method described above can further comprise: automatically combining the first offspring nucleotide coding sequences and the first parent nucleotide coding sequences to form a second population of nucleotide coding sequences.

In some embodiments, the method described above can further comprise: automatically determining a fitness value for each of the nucleotide coding sequences of the second population using a fitness function that determines codon context fitness for the predetermined host cell; automatically ranking each of the nucleotide coding sequences of the second population according to the fitness value of each of the nucleotide coding sequences of the second population; automatically dividing the second population of nucleotide coding sequences according to the fitness value ranking of each of the nucleotide coding sequences of the second population, wherein the top fifty percent of the nucleotide coding sequences of the second population having the highest fitness value ranking are selected as a second parent nucleotide coding sequences; automatically producing second offspring nucleotide coding sequences via recombination and/or mutation of the second parent nucleotide coding sequences; and automatically combining the second offspring nucleotide coding sequences and the second parent nucleotide coding sequences to form a third population of nucleotide coding sequences.

In some embodiments, the optimization of the nucleotide coding sequence coding for the predetermined amino acid sequence described above can be automatically repeated until a predetermined termination criterion is met.

A second aspect of the present disclosure provides a system that can comprise: a processing unit; a memory unit comprising an optimizing module, wherein the optimizing module comprises a set of program instructions executable by the processing unit; wherein execution of the set of program instructions causes the processing unit to optimize a nucleotide coding sequence coding for a predetermined amino acid sequence, wherein the nucleotide coding sequence is optimized for expression in a predetermined host cell, the optimization comprising: automatically generating at least two initial nucleotide coding sequences coding for the predetermined amino acid sequence to form a first population of initial nucleotide coding sequences coding for the predetermined amino acid sequence; and automatically dividing the first population of initial nucleotide coding sequences.

In some embodiments, the optimization described above can further comprise: automatically determining a fitness value for each of the initial nucleotide coding sequences of the first population using a fitness function that determines codon context fitness for the predetermined host cell.

In some embodiments, the optimization described above can further comprise: automatically ranking each of the initial nucleotide coding sequences of the first population according to the fitness value of each of the initial nucleotide coding sequences of the first population.

In some embodiments, the dividing described above can comprise automatically dividing the first population of initial nucleotide coding sequences according to the fitness value ranking of each of the initial nucleotide coding sequences of the first population, wherein the top fifty percent of the initial nucleotide coding sequences having the highest fitness value ranking are selected as first parent nucleotide coding sequences.

In some embodiments, the optimization described above can further comprise: automatically producing first offspring nucleotide coding sequences via recombination and/or mutation of the first parent nucleotide coding sequences.

In some embodiments, the optimization described above can further comprise: automatically combining the first offspring nucleotide coding sequences and the first parent nucleotide coding sequences to form a second population of nucleotide coding sequences.

In some embodiments, the optimization described above can further comprise: automatically determining a fitness value for each of the nucleotide coding sequences of the second population using a fitness function that determines codon context fitness for the predetermined host cell; automatically ranking each of the nucleotide coding sequences of the second population according to the fitness value of each of the nucleotide coding sequences of the second population; automatically dividing the second population of nucleotide coding sequences according to the fitness value ranking of each of the nucleotide coding sequences of the second population, wherein the top fifty percent of the nucleotide coding sequences of the second population having the highest fitness value ranking are selected as a second parent nucleotide coding sequences; automatically producing second offspring nucleotide coding sequences via recombination and/or mutation of the second parent nucleotide coding sequences; and automatically combining the second offspring nucleotide coding sequences and the second parent nucleotide coding sequences to form a third population of nucleotide coding sequences.

In some embodiments, the optimization of the nucleotide coding sequence coding for the predetermined amino acid sequence by the system described above can be automatically repeated until a predetermined termination criterion is met.

### BRIEF DESCRIPTION OF THE DRAWINGS

FIG. 1 is a block diagram of a system for codon optimization in accordance with an embodiment of the present disclosure.

FIG. 2 illustrates a multi-objective codon optimization solution in accordance with an embodiment of the present disclosure, in which optimal solutions generated by multi-objective codon optimization (MOCO) lies on the pareto front.

FIG. 3 illustrates a general codon optimization workflow in accordance with an embodiment of the present disclosure, wherein during codon optimization, either individual codon usage optimization (ICO), codon context optimization (CCO) or MOCO can be used for sequence optimization.

FIG. 4 illustrates principal component analysis (PCA) of individual codon usage (ICU) and codon context (CC) distributions, in which first and second principal components (PC1 and PC2) are plotted to show the differences in the ICU and CC distributions of (top 5%) high-expression genes (H), (bottom 5%) low-expression genes (L) and all genes (A) found in the genomes of E. coli (EC), L. lactis (LL), P. pastoris (PP) and S. cerevisiae (SC). The unbiased distribution (U) is also included for each plot as reference.

FIGS. 5A and 5B illustrate codon optimization validation, in which in silico cross-validation of the optimization procedures is performed according to the presented workflow.

FIGS. 6A and 6B illustrate a codon context optimization algorithm in accordance with an embodiment of the present disclosure.

FIG. 7 illustrates a comparison of performance of codon optimization methods.

FIGS. 8A and 8B illustrates a comparison of Chinese hamster ovary (CHO) genes' codon patterns in terms of ICU, in which points corresponding to the highly and lowly expressed genes are indicated as “high” and “low”, respectively. The bottom PCA plot illustrates the differences in average ICU distribution among the three groups of genes (H, M and L) across the various expression hosts.

FIGS. 9A and 9B illustrates a comparison of CHO genes' codon patterns in terms of CC, in which points corresponding to the highly and lowly expressed genes are indicated as “high” and “low”, respectively. The bottom PCA plot illustrates the differences in average CC distribution among the three groups of genes (H, M and L) across the various expression hosts.

FIG. 10 illustrates an expression of interferon genes in CHO cells.

FIGS. 11A-11C illustrates expression levels and codon patterns of IFN-γ genes, in which expression values of IFN-γ genes measured with ELISA are normalized with respect to the level of IFN_WT such that it has a value of 1. The individual codon frequency is shown by the color of the codon itself while the codon pair frequency is indicated by the color of the rectangular block between adjacent codons.

FIGS. 12A and 12B illustrates multiple ICU optimal sequences, wherein it will be understood that many combinatorial coding sequences can attain the same ICU fitness via the interchange of codons, e.g., between Ser-4 and Ser-18. Hence, it is common to have many optimal sequences with equal ICU fitness, similar to the sequences illustrated in the figure.

FIG. 13 illustrates hierarchical clustering of optimized genes based on ICU distributions, wherein euclidean distance is used as the distance measure.

FIG. 14 illustrates hierarchical clustering of optimized genes based on CC distributions, wherein euclidean distance is used as the distance measure.

FIG. 15 illustrates ICU and CC fitness of MFLS gene variants.

FIG. 16 illustrates codon usage patterns of the MFLS gene variants, wherein colors of individual codons and codon pairs (represented by small rectangular blocks between adjacent codons) indicate the usage frequency with respect to the P. pastoris host, as indicated by the gradient at the top of the figure.

FIGS. 17A-17D illustrates properties of MFLS gene variants, wherein correlation between ICU, CC fitness and gene expressivity is illustrated (FIG. 17A), and CAI, G+C content and mRNA folding energy, calculated by mfold, of the gene variants are also plotted (FIGS. 17B-D).

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments can be utilized, and other changes can be made, without departing from the spirit or scope of the subject matter presented herein.

Unless specified otherwise, the terms “comprising” and “comprise” as used herein, and grammatical variants thereof, are intended to represent “open” or “inclusive” language such that they include recited elements but also permit inclusion of additional, un-recited elements. As used herein, the term “about”, in the context of concentrations of components, conditions, other measurement values, etc., means +/−5% of the stated value, or +/−4% of the stated value, or +/−3% of the stated value, or +/−2% of the stated value, or +/−1% of the stated value, or +/−0.5% of the stated value, or +/−0% of the stated value.

As used herein, the term “set” corresponds to or is defined as a non-empty finite organization of elements that mathematically exhibits a cardinality of at least 1 (i.e., a set as defined herein can correspond to a unit, singlet, or single element set, or a multiple element set), in accordance with known mathematical definitions (for instance, in a manner corresponding to that described in An Introduction to Mathematical Reasoning: Numbers, Sets, and Functions, “Chapter 11: Properties of Finite Sets” (e.g., as indicated on p. 140), by Peter J. Eccles, Cambridge University Press (1998)). In general, an element of a set can include or be a system, an apparatus, a device, a structure, an object, a process, a physical parameter, or a value depending upon the type of set under consideration.

Throughout this disclosure, certain embodiments may be disclosed in a range format. It should be understood that the description in range format is merely for convenience and brevity and should not be construed as an inflexible limitation on the scope of the disclosed ranges. Accordingly, the description of a range should be considered to have specifically disclosed all the possible sub-ranges as well as individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

### Abbreviations

ICU: Individual codon usage; CC: Codon-pair context; MFLS: Saccharomyces cerevisiae-derived mating factor α prepro-leader sequence; ICO: ICU-based codon optimization; CCO: CC-based codon optimization; MOCO: Multi-objective codon optimization; CALB: Lipase B from Candida antarctica; P_{TEF}: Pichia pastoris-derived TEF promoter.

Codon optimization can be applied to any life science research area, allowing biologists to systematically enhance the expression of recombinant genes in a heterologous host organism. There is yet to be a study that investigates the relative effects of ICU and CC on protein expression. To address this issue, a computational analysis was proposed to evaluate the performance of sequences generated by various ICU and CC optimization approaches. The proposed methodology optimizes synthetic genes based on codon context as its key design criterion.

In the present disclosure, novel computational procedures were applied to generate DNA sequences exhibiting optimal ICU and CC in Escherichia coli, Lactococcus lactis, Pichia pastoris and Saccharomyces cerevisiae based on information obtained from omics data analysis. While E. coli and S. cerevisiae has been model organisms for recombinant protein production studies, codon optimization in the Gram-positive bacterium L. lactis and methylotrophic yeast P. pastoris were also considered since they are also promising candidates for expressing recombinant proteins. Assuming that the native DNA sequences of highly expressed genes have evolved to exhibit optimal ICU and CC for high in vivo expression, the efficacy of the computational approaches in the present disclosure by performing a leave-one-out cross-validation on the high-expression genes were demonstrated for each expression host.

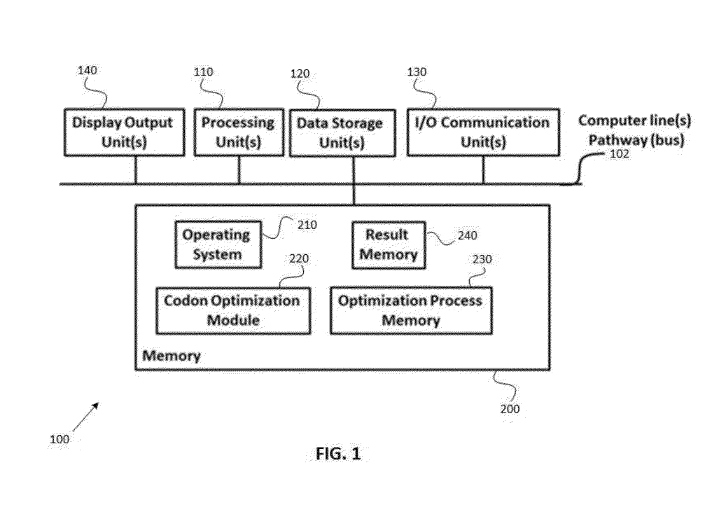

FIG. 1 is a block diagram of a system 100 for codon optimization in accordance with an embodiment of the present disclosure. In an embodiment, the system 100 includes a computer or computing device having at least one processing unit 110 configured for executing program instructions; a data storage unit 120 including one or more types of computer or electronically readable/accessible media for configured for storing data and/or program instructions; an input/output (I/O) and/or communication unit 130 (e.g., a network interface/communication unit); a display device/visual output unit 140 (e.g., a computer monitor); and a memory 200 wherein an operating system 210, a codon optimization module 220, an optimization process memory 230, and an optimization results memory 240 reside. Each element of the system 100 can be coupled by way of a set of communication/signal transfer pathways, links, or lines 102 such as a bus. Depending upon embodiment details, the system 100 can include or be a desktop computer system, a portable computing system/device, or one or more servers (e.g., a local server or a set of remote servers, such as associated with a computing cloud).

In various embodiments, the codon optimization module 220 includes one or more program instruction sets which are executable by the processing unit(s) 110, and which are configured for performing a set of codon optimization processes, procedures, routines, or methods described herein. The codon optimization module 220 can additionally manage or direct the presentation of visual information related to a codon optimization process and/or results associated therewith (e.g., algorithm convergence information/progress; optimized coding sequence matching relative to high expression genes; and/or other information) on the display device 140. The optimization process memory 230 can include information/data storage elements configured for storing initially retrieved or provided data, intermediate results, and data structures associated therewith. The optimization results memory 240 can include storage elements configured for storing final output or results associated with codon optimization processes described herein.

Aspects of codon optimization processes, procedures, routines, or methods in accordance with embodiments of the present disclosure are described in detail hereafter.

### Codon Optimization Formulation

To investigate the relative importance of ICU and CC towards designing sequences for high protein expression, three computational procedures were implemented: the individual codon usage optimization (ICO) method generates a sequence with optimal ICU only; the codon context optimization (CCO) method optimizes sequences with regard to codon context only; and the multi-objective codon optimization (MOCO) method simultaneously considers both ICU and CC. Thus, the resultant sequence is ICU-/CC-optimal when its ICU/CC distribution is closest to the organism's reference ICU/CC distribution calculated based on the sequences of native high-expression genes. Based on the mathematical formulation presented in Methods, the ICO problem can be described as the maximization of ICU fitness, Ψ_{ICU} (see Eqn. 23), subject to the constraint that the codon sequence can be translated into the target protein (see Eqns. 3, 4 and 11). Due to the discrete codon variables and nonlinear fitness expression of Ψ_{ICU}, ICO is classified a mixed-integer nonlinear programming (MINLP) problem. Nonetheless, it can be linearized using a strategy by decomposing the nonlinear |p₀^{k}−p₁^{k}| term (see Eqn. 23) into a series of linear and integer constraints which consist of binary and positive real variables. The resultant mixed-integer linear programming (MILP) problem can be solved using well established computational methods such as branch-and-bound and branch-and-cut. However, due to the large and discrete search space which contains all possible DNA sequences that can encode the target protein, solving the MILP using these methods may require a long computational time. Thus, alternative methods, such as GASCO and QPSOBT, have been proposed for solving ICO using genetic algorithm and particle swarm optimization. Although these heuristic methods are more efficient than conventional MILP solving procedures, they still require a significant amount of computational resources due to the iterative nature of the algorithms. To circumvent the high computational costs, the non-iterative method is developed for solving ICO using the following steps:
I1. Calculate the host's individual codon usage distribution, p₀^{k}.
I2. Calculate the subject's amino acid counts, θ_{AA,1}^{j}.
I3. Calculate the optimal codon counts for the subject using the expression:

$${θ}_{C , opt}^{k} = {p}_{0}^{k} \times {\sum }_{j = 1}^{21} [ {θ}_{A , 1}^{j} \times 1 \{ {α}^{j} = f ( {κ}^{k} ) \} ] ∀ k ∈ \{ 1 , 2 , … , 64 \}$$

I4. For each τᵢ in the subject's sequence, randomly assign a codon κ^{k} if θ_{C}^{k}>0, and decrement θ_{C,opt}^{k} by one.
I5. Repeat step I4 for all amino acids of the target protein from τ_{1,1} to τ_{n,1}.

Similarly, CCO can be formulated as the maximization of CC fitness, Ψ_{CC} (see Eqn. 26), subject to the constraint that the codon pair sequence can be translated into the target protein (see Eqns. 7, 8 and 12). To find the solution for CCO, the procedure in ICO may not be applicable due to the computational complexity which arises from the dependency of adjacent codon pairs. For example, given a codon pair “AUG-AGA” in a 5′-3′ direction, the following codon pair must only start with “AGA”. Therefore, if the ICO procedure had been adopted to directly identify the codon pairs and randomly assign them to the respective amino acid pairs, there could be conflicting codon pair assignments in certain parts of the sequence. Since the characteristic of independency, which was exploited to develop a simple solution procedure for ICO, is absent in the CCO problem, a more sophisticated computational approach was resorted to.

The CCO problem can be conceptualized in a similar way as the well-known traveling salesman problem whereby the traversing from one codon to the next adjacent codon is analogous to the salesman traveling from one city to the next. Since there will be a “cost” incurred by taking a particular “codon path”, the CCO problem aims to minimize of the total cost for traveling a codon path that is able to code the desired protein sequence. However, the CCO problem is more complex than the traveling salesman problem due to the nonlinear cost function evaluated based on the frequency of codon pair occurrence. For an average sized protein consisting 300 amino acids, the total number of codon paths can be as many as 10¹⁰⁰. Finding an optimal solution for such a large-scale combinatorial problem within an acceptable period of computation time can only be achieved via heuristic optimization methods. Incidentally, the use of genetic algorithm provides an intuitive framework whereby codon path candidates are “evolved” towards optimal CC through techniques mimicking natural evolutionary processes such as selection, crossover or recombination and mutation.

Thus, the procedure for solving CCO is as follows:
C1. Randomly initialize a population of coding sequences for target protein.
C2. Evaluate the CC fitness of each sequence in the population.
C3. Rank the sequences by CC fitness and check termination criterion.
C4. If termination criterion is not satisfied, select the “fittest” sequences (top 50% of the population) as the parents for creation of offspring via recombination and mutation.
C5. Combine the parents and offspring to form a new population.
C6. Repeat steps C2 to C5 until termination criterion is satisfied.

In step C3, the termination criterion depends on the degree of improvement in best CC fitness values for consecutive generations of the genetic algorithm. If the improvement in CC fitness across many generations is not significant, the algorithm is said to have converged. In the present disclosure, the CC optimization algorithm is set to terminate when there is less than 0.5% increase in CC fitness across 100 generations, i.e. Ψ_{CC}^{(r+100)}/Ψ_{CC}^{(r)}<0.005 where r refers to the r^{th} generation of the genetic algorithm. When the termination criterion is not satisfied, the subsequent step C4 will perform an elitist selection such that the fittest 50% of the population are always selected for reproduction of offspring through recombination and mutation. During recombination, a pair of parents is chosen at random and a crossover is carried out at a randomly selected position in the parents' sequences to create 2 new individuals as offspring. The offspring subsequently undergo a random point mutation before they are combined with the parents to form the new generation.

Unlike traditional implementations of genetic algorithm where individuals in the population are represented as 0-1 bit strings, the presented CC optimization algorithm represents each individual as a sequential list of character triplets indicating the respective codons. Therefore, the codons can be manipulated directly with reference to a hash table which defines the synonymous codons for each amino acid. As a result, the protein encoded by the coding sequences is always the same in the genetic algorithm since crossovers only occur at the boundary of the codon triplets and mutation is always performed with reference to the hash table of synonymous codons for each respective amino acid.

Based on the formulations for ICU and CC optimization, the MOCO problem, which is an integration of both, can be described as maximizing both ICU and CC fitness, i.e. max (Ψ_{ICU}, Ψ_{CC}), subject to the constraints that both the codon and codon pair sequences can be translated into the target protein sequence. As such, due to the complexity attributed to CC optimization, solution to MOCO will also require a heuristic method. In this case, the nondominated sorting genetic algorithm-II (NSGA-II) is used to solve the multi-objective optimization problem. The procedure for NSGA-II is similar to that presented for CC optimization except for additional steps required to identify the nondominated solution sets and the ranking of these sets to identify the pareto optimum front. The NSGA-II procedure for solving the MOCO problem is as follows:
M1. Randomly initialize a population of coding sequences for target protein.
M2. Evaluate ICU and CC fitness of each sequence in the population.
M3. Group the sequences into nondominated sets and rank the sets.
M4. Check termination criterion.
M5. If termination criterion is not satisfied, select the “fittest” sequences (top 50% of the population) as the parents for creation of offspring via recombination and mutation.
M6. Combine the parents and offspring to form a new population.
M7. Repeat steps M2 to M5 until termination criterion is satisfied.

The identification and ranking of nondominated sets in step M3 is performed via pair-wise comparison of the sequences' ICU and CC fitness. For a given pair of sequences with fitness values expressed as (Ψ_{ICU}¹, Ψ_{CC}¹) and (Ψ_{ICU}², Ψ_{CC}²), the domination status can be evaluated using the following rules:
If (Ψ_{ICU}¹>Ψ_{ICU}²) and (Ψ_{CC}¹≧Ψ_{CC}²), sequence 1 dominates sequence 2.
If (Ψ_{ICU}¹≧Ψ_{ICU}²) and (Ψ_{CC}¹>Ψ_{CC}²), sequence 1 dominates sequence 2.
If (Ψ_{ICU}¹<Ψ_{ICU}²) and (Ψ_{CC}¹≦Ψ_{CC}²), sequence 2 dominates sequence 1.
If (Ψ_{ICU}¹≦Ψ_{ICU}²) and (Ψ_{CC}¹>Ψ_{CC}²), sequence 2 dominates sequence 1.

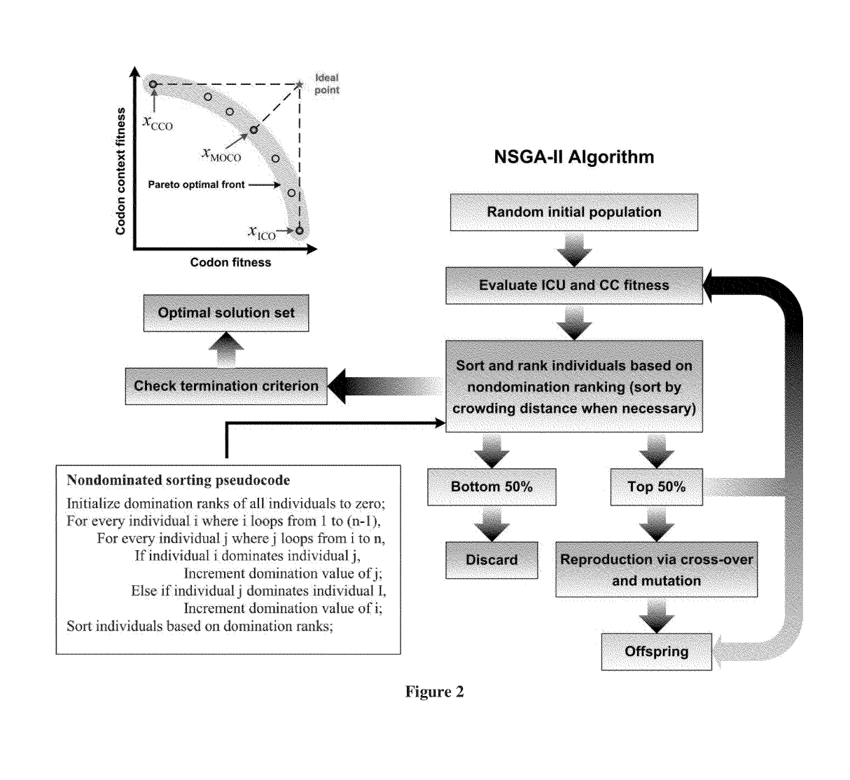

Whenever a particular sequence is found to be dominated by another sequence, the domination rank of the former sequence is lowered. As such, the grouping and sorting of the nondominated sets are performed simultaneously in step M3 (FIG. 2). In the original nondominated sorting algorithm, the set of individuals that is dominated by every individual is stored in memory. Therefore, for a total population of n, the total storage requirement is O(n²). However, for the abovementioned algorithm, only O(n) storage is required for storing the domination value of each individual. In terms of computational complexity, both the original and modified algorithm requires at most O(mn²) computations for m objective values since all the n individuals have to be compared pair-wise for every objective to be optimized. Therefore, the nondominated sorting algorithm presented in the present disclosure is superior on the whole, especially with regards to computational storage requirement which can become an important issue when dealing with long coding sequences.

The output of multi-objective optimization is a set of solutions also known as the pareto optimal front. Since the aim of MOCO is to examine the relative effects of ICU and CC optimization, it is not necessary to analyze all the sequences in the pareto optimal front. Instead, the solution which is nearest to the ideal point will represent the sequence with balanced ICU and CC optimality. As such, the solutions of ICO, CCO and MOCO will subsequently be referred to as x_{ICO}, x_{CCO} and x_{MOCO} respectively (FIG. 2).

### Finding the Codon Preference

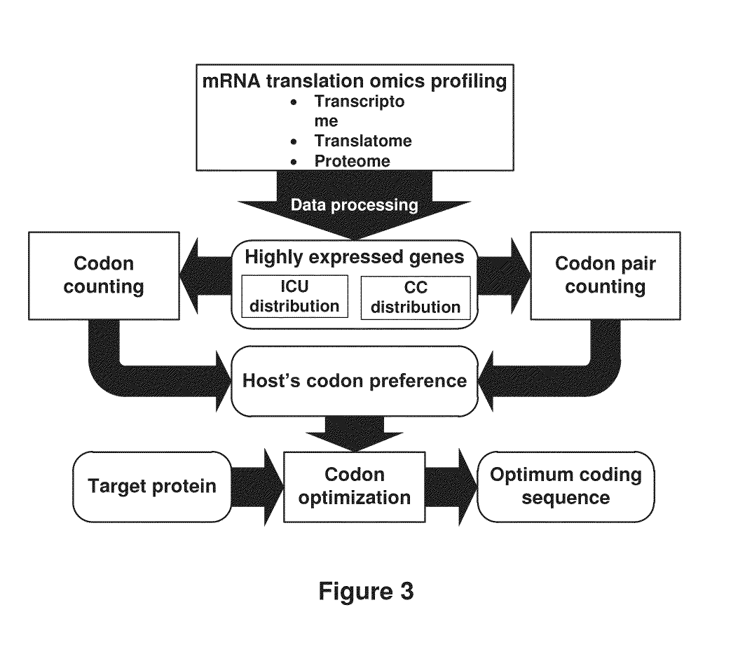

The entire workflow for codon optimization of a target protein sequence begins with the identification of the host's preferred ICU and CC distributions as the reference (FIG. 3). These ICU and CC distributions should ideally capture codon usage patterns that correspond to efficient translation of mRNA to protein. Therefore, the first step of codon optimization identifies the reference ICU and CC distributions by characterizing the underlying mechanisms of efficient translation which can be achieved through transcriptome, translatome and proteome profiling. However, such large-scale experimental data are not readily available for the extraction of codon usage preference information in all the expression hosts considered in the present disclosure. Alternatively, it is assumed that the organisms have evolved to conserve resources by producing high amounts of transcripts for genes that will also be efficiently translated. As such, the widely available transcriptome data from microarray experiments can be used to identify the highly expressed and efficiently translated genes. Thus, the codon pattern of the host's native high-expression genes will be a suitable reference point for codon optimization.

The step for selecting high-expression genes codon pattern for codon optimization is only relevant if the following two conditions are true: (1) ICU and CC distributions of high-expression genes are significantly biased and non-random; and (2) there is a significant difference in ICU and CC distribution between highly expressed genes and all the genes in the host organism's genome. It is noted that if the first condition is false, there is no codon (pair) bias and codons can be assigned randomly based on a uniform distribution; if the second condition is false, the computation of ICU and CC distributions based on all the genes in the genome will be sufficient to characterize the ICU and CC preference of the organism without the need for selecting high-expression genes.

To determine the significance of ICU and CC biases, the Pearson's chi-squared test is applied. Using a p-value cut-off of 0.05, the ICU and CC distributions of at least 80% of the amino acids (pairs) amenable to the chi-squared test were found to be significantly biased in the micro-organisms (Table 1).

### ICU and CC Biasness Analysis

The chi-squared statistic is computed based on the observed occurrence of each codon (pair) and the expected occurrence under the null hypothesis of uniform distribution. Any amino acid (pair) with p-value <0.05 is considered to exhibit significantly biased codon (pair) usage. Singular amino acids (methionine and tryptophan) and singular amino acid pairs (pairs only consisting of methionine and/or tryptophan) are not amenable to the biasness analysis since they are not encoded by more than one synonymous codon (pair). Chi-squared statistic and p-value are not calculated for amino acid (pair) with expected counts less than 5. Abbreviations: D^{A}, codon (pair) distribution of all genes in the genome; D^{H}, codon (pair) distribution of high-expression genes; U, uniform distribution.

TABLE 1
ICU and CC biasness analysis

| | E. coli | | P. pastoris | | S. cerevisiae | |
|---|---|---|---|---|---|---|
| | Null hypothesis (H₀) | | | | | |
| | D^{H} = U | D^{H} = D^{A} | D^{H} = U | D^{H} = D^{A} | D^{H} = U | D^{H} = D^{A} |
| | Alternative hypothesis (H₁) | | | | | |
| | D^{H} ≠ U | D^{H} ≠ D^{A} | D^{H} ≠ U | D^{H} ≠ D^{A} | D^{H} ≠ U | D^{H} ≠ D^{A} |
| No. of biased amino | 18 | 17 | 18 | 19 | 18 | 19 |
| acids | | | | | | |
| (P-value < 0.05) | | | | | | |
| No. of unbiased amino | 1 | 2 | 1 | 0 | 1 | 0 |
| acids | | | | | | |
| (P-value ≧ 0.05) | | | | | | |
| No. of singular amino | 2 | 2 | 2 | 2 | 2 | 2 |
| acids | | | | | | |
| No. of unevaluated | 0 | 0 | 0 | 0 | 0 | 0 |
| amino acids | | | | | | |
| (Expect count < 5) | | | | | | |
| Total no. of amino | 21 | 21 | 21 | 21 | 21 | 21 |
| acids | | | | | | |
| No. of biased amino | 314 | 99 | 354 | 259 | 372 | 282 |
| acid pairs | | | | | | |
| (P-value < 0.05) | | | | | | |
| No. of unbiased amino | 26 | 23 | 38 | 36 | 19 | 9 |
| acid pairs | | | | | | |
| (P-value ≧ 0.05) | | | | | | |
| No. of singular amino | 4 | 4 | 4 | 4 | 4 | 4 |
| acid pairs | | | | | | |
| No. of unevaluated | 76 | 294 | 24 | 121 | 25 | 125 |
| amino acid pairs | | | | | | |
| (Expect count < 5) | | | | | | |
| Total no. of amino | 420 | 420 | 420 | 420 | 420 | 420 |
| acid pairs | | | | | | |

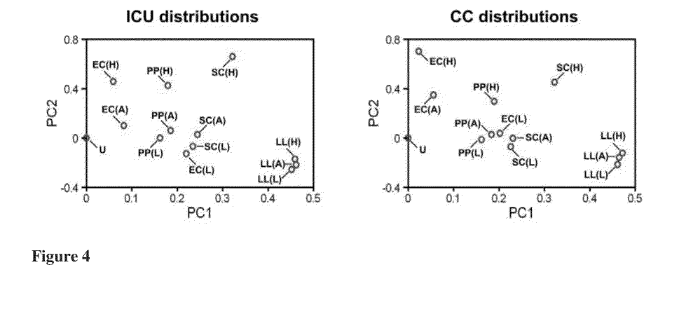

In the high-expression genes, aspartate was found to be the only one among all amino acids exhibiting an ICU distribution that is not significantly different from the unbiased distribution for E. coli, P. pastoris and S. cerevisiae. Similarly, more than 80% of the amino acids (pairs) show significant difference in ICU and CC distributions between high-expression genes and all genes in the genomes of these three microbes. Contrastingly, 80% amino acids did not show significant difference in CC distributions between high-expression genes and all genes in L. lactis, suggesting that the selection of highly expressed genes may not be required to establish the CC preference of L. lactis. By applying the principal component analysis, it can be observed that the ICU and CC distributions for all types of genes in L. lactis are close to one another when compared to genes from other organisms (FIG. 4). This indicates that the short listing of highly expressed genes may not be necessary for organisms like L. lactis. Nonetheless, the identification of high-expression genes is recommended to characterize the ICU and CC preference of any host, such that there is a better level of confidence that the optimized recombinant gene can be efficiently expressed.

### Performance of Codon Optimization Methods

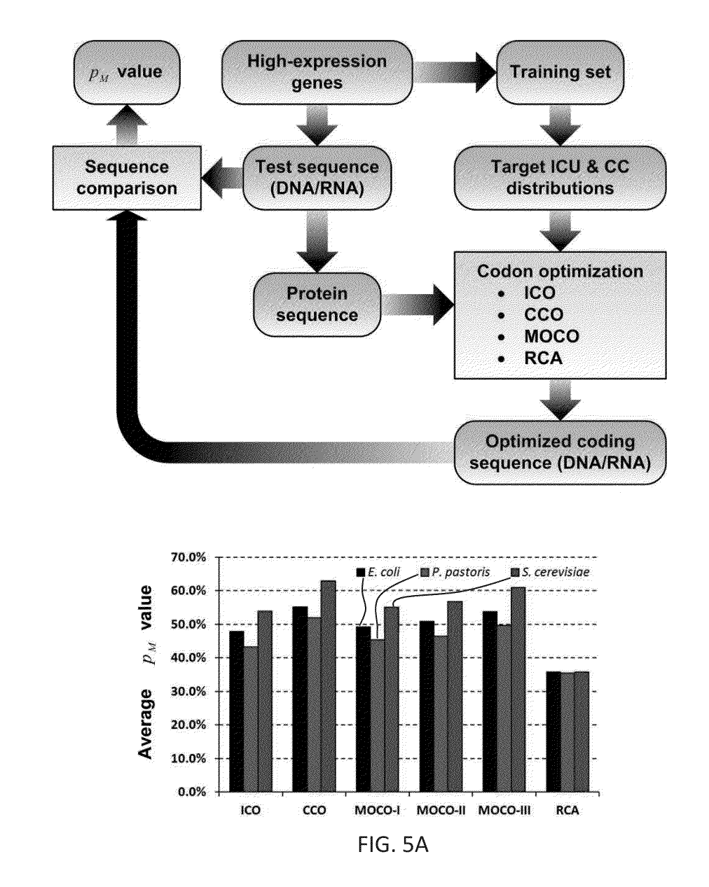

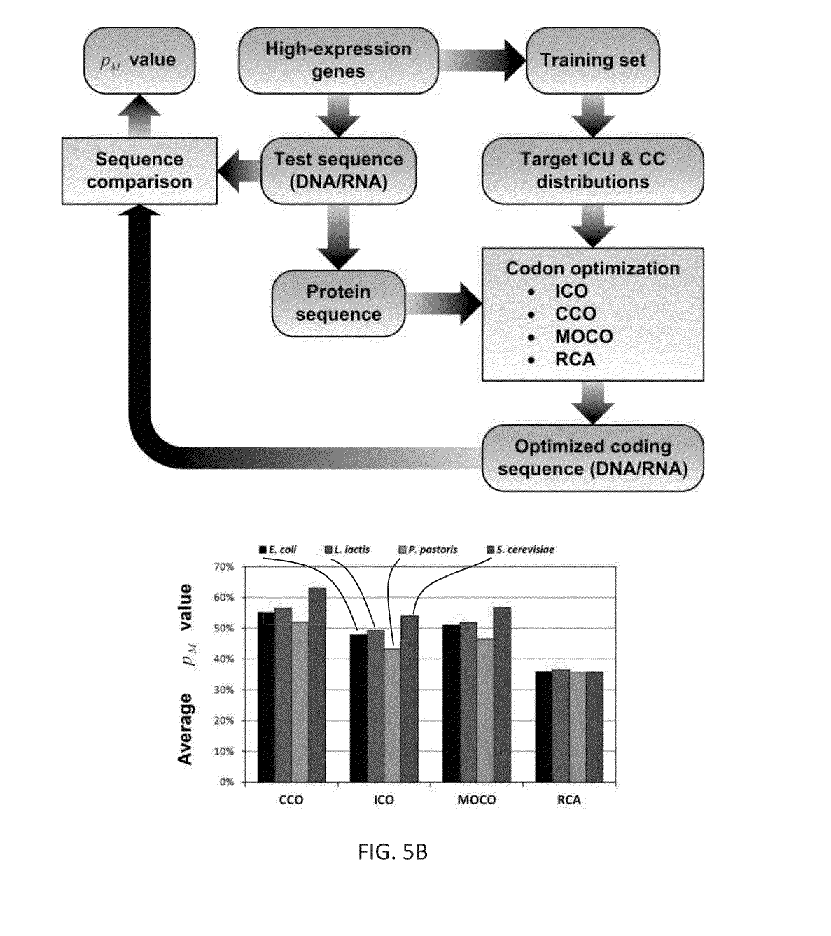

The performance of each optimization approach was evaluated using a leave-one-out cross-validation, where a gene is randomly selected from the entire set of high-expression genes for sequence optimization while the rest of the genes will be used as the training set to calculate the reference ICU and CC distribution (FIGS. 5A and 5B). The predicted optimum sequences are compared with the original native sequences to evaluate the performance of each codon optimization approach. As the degree of similarity to the wild-type high expression genes indicates the gene expressivity potential of the optimized sequences, the quality of each optimized sequence was measured in terms of the percentage of codons matching the corresponding native sequence, denoted by p_{M}. From the results, the x_{ICO}, x_{CCO} and x_{MOCO} solutions were generally found to be more similar to the native genes than the random sequences generated by random codon assignment (RCA) indicating that all the optimization approaches are indeed capable of improving the codon usage pattern compared to the control (FIGS. 5A and 5B). The p_{M} values of x_{ICO}, x_{CCO}, x_{MOCO} and x_{RCA} sequences for each gene are further compared in a “tournament” style to show the relative performance of each optimization method. In the tournament matrix (Table 2), each cell shows the number of wins by the method in the left-most column against that in the upper-most row. Whenever the numbers of wins and losses (i.e. cells diagonally opposite of each other) do not sum up to 100, the shortfall will be equal to the number of draws.

### Tournament Matrix

For every gene, the p_{M} of the optimal sequences generated by respective optimization approaches are compared pair-wise for each expression host. The numbers of tournament wins/losses by each approach for all the genes in each expression host are added up. The sequences generated by ICO, CCO, MOCO and RCA are indicated as x_{ICO}, x_{CCO}, x_{MOCO} and respectively. In each cell, the numbers from top-most to bottom-most corresponds to x_{RCA} the data for E. coli, L. lactis, P. pastoris and S. cerevisiae, respectively.

TABLE 2
Tournament matrix

| | x_{ICO} | x_{CCO} | x_{MOCO} | x_{RCA} |
|---|---|---|---|---|
| x_{ICO} | | 7 | 19 | 95 |
| | | 2 | 18 | 99 |
| | | 4 | 15 | 93 |
| | | 5 | 22 | 99 |
| x_{CCO} | 92 | | 82 | 97 |
| | 96 | | 93 | 100 |
| | 96 | | 86 | 100 |
| | 93 | | 89 | 99 |
| x_{MOCO} | 78 | 15 | | 97 |
| | 74 | 5 | | 100 |
| | 83 | 12 | | 99 |
| | 75 | 9 | | 99 |
| x_{RCA} | 5 | 2 | 3 | |
| | 0 | 0 | 0 | |
| | 6 | 0 | 1 | |
| | 1 | 0 | 0 | |

Through the comparison of ICO and CCO, the x_{CCO}, solutions have a higher average percentage of codon matches than x_{ICO}, sequences for all four microbes (FIGS. 5A and 5B), with at least 90% of the x_{CCO} sequences matching the native corresponding sequences better than those generated by ICO (Table 2). This result indicates that CC fitness can be a more important design parameter for sequence optimization than ICU fitness which has been a conventional design criterion implemented in several software tools. While it appears likely that the integration of CCO with ICO under a multi-objective optimization framework can potentially lead to even better sequence design, results from the MOCO analysis in the present disclosure suggest otherwise. The average of p_{M} value of x_{MOCO} were observed to be lower than that of x_{CCO}, indicating that the consideration of ICU fitness in addition to CC fitness can be detrimental to the sequence design. To our best knowledge, no such formal evaluation of the relative impact of ICU and CC fitness on synthetic gene design has been presented to date. Hence, based on the promising in silico validation results which implicate CC as an important design parameter for optimizing sequences, the newly developed CCO procedure can potentially supersede the ICU optimization techniques currently implemented in gene design software tools.

It is noted that similar observations on the relative performance of ICO, CCO and MOCO were made when the in silico leave-one-out cross-validation were performed on the set of 27 high-expression genes of E. coli.

### Capturing the Preferred Codon Usage Patterns

Earlier codon optimization studies have recommended the usage of high expression genes to design the recombinant gene for efficient heterologous expression. In the analysis of codon usage patterns, the significant distinction in the ICU and CC distributions between highly expressed and other genes corroborated the relevance of identifying high-expression genes to characterize the preferred codon usage patterns. It is noted that although there is codon usage information readily available in the Codon Usage Database (http://www.kazusa.or.jp/codon/), these data may not be useful as prior filtering of highly expressed genes was not performed.

Such codon usage data may reflect some degree of preference for “rare” codons, thus leading to low gene expression.

Several options are available for quantifying the codon usage patterns. In the present disclosure, the method of treating the ICU and CC distributions as a vector of frequency values has been adopted to capture the relative abundance of individual codons and codon pairs. An earlier well-known method for quantifying codon usage bias is the codon adaptation index (CAI). The CAI has been widely used for codon optimization due to its observed correlation with gene expressivity. However, by designing a gene through the maximization of CAI, the resultant coding sequence will become a “one amino acid—one codon” design where CAI=1.0. This sequence design may not be desirable as the overexpression of this gene can lead to very rapid depletion of the specific cognate tRNAs resulting in tRNA pool imbalance, which can in turn cause an increase in translational errors. In this aspect, the ICU fitness measure will be a better performance criterion than CAI since the former allows a small number of rare codons to be included in the final sequence. Furthermore, the calculation of CAI is intrinsically based on individual codon usage and does not have the capability to account for codon pairing. Therefore, the information captured by the CC fitness cannot be reflected in the CAI value.

Therefore, the proposed approach of optimizing codons according to the complete ICU and CC distributions of highly expressed genes will be suitable to alleviate the problem of tRNA pool imbalance when the cell is induced to overexpress the target gene.

### Efficacy of CCO

Codon usage has been shown to affect the accuracy and speed of translation. Hence, the concept of CCO implementation is to identify favorable codon pairings that can lead to more efficient protein synthesis process. Notably, an optimization framework based on the dynamic modeling of protein translation has been recently developed to identify suitable codon placements to improve translation elongation speed. Although this recent method provides a mechanistic understanding of how codon choice affects translation efficiency, it requires a protein translation kinetic model and codon-specific elongation rates which may not be readily available for organisms other than E. coli as shown in previous studies. Therefore, CCO may be a better alternative as it can achieve the aim of enhancing translation efficiency while having the advantage of utilizing information, including genome sequence and gene expression data, which are easily accessible in public databases such as the Gene Expression Omnibus (www.ncbi.nlm.nih.gov/geo/) and GenBank (www.ncbi.nlm.nih.gov/genbank/). Incidentally, there was evidence suggesting that translation initiation rather than elongation is the rate limiting step. Nonetheless, CCO generated sequences can indirectly increase translation initiation by freeing up more ribosomes through enhanced translation elongation rates. The increased pool of free ribosomes can then help to improve translation initiation by mass action effect.

On the other hand, translation initiation can also be affected by the mRNA structure of the initiation site. At the primary structure level, Shine-Dalgarno sequence and Kozak sequence should be added to the 5′ end of the coding sequence since previous studies have shown that they are required for recognition of the AUG start codon to initiate translation in prokaryotes and eukaryotes, respectively. At the secondary structure level, it was found that hairpin, stem-loop and pseudoknot mRNA structures can repress protein translation. Although this suggests that the computationally intensive mRNA secondary structure evaluation may be required for designing synthetic genes, it was also reported that the helicase activity of ribosome is able to disrupt the secondary structures for mRNA translation. Therefore, using the mRNA secondary structure analysis only as a supplementary step for the CC-optimized sequences such that no significant computational cost is added to the main CCO procedure is suggested.

### CCO Tool for Synthetic Biology

To further develop CCO into a software tool for designing synthetic genes, several other factors may also be considered. From the experimental aspect, the gene optimization should take into consideration the types of restriction enzymes used for vector construction such that the restriction sites DNA motifs are avoided to prevent unnecessary cleavage of the coding sequence. In certain cases where the optimized coding sequence tends to have nucleotide repeats, additional steps may be required to avoid the repeats or inverted repeats which may lead to DNA recombination or formation of mRNA hairpin loops, respectively, that will reduce the heterologous expressivity of the target protein. In addition, sequence homology may also be considered to design genes that are resistant to RNA interference such that complementary sequences of the silencing RNAs are avoided in the coding sequence.

The optimal sequences generated by CCO are not found in any natural organism. Thus, the CCO software tool should also consider challenges involved in the synthesis of these artificial genes. The current technology for de novo gene synthesis involves the chemical synthesis of short oligonucleotides followed by ligation- or PCR-mediated assembly of the oligonucleotides to form the complete gene. The way in which a long coding sequence is broken down into short oligonucleotides has to be properly designed to minimize the oligonucleotide synthesis error rate and maximize the uniformity of the oligonucleotides' annealing temperatures for efficient assembly. Several methods such as DNAWorks, Gene2Oligo and TmPrime have been proposed to address these goals in oligonucleotide design optimization for gene synthesis. Although these oligonucleotide optimization methods can be performed independently from the codon optimization procedure, these two processes can be integrated to facilitate the “design-to-synthesis” workflow. As long as the current gene synthesis paradigm prevails, researchers can further explore the possibility of developing an integrated codon and oligonucleotide optimization software tool to effectively and systematically design high performance synthetic genes for protein expression.

### Applications of CCO

Through the in silico cross-validation of the present disclosure, the inventors have shown that CCO performs better than the conventional ICO approach. This implies that the incorporation of the CCO algorithm into existing gene designing tools such as Codon optimizer, GeneDesigner, and OPTIMIZER can lead to much better gene designs compared to the current framework. Furthermore, existing tools typically use all of the host genome's coding sequences for codon evaluation without specifically focusing on high expression genes as presented in the CCO procedure of the present disclosure. Thus, these existing tools are likely to yield sequences that use more rare codons than desired.

The concept of codon optimization has been widely applied to enhance heterologous gene expression. However, the application of existing codon optimization frameworks has several inherent problems. Firstly, most of the experimentalists claim to optimize the heterologous gene by arbitrarily replacing one or a few codons with the preferred ones for some amino acid, which is usually leucine or serine since they have the most synonymous codons. This approach is problematic because even though the modified sequence can exhibit improved in vivo expression, the sequence design can only be considered “locally optimal” with respect to the few codons instead of the global optimum that can only be reasonably achieved via computational means. In other cases where computational algorithms were used to optimize the gene, many design parameters, including GC content, codon adaptation index (CAI), mRNA structure, codon (pair) distribution and translation initiation sites, were incorporated. To accommodate the multitude of design parameters, sophisticated computational procedures were used, which adds to the complexity of the problem. Ultimately, numerous experiments may be required to elucidate the relative importance of these parameters before the gene optimization method can be applied successfully.

The CCO algorithm of the present disclosure overcomes the limitations of existing tools and existing algorithms by designing a genetic sequence with optimal codon pair usage, which has been experimentally shown to be a strong determinant of protein expression capability. Hence, the resultant gene design is expected to exhibit improved expression of heterologous proteins. Since CCO is primarily based on minimizing the discrepancy in codon pair usage between the host and the synthetic gene, well-established global optimization methods can be used to provide a solution sequence.

The key motivation behind the development of the CCO algorithm of the present disclosure is to enhance the expression of foreign genes in commonly used microbial cell factories such as Escherichia coli, Sacchromyces cerevisiae and Pichia pastoris. Therefore, the CCO algorithm of the present disclosure can be used in any industry where it is desirable to improve the production of heterologous proteins in a particular host organism. As such, the CCO algorithm of the present disclosure can be integrated into biopharmaceutical processes to improve the production of therapeutic protein drugs. In addition, in cases where metabolic engineering of cells is required, the CCO algorithm of the present disclosure can be used to enhance the expression of the respective metabolic enzymes to alter biosynthetic pathways for biotechnological applications which can include biofuel production, bio-catalysis and bioremediation.

The motivation behind codon optimization is usually to enhance the expression of foreign genes in expression hosts such as E. coli, P. pastoris and S. cerevisiae. In addition, codon optimization can also be used to generate synthetic designs of native genes for metabolic engineering applications. While conventional overexpression of native metabolic genes is achieved by increasing gene copy number through the introduction of plasmids, codon optimization provides an alternative approach for enhancing pathway utilization via insertion of high-expression synthetic genes of the respective metabolic enzymes into the host's genome. The latter technique can be advantageous as it obviates the metabolic burden associated with plasmid maintenance, thus allowing the cells to have more resources for growth and biochemical production.

Apart from biotechnological applications, codon optimization can also be used in biomedical research where modulation of protein expression is required to alter physiological response. For example, in the development of vaccines against viruses, one approach is to genetically manipulate the virus to obtain a “live attenuated” strain as the vaccine. Such a vaccine, when administered to the host, will elicit an immune response for the host to develop immunologic memory and specific immunity against the virus without severe disruption to the overall physiology. Some conventional methods of developing live attenuated vaccines include laboratory adaptation of virus in non-human hosts and random/site-directed mutagenesis. Since the wild-type virus is able to hijack the gene expression machinery of the host for replication, the de-optimization of viral codon usage can lead to the development of live attenuated vaccines. Therefore, the CCO framework developed in the present disclosure can be slightly modified to design a synthetic virus consisting of more rare codons that can be used as vaccines. Specifically, either inverting the objective function to minimize CC fitness or altering the target CC distribution during the execution of the optimization procedure can be done to design the sequence of the attenuated virus.

### Processes/Procedures/Methods

### Identifying Highly Expressed Genes

Provided that highly expressed genes have evolved to adopt optimal codon patterns, information on ICU and CC preference of any organism can be extracted from the DNA sequences of the high-expression genes. In this sense, published microarray data of E. coli, L. lactis, P. pastoris and S. cerevisiae from various experimental conditions were used to identify the top 5% of genes with the highest expression value for each microbe. The ICU and CC of these genes were then extracted from their corresponding DNA coding sequences that can be obtained from publicly available genome annotations for E. coli, L. lactis, P. pastoris and S. cerevisiae. Each host's ICU and CC preference can be represented as the frequency of occurrence of individual codons and codon pairs found in the sequences of the highly expressed genes. These ICU and CC distributions are then be used as the targets for the respective codon optimization methods. For the evaluation of ICU and CC biasness difference between high- and low-expression genes, the low-expression genes are identified in a similar way whereby the bottom 5% of the genes with the lowest expression values are consolidated (see list of sequences for a list of high-expression genes).

ICU and CC biasness

To compute the significance of codon (pair) usage bias, the Pearson's chi-squared test was resorted to. Based on the null hypothesis that “the ICU (CC) of high-expression genes follows the uniform/unbiased distribution”, the chi-square statistic for amino acid (pair) j is calculated as:

$${X}_{j}^{2} = {\sum }_{i = 1}^{{n}_{j}^{H}} \frac{{( {O}_{ij}^{H} - {E}_{ij}^{H} )}^{2}}{{E}_{ij}^{H}} \qquad ( Eqn . 1 )$$

where Eᵢⱼ^{H} and Oᵢⱼ^{H} are the expected and observed numbers of synonymous codon (pair) i encoding amino acid (pair) j, respectively. The constant nⱼ^{H} refers to the number of unique synonymous codon (pair) encoding the amino acid j; for example, the nH values for asparagine, glycine and leucine are 2, 4, and 6 respectively. The superscript “H” indicates that only the high-expression genes are used to evaluate the respective values. Given the null hypothesis of unbiased codon (pair) usage, Eᵢⱼ^{H} can be calculated as

$${E}_{ij}^{H} = \frac{{N}_{j}^{H}}{{n}_{j}^{H}}$$

where Nⱼ^{H} refers to the total number of amino acid (pair) j found in the high-expression genes. The p-value is then evaluated by comparing the calculated Xⱼ² against the χ² distribution with (nⱼ^{H}−1) degrees of freedom since the reduction in degrees of freedom is one due to the constraint:

$${\sum }_{i = 1}^{{n}_{j}^{H}} {O}_{ij}^{H} = {N}_{j}^{H} .$$

Using a p-value cut-off of 0.05, the amino acid (pair) with biased ICU (CC) distribution that is significantly different from the normal distribution can be identified. This test of ICU and CC biasness will be referred to as “χ² Test 1”. To ensure that the statistical adequacy of this chi-squared test, any amino acid (pair) with low expected occurrence (i.e. Eᵢⱼ^{H}<5) will be omitted from this analysis. Furthermore, chi-squared test of singular amino acids (methionine and tryptophan) and amino acid pairs (pairs only consisting of methionine and/or tryptophan) are also not relevant since they are not encoded by more than one synonymous codon (pair) such that the chi-squared statistic will always be equal to 1.

The presented Pearson's chi-squared formulation is slightly modified to determine whether the ICU (CC) is significantly different between high-expression genes and all genes in the genome. Based on the null hypothesis as “ICU (CC) of high-expression genes is the same as that of all genes in the genome”, the expected number of codon (pair) i in high-expression genes is modified as:

$${\tilde{E}}_{ij}^{H} = \frac{{O}_{ij}^{A} {N}_{j}^{H}}{{N}_{j}^{A}} \qquad ( Eqn . 2 )$$

where Oᵢⱼ^{A} refers the observed number of codon (pair) i encoding amino acid (pair) j and Nⱼ^{A} refers to the total number of amino acid (pair) j. The superscript “A” indicates that all genes in the host's genome are used for evaluating the respective values. By substituting Eᵢⱼ^{H} with \tilde{E}ᵢⱼ^{H} in the expression for Xⱼ², the chi-squared statistic to test the difference in ICU (CC) distribution between high-expression genes and all genes in the host's genome can be calculated.

### ICU and CC Fitness Evaluation

In the present disclosure, the target gene, subsequently known as the “subject”, is optimized such that the final synthetic sequence design will exhibit ICU and/or CC distributions that are as similar as possible to those preferred by the host's organism. The ICU and CC fitness values can be used to quantify the degree of similarity in ICU and CC distributions between the subject and the host. Before formulating the ICU and CC fitness, the mathematical expression of the coding sequence and amino acid sequence was presented as follows:

S_{A,1}={M,R,F,P,S,I,F, . . . ,G,D,R,*}={τ_{i,1}}ᵢ₌₁ⁿ (Eqn. 3)

S_{C,1}={AUG,AGA,UUU,CCU,UCA, . . . ,GAC,AGA,UGA}={λ_{i,1}}ᵢ₌₁ⁿ (Eqn. 4))

τ_{i,1}εA={α^{j}}ⱼ₌₁²¹={A,C,D, . . . ,W,Y*}∀i (Eqn. 5)

λ_{i,1}εK={κ^{k}}ₖ₌₁⁶⁴={AAA,AAC,AAG, . . . ,UUG,UUU}∀i (Eqn. 6)

where τ_{i,1} refers to the amino acid occupying the i^{th} position of the amino acid sequence S_{A,1} with the subscript 1 indicating the target protein; τ_{i,1} also belongs to the set A of 21 unique amino acids α^{j}. Similarly, λ_{i,1}, a codon from the set K of 64 unique codons κ^{k}, represents the codon variable in the i^{th} position of the target coding sequence S_{C,1}. It is noted that the coding sequence is express as a sequence of codons instead of nucleotides since codon usage patterns is the key concern. As codon context is another key issue to be examined, the mathematical expressions for amino acid pairs and codon pairs are as follows:

S_{AA,1}={MR,RF,FP,PS,SI, . . . ,GD,DR,R*}={ω_{i,1}}ᵢ₌₁ⁿ⁻¹ (Eqn. 7)

S_{CC,1}={AUGAGA,AGAUUU,UUUCCU, . . . ,AGAUGA}={γ_{i,1}}ᵢ₌₁ⁿ⁻¹ (Eqn. 8)

ω_{i,1}εB={AA,AC,CA, . . . ,W*,Y*}={β^{j}}ⱼ₌₁⁴²⁰∀iε{1, . . . ,n−1} (Eqn. 9)

γ_{i,1}εP={AAAAAA, . . . ,UUUUUU}={ρ^{k}}ₖ₌₁³⁹⁰⁴∀iε{1, . . . ,n−1} (Eqn. 10)

By defining a function to ƒ translate codon(s) to the corresponding amino acid(s) and a concatenation function g(a, b) to append the string b to right of string a, the mathematical relationships for τ_{i,1}, ω_{i,1}, λ_{i,1} and γ_{i,1} are as follows:

ƒ(λ_{i,1})=τ_{i,1} (Eqn. 11)

ƒ(γ_{i,1})=ω_{i,1} (Eqn. 12)

g(τ_{i,1},τ_{(i+1),1})=ω_{i,1} (Eqn. 13)

g(λ_{i,1},λ_{(i+1),1})=γ_{i,1} (Eqn. 14)

The ICU distribution can be defined as the frequency of each unique codon based on its total number of occurrences in the sequence(s). Based on the mathematical formulation presented hitherto, the required mathematical expressions to calculate the ICU distribution are as follows:

$$\begin{matrix}{θ}_{A , 1}^{j} = {\sum }_{i = 1}^{n} 1 \{ {τ}_{i , 1} = {α}^{j} \} ∀ j ∈ \{ 1 , 2 , … , 21 \} & ( Eqn . 15 ) \\ {θ}_{C , 1}^{k} = {\sum }_{i = 1}^{n} 1 \{ {λ}_{i , 1} = {κ}^{k} \} ∀ k ∈ \{ 1 , 2 , … , 64 \} & ( Eqn . 16 ) \\ {θ}_{A , 0}^{j} = {\sum }_{i = 1}^{{n}^{′}} 1 \{ {τ}_{i , 0} = {α}^{j} \} ∀ j ∈ \{ 1 , 2 , … , 21 \} & ( Eqn . 17 ) \\ {θ}_{C , 0}^{k} = {\sum }_{i = 1}^{{n}^{′}} 1 \{ {λ}_{i , 0} = {κ}^{k} \} ∀ k ∈ \{ 1 , 2 , … , 64 \} & ( Eqn . 18 ) \\ {p}_{0}^{k} = \frac{{θ}_{C , 0}^{k}}{{\sum }_{j = 1}^{21} [ {θ}_{A , 0}^{j} \times 1 \{ {α}^{j} = f ( {κ}^{k} ) \} ]} ∀ k ∈ \{ 1 , 2 , … , 64 \} & ( Eqn . 19 ) \\ {p}_{1}^{k} = \frac{{θ}_{C , 1}^{k}}{{\sum }_{j = 1}^{21} [ {θ}_{A , 1}^{j} \times 1 \{ {α}^{j} = f ( {κ}^{k} ) \} ]} ∀ k ∈ \{ 1 , 2 , … , 64 \} & ( Eqn . 20 ) \\ {θ}_{C , 0}^{k} = {\sum }_{i = 1}^{{n}^{′}} 1 \{ {λ}_{i , 0} = {κ}^{k} \} ∀ k ∈ \{ 1 , 2 , … , 64 \} & ( Eqn . 21 ) \\ {θ}_{C , 0}^{k} = {\sum }_{i = 1}^{{n}^{′}} 1 \{ {λ}_{i , 0} = {κ}^{k} \} ∀ k ∈ \{ 1 , 2 , … , 64 \} & ( Eqn . 22 )\end{matrix}$$

where 1{•} is an indicator function such that

$$1 \{ x \} = \{ \begin{matrix}1 & if x is true \\ 0 & otherwise\end{matrix}$$

The count variables θ_{AA}^{j} and θ_{C}^{k} refer to the numbers of occurrences of amino acid j and codon k, respectively, found in the host's (indicated by subscript “0”) or subject's (indicated by subscript “1”) sequence(s), while p^{k} represents the frequency of occurrence of codon k. Accordingly, the ICU fitness can be expressed as:

$${Ψ}_{ICU} = - \frac{{\sum }_{k = 1}^{64} \vert {p}_{0}^{k} - {p}_{1}^{k} \vert}{64} \qquad ( Eqn . 23 )$$

The ICU fitness, Ψ_{ICU}, was divided by 64 such that the numerical value will reflect the average fitness of all codons. In a similar way, if the frequency of occurrence of codon pair k is denoted as q^{k}, the CC fitness can be calculated as:

$$\begin{matrix}{q}_{0}^{k} = \frac{{θ}_{CC , 0}^{k}}{{\sum }_{j = 1}^{420} [ {θ}_{AA , 0}^{j} \times 1 \{ {β}^{j} = f ( {ρ}^{k} ) \} ]} ∀ k ∈ \{ 1 , 2 , … , 3904 \} & ( Eqn . 24 ) \\ {q}_{1}^{k} = \frac{{θ}_{CC , 1}^{k}}{{\sum }_{j = 1}^{420} [ {θ}_{AA , 1}^{j} \times 1 \{ {β}^{j} = f ( {ρ}^{k} ) \} ]} ∀ k ∈ \{ 1 , 2 , … , 3904 \} & ( Eqn . 25 ) \\ {Ψ}_{CC} = - \frac{{\sum }_{k = 1}^{3904} \vert {q}_{0}^{k} - {q}_{1}^{k} \vert}{3904} & ( Eqn . 26 )\end{matrix}$$

### EXAMPLES

### Example 1

A detailed mathematical formulation of ICO, CCO and MOCO is given in the following.

### 1.1 Codon Optimization Mathematical Formulation

The amino acid sequence of the recombinant EPO sequence with MFα signal peptide as the target protein for heterologous expression in P. pastoris is as follows:

MRFPSIFTAVLFAASSALAAPVNTTTEDETAQIPAEAVIGYLDLEGDFDVAVLPFSNSTNNG
LLFINTTIASIAAKEEGVSLDKRAPPRLICDSRVLERYLLEAKEAENITTGCAEHCSLNENI
TVPDTKVNFYAWKRMEVGQQAVEVWQGLALLSEAVLRGQALLVNSSQPWEPLQLHVDKAVSG
LRSLTTLLRALGAQKEAISPPDAASAAPLRTITADTFRKLFRVYSNFLRGKLKLYTGEACRT
GDR*

The abbreviation and corresponding synonymous codons for each amino acid is shown in Table 3.

TABLE 3
Amino acid abbreviation and synonymous codons

| | Abbre- | |
|---|---|---|
| Amino acid | viation | Synonymous codon(s) |
| Methionine | M | AUG |
| Tryptophan | W | UGG |
| Cysteine | C | UGC, UGU |
| Aspartate | D | GAC, GAU |
| Glutamate | E | GAA, GAG |
| Phenylalanine | F | UUC, UUU |
| Histidine | H | CAC, CAU |
| Lysine | K | AAA, AAG |
| Asparagine | N | AAC, AAU |
| Glutamine | Q | CAA, CAG |
| Tyrosine | Y | UAC, UAU |
| Isoleucine | I | AUA, AUC, AUU |
| Alanine | A | GCA, GCC, GCG, GCU |
| Glycine | G | GGA, GGC, GGG, GGU |
| Proline | P | CCA, CCC, CCG, CCU |
| Threonine | T | ACA, ACC, ACG, ACU |
| Valine | V | GUA, GUC, GUG, GUU |
| Leucine | L | CUA, CUC, CUG, CUU, UUA, |
| | | UUG |
| Arginine | R | AGA, AGG, CGA, CGC, CGG, |
| | | CGU |
| Serine | S | AGC, AGU, UCA, UCG, UCC, |
| | | UCU |
| (Stop) | * | UAA, UAG, UGA |

Based on the recombinant EPO sequence, the mathematical formulation of the codon optimization problem is illustrated as below.

### 1.2 Mathematical Representation of RNA and Protein Sequences

The primary structure of the target protein can be described as a sequence amino acids mathematically denoted as:

S_{A,1}={M,R,F,P,S,I,F, . . . ,G,D,R,*}={τ_{i,1}}ᵢ₌₁ⁿ

where τ_{i,1} refers to the amino acid occupying the i^{th} position of the protein sequence S_{A,1} with the subscript 1 indicating that this is the target protein and n refers to the sequence length which is 252 for the recombinant EPO. Each τ_{i,1} belongs to the set of unique amino acids which also includes the translation termination signal. Therefore, the following relationship can be established:

τ_{i,1}εA={α^{j}}ⱼ₌₁²¹={A,C,D, . . . ,W,Y,*}∀i

Since the primary concern is the manipulation of codons, the nucleotide sequence will be defined in terms of nucleotide triplets instead of individual nucleotides. Therefore, the coding sequence of the EPO gene will be mathematically written as:

S_{C,1}={AUG,AGA,UUU,CCU,UCA,AUU,UUU, . . . ,GGG,GAC,AGA,UGA}={λ_{i,1}}ᵢ₌₁ⁿ

where λ_{i,1} refers to the codon variable in the i^{th} position of the target coding sequence S_{C}. Every variable λ_{i,1} belongs to the set of 64 unique codons such that:

λ_{i,1}εK={κ^{k}}ₖ₌₁^{Γ}={AAA,AAC,AAG, . . . ,UUG,UUU}∀i

By defining a function ƒ to many any codon to its corresponding amino acid sequence, the translation of mRNA to protein can be written as τ_{i,1}=ƒ(λ_{i,1}) for individual codons, or S_{A}=ƒ(S_{C}) for the entire coding sequence. In ICU optimization, every λ_{i,1} is a variable while τ_{i,1} is a predefined constant. Therefore, the constraint ƒ(λ_{i,1})=τ_{i,1} delineates the feasible solution space of the ICU optimization problem. It is noted that in this writing, the subscript will be consistently used to indicate the position in a sequence while a superscript will always be used as index for elements in a unique set.

### 1.3 ICU Fitness

After defining the variables (codons) and constraint (target protein sequence), the final component of the optimization problem formulation is the objective function. In ICU optimization, the aim is to search for a candidate coding sequence which exhibits an ICU pattern that is most similar to the host's. Therefore, a fitness measure can be used to quantify the similarity between the ICU distributions of the host and the designed coding sequence, subsequently known as the “subject”.

The ICU distribution can be mathematically written as a vector of individual codon frequencies. The frequency of a codon can be calculated by dividing the number of codon occurrences in a coding sequence by the total number of corresponding amino acid occurrences in the target protein sequence. The counts of codons and amino acids are mathematically formulated as follows:

Subject's count for amino acid j:

$${θ}_{A , 1}^{j} = {\sum }_{i = 1}^{n} 1 \{ {τ}_{i , 1} = {α}^{j} \} ∀ j ∈ \{ 1 , 2 , … , 21 \}$$

Subject's count for codon k:

$${θ}_{C , 1}^{k} = {\sum }_{i = 1}^{n} 1 \{ {λ}_{i , 1} = {κ}^{k} \} ∀ k ∈ \{ 1 , 2 , … , 64 \}$$

Host's count for amino acid j:

$${θ}_{A , 0}^{j} = {\sum }_{i = 1}^{{n}^{′}} 1 \{ {τ}_{i , 0} = {α}^{j} \} ∀ j ∈ \{ 1 , 2 , … , 21 \}$$

Host's count for codon k:

$${θ}_{C , 0}^{k} = {\sum }_{i = 1}^{{n}^{′}} 1 \{ {λ}_{i , 0} = {κ}^{k} \} ∀ k ∈ \{ 1 , 2 , … , 64 \}$$

where 1{•} is an indicator function such that

$$1 \{ x \} = \{ \begin{matrix}1 & if x is true \\ 0 & otherwise\end{matrix}$$

It is noted that the host's codon and amino acid counts are calculated for a group of selected native genes while the subject's counts are calculated for the target protein sequence only. Hence, the host's counts are summed over the total number of amino acids/codons in all the genes denoted by n′. Accordingly, the subject's codon frequency can be calculated as:

$${p}_{1}^{k} = \frac{{θ}_{C , 1}^{k}}{{\sum }_{j = 1}^{21} [ {θ}_{A , 1}^{j} \times 1 \{ {α}^{j} = f ( {κ}^{k} ) \} ]} ∀ k ∈ \{ 1 , 2 , … , 64 \}$$

And the corresponding host's codon frequency can be calculated as:

$${p}_{0}^{k} = \frac{{θ}_{C , 0}^{k}}{{\sum }_{j = 1}^{21} [ {θ}_{A , 0}^{j} \times 1 \{ {α}^{j} = f ( {κ}^{k} ) \} ]} ∀ k ∈ \{ 1 , 2 , … , 64 \}$$

The ICU distributions can be written as vectors of 64 ICU frequencies, i.e. p₀ and p₁. Thus, the ICU fitness of the subject with respect to the host can be expressed as the negative of the Manhattan distance between p_{C}, and p₁:

$${Ψ}_{ICU} = - \frac{‖ {p}_{0} - {p}_{1} ‖}{64} = - \frac{{\sum }_{k = 1}^{64} \vert {p}_{0}^{k} - {p}_{1}^{k} \vert}{64}$$

### 1.4 Individual Codon Optimization (ICO)

By combining the mathematical expressions presented thus far, the ICU optimization problem can be formulated as follows:

$$max Z = {Ψ}_{ICU} \\ s . t . {S}_{A , 1} = {\{ {τ}_{i , 1} \}}_{i = 1}^{n} \\ {S}_{C , 1} = {\{ {λ}_{i , 1} \}}_{i = 1}^{n} \\ f ( {λ}_{i , 1} ) = {τ}_{i , 1} ∀ i ∈ \{ 1 , … , n \} \\ {θ}_{A , 1}^{j} = {\sum }_{i = 1}^{n} 1 \{ {τ}_{i , 1} = {α}^{j} \} ∀ j ∈ \{ 1 , 2 , … , 21 \} \\ {θ}_{C , 1}^{k} = {\sum }_{i = 1}^{n} 1 \{ {λ}_{i , 1} = {κ}^{k} \} ∀ k ∈ \{ 1 , 2 , … , 64 \} \\ {p}_{1}^{k} = \frac{{θ}_{C , 1}^{k}}{{\sum }_{j = 1}^{21} [ {θ}_{A , 1}^{j} \times 1 \{ {α}^{j} = f ( {κ}^{k} ) \} ]} ∀ k ∈ \{ 1 , 2 , … , 64 \} \\ {θ}_{A , 0}^{j} = {\sum }_{i = 1}^{{n}^{′}} 1 \{ {τ}_{i , 0} = {α}^{j} \} ∀ j ∈ \{ 1 , 2 , … , 21 \} \\ {θ}_{C , 0}^{k} = {\sum }_{i = 1}^{n} 1 \{ {λ}_{i , 0} = {κ}^{k} \} ∀ k ∈ \{ 1 , 2 , … , 64 \} \\ {p}_{0}^{k} = \frac{{θ}_{C , 0}^{k}}{{\sum }_{j = 1}^{21} [ {θ}_{A , 0}^{j} \times 1 \{ {α}^{j} = f ( {κ}^{k} ) \} ]} ∀ k ∈ \{ 1 , 2 , … , 64 \} \\ {Ψ}_{ICU} = - \frac{{\sum }_{k = 1}^{64} \vert {p}_{0}^{k} - {p}_{1}^{k} \vert}{64} \qquad ( P1 )$$

Due to the discrete codon variables and nonlinear fitness expression of Ψ_{ICU}, the above is a mixed-integer nonlinear programming (MINLP) problem. Nonetheless, the problem can be linearized using a similar strategy. By decomposing the nonlinear expression |p₀^{k}−p₁^{k}| into a series of linear constraints which consist of positive real and integer variables, the MINLP problem (P1) can be recast into a MILP problem. Although such an optimization problem can be solved using MILP solvers, there is a faster method for generating a subject with optimal ICU using the following steps:
I1. Calculate the host's individual codon usage distribution, p₀^{k}.
I2. Calculate the subject's amino acid counts, θ_{A,1}^{j}.
I3. Calculate the optimal codon counts for the subject:

$${θ}_{C , opt}^{k} = {p}_{0}^{k} \times {\sum }_{j = 1}^{21} [ {θ}_{A , 1}^{j} \times 1 \{ {α}^{j} = f ( {κ}^{k} ) \} ] ∀ k ∈ \{ 1 , 2 , … , 64 \}$$

I4. For each τᵢ in the subject's sequence, randomly assign a codon κ^{k} if θ_{C}^{k}>0, and decrement θ_{C,opt}^{k} by one.
I5. Repeat step 4 for all amino acids of the target protein from τ_{l,1} to τ_{n,1}.

### 1.5 Codon Context Optimization (CCO)

The formulation of CC optimization is similar to that of ICU optimization. In the context of CC, the target coding sequence is expressed as a sequence of codon pair variables:

S_{CC}={AUGAGA,AGAUUU,UUUCCU, . . . ,GGGGAC,GACAGA,AGAUGA}={γ_{i,1}}ᵢ₌₁ⁿ⁻¹

where γ_{i,1} refers to the codon variable in the i^{th} position of the target coding sequence S_{CC}. It is noted that the sequence S_{CC} is different from sequence S_{C} as the former set consists of n−1 codon pairs while the latter is made up of n codons. By defining a concatenation function g(a, b) to append the string b to right of string a, the relationship between λ_{i,1} and γ_{i,1} can be stated as γ_{i,1}=g(λ_{i,1}λ_{(i+1),1}). Every codon pair variable encodes for the corresponding amino acid pair, i.e. ƒ(γ_{i,1})=g(τ_{i,1},τ_{(i+1),1}), and they each belong to the unique sets of amino acid pairs and codon pairs defined as follows:

g(τ_{i,1},τ_{(i+1),1})εB={AA,AC,CA,AD,DA, . . . mW*,Y*}={β^{j}}ⱼ₌₁⁴²⁰∀iε{1, . . . ,n−1}

γ_{i,1}εP={AAAAAA,AAAAAC, . . . ,UUUUUU}={ρ^{k}}ₖ₌³⁹⁰⁴∀iε{1, . . . ,n−1}

Therefore, the counts and frequency can be expressed as follows:

Subject's count for amino acid pair j:

$${θ}_{AA , 1}^{j} = {\sum }_{i = 1}^{n - 1} 1 \{ g ( {τ}_{i , 1} , {τ}_{( i + 1 ) , 1} ) = {β}^{j} \} ∀ j ∈ \{ 1 , 2 , … , 420 \}$$

Subject's count for codon pair k:

$${θ}_{CC , 1}^{k} = {\sum }_{i = 1}^{n - 1} 1 \{ {γ}_{i , 1} = {ρ}^{k} \} ∀ k ∈ \{ 1 , 2 , … , 3904 \}$$

Subject's frequency of codon pair k:

$${q}_{1}^{k} = \frac{{θ}_{CC , 1}^{k}}{{\sum }_{j = 1}^{420} [ {θ}_{AA , 1}^{j} \times 1 \{ {β}^{j} = f ( {ρ}^{k} ) \} ]} ∀ k ∈ \{ 1 , 2 , … , 3904 \}$$

Host's count for amino acid pair j:

$${θ}_{AA , 0}^{j} = {\sum }_{i = 1}^{{n}^{′} - 1} 1 \{ g ( {τ}_{i , 0} , {τ}_{( i + 1 ) , 0} ) = {β}^{j} \} ∀ j ∈ \{ 1 , 2 , … , 420 \}$$

Host's count for codon pair k:

$${θ}_{CC , 1}^{k} = {\sum }_{i = 1}^{{n}^{′} - 1} 1 \{ {γ}_{i , 0} = {ρ}^{k} \} ∀ k ∈ \{ 1 , 2 , … , 3904 \}$$

Host's frequency of codon pair k:

$${q}_{0}^{k} = \frac{{θ}_{CC , 0}^{k}}{{\sum }_{j = 1}^{420} [ {θ}_{AA , 0}^{j} \times 1 \{ {β}^{j} = f ( {ρ}^{k} ) \} ]} ∀ k ∈ \{ 1 , 2 , … , 3904 \}$$

By denoting the CC distributions of the host and the subject as q₀ and q₁, the CC fitness of the subject is expressed as:

$${Ψ}_{CC} = - \frac{‖ {q}_{0} - {q}_{1} ‖}{3904} = - \frac{{\sum }_{k = 1}^{3904} \vert {q}_{0}^{k} - {q}_{1}^{k} \vert}{3904}$$

Consequently, the mathematical formulation of the CC optimization problem is as follows:

$$max Z = {Ψ}_{CC} \\ s . t . {S}_{A , 1} = {\{ {τ}_{i , 1} \}}_{i = 1}^{n} \\ {S}_{CC , 1} = {\{ {γ}_{i , 1} \}}_{i = 1}^{n} \\ f ( {γ}_{i , 1} ) = g ( {τ}_{i , 1} , {τ}_{( i + t ) , 1} ) ∀ i ∈ \{ 1 , … , n - 1 \} \\ {θ}_{AA , 0}^{j} = {\sum }_{i = 1}^{n - 1} 1 \{ g ( {τ}_{i , 1} , {τ}_{( i + 1 ) , 1} ) = {β}^{j} \} ∀ j ∈ \{ 1 , 2 , … , 420 \} \\ {θ}_{CC , 1}^{k} = {\sum }_{i = 1}^{n - 1} 1 \{ {γ}_{i , 1} = {ρ}^{k} \} ∀ k ∈ \{ 1 , 2 , … , 3904 \} \\ {q}_{1}^{k} = \frac{{θ}_{CC , 1}^{k}}{{\sum }_{j = 1}^{420} [ {θ}_{AAP , 1}^{j} \times 1 \{ {β}^{j} = f ( {ρ}^{k} ) \} ]} ∀ k ∈ \{ 1 , 2 , … , 3904 \} \\ {θ}_{AA , 0}^{j} = {\sum }_{i = 1}^{{n}^{′} - 1} 1 \{ g ( {τ}_{i , 0} , {τ}_{( i + 1 ) , 0} ) = {β}^{j} \} ∀ j ∈ \{ 1 , 2 , … , 420 \} \\ {θ}_{CC , 0}^{k} = {\sum }_{i = 1}^{{n}^{′} - 1} 1 \{ {γ}_{i , 0} = {ρ}^{k} \} ∀ k ∈ \{ 1 , 2 , … , 3904 \} \\ {q}_{0}^{k} = \frac{{θ}_{CC , 0}^{k}}{{\sum }_{j = 1}^{420} [ {θ}_{AA , 0}^{j} \times 1 \{ {β}^{j} = f ( {ρ}^{k} ) \} ]} ∀ k ∈ \{ 1 , 2 , … , 3904 \} \\ {Ψ}_{CC} = - \frac{{\sum }_{k = 1}^{3904} \vert {q}_{0}^{k} - {q}_{1}^{k} \vert}{3904} \qquad ( P 2 )$$

The above MINLP problem can also be recast into an MILP problem using the same strategy shown earlier in ICO to harness the more efficient MILP solvers to find an optimal sequence design. Due to the large discrete nonlinear search space, existing MILP solvers which use either branch-and-bound or branch-and-cut methods will still require huge amount of computational resources to find the optimum solution. Therefore, the genetic algorithm is used to solve (P2) as it provides an intuitive framework whereby codons are “evolved” towards optimal CC through techniques mimicking natural evolutionary processes such as selection, crossover or recombination and mutation.

The steps involved in the implementation of genetic algorithm for CC optimization is as follows:
C1. Randomly initialize a population of coding sequences for target protein.
C2. Evaluate the CC fitness of each sequence in the population.
C3. Rank the sequences by CC fitness and check termination criterion.
C4. If termination criterion is not satisfied, select the “fittest” sequences (top 50% of the population) as the parents for creation of offspring via recombination and mutation.
C5. Combine the parents and offspring to form a new population.
C6. Repeat steps 2 to 5 until termination criterion is satisfied.

In step 3, the termination criterion depends on the degree of improvement in best CC fitness values for consecutive generations of the genetic algorithm. If the improvement in CC fitness across many generations is not significant, the algorithm is said to have converged. In the present disclosure, the CC optimization algorithm will terminate when there is less than 0.5% increase in CC fitness across 100 generations, Ψ_{CC}^{(r+100)}/Ψ_{CC}^{(r)}<0.005 where r refers to the r^{th} generation of the genetic algorithm. When the termination criterion is not satisfied, the subsequent step 4 will perform an elitist selection such that the fittest 50% of the population are always selected for reproduction of offspring through recombination and mutation. During recombination, a pair of parents is chosen at random and a crossover is carried out at a randomly selected position in the parents' sequences to create 2 new individuals as offspring. The offspring subsequently undergo a random point mutation before they are combined with the parents to form the new generation.

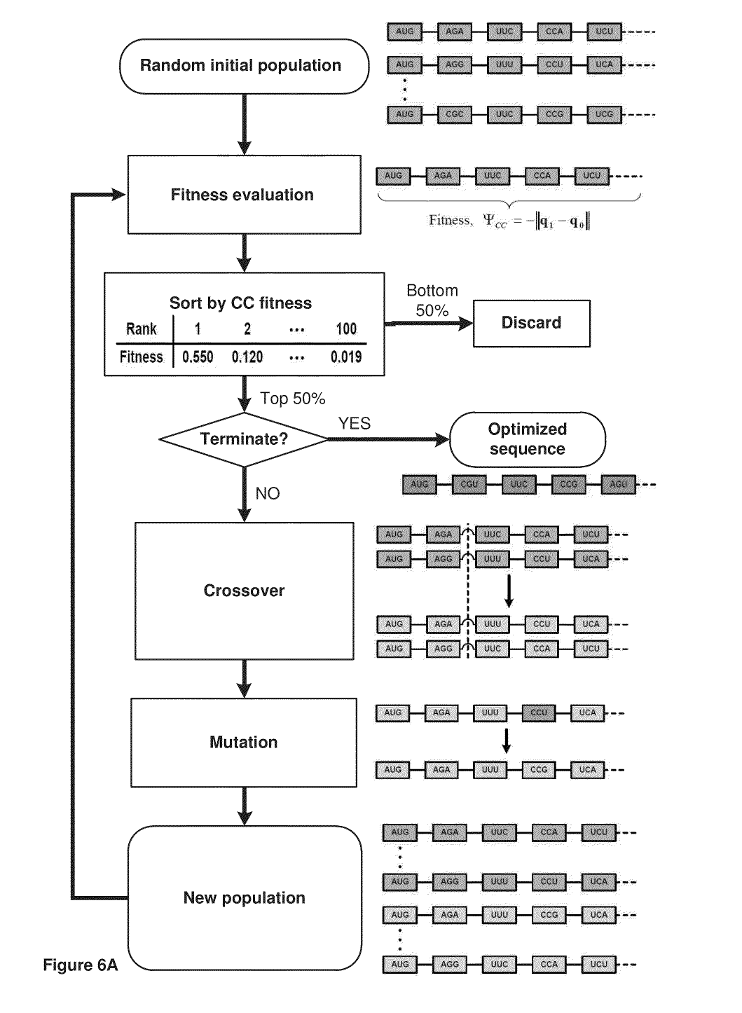

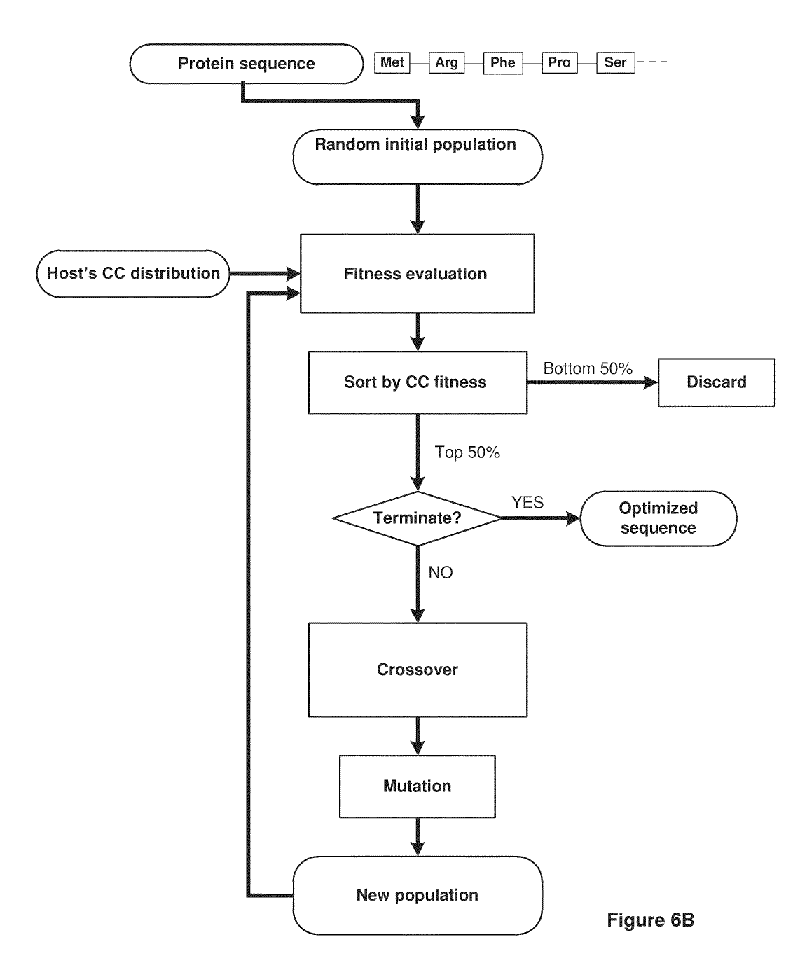

Unlike traditional implementations of genetic algorithm where individuals in the population are represented as 0-1 bit strings, the presented CC optimization algorithm represents each individual as a sequential list of character triplets indicating the respective codons. Therefore, the codons can be manipulated directly with reference to a hash table which defines the synonymous codons for each amino acid. As a result, the protein encoded by the coding sequences is always the same in the genetic algorithm since crossovers only occur at the boundary of the codon triplets and mutation is always performed with reference to the hash table of synonymous codons for each respective amino acid. The hash table is constructed according to Table-3. The CCO algorithm is implemented whereby the codon fitness values of a population of sequence candidates are improved through selection, recombination and mutation (see FIGS. 6A and 6B). Unlike conventional genetic algorithm (GA) representation of individuals as 0-1 bit string, CCO represents the individuals as a string of characters which directly depicts the codons used for each amino acid. Therefore, for the evaluation of codon context fitness, the individual sequences are processed to calculate the respective codon context frequencies before it is compared with the host's. During selection, only top 50% of the fittest individuals are selected as parents for reproduction while the rest are discarded.

These parents are then randomly paired up for crossover at random points along the coding sequence to generate offspring that replace the discarded individuals. Random point mutation is then performed on each offspring individual to create diversity. It is noted that during crossover, special care is taken that the crossover point lies exactly on the boundary of two adjacent codons such that the resultant protein sequence will not be altered. Furthermore, duplicates are removed at each iteration to ensure that the population is not dominated by a particular sequence which can lead to the algorithm being stuck with a suboptimal solution. By specifically using the codon context distribution of the host's high-expressed genes as input parameter, the CCO algorithm can generate sequences similar to the native genes, thus capable of high expression levels.

### 1.6 Multi-Objective Codon Optimization (MOCO)

Based on the formulations for ICU and CC optimization, the MOCO problem can be mathematically formulated as follows:

$$max Z = ( {Ψ}_{ICU} , {Ψ}_{CC} ) \\ s . t . {S}_{A , 1} = {\{ {τ}_{i , 1} \}}_{i = 1}^{n} \\ {S}_{C , 1} = {\{ {λ}_{i , 1} \}}_{i = 1}^{n} \\ {S}_{CC , 1} = {\{ {γ}_{i , 1} \}}_{i = 1}^{n - 1} \\ f ( {λ}_{i , 1} ) = {τ}_{i , 1} ∀ i ∈ \{ 1 , … , n \} \\ f ( {γ}_{i , 1} ) = g ( {τ}_{i , 1} , {τ}_{( i + t ) , 1} ) ∀ i ∈ \{ 1 , … , n - 1 \} \\ {θ}_{A , 1}^{j} = {\sum }_{i = 1}^{n} 1 \{ {τ}_{i , 1} = {α}^{j} \} ∀ j ∈ \{ 1 , 2 , … , 21 \} \\ {θ}_{C , 1}^{k} = {\sum }_{i = 1}^{n} 1 \{ {γ}_{i , 1} = {κ}^{k} \} ∀ k ∈ \{ 1 , 2 , … , 64 \} \\ {p}_{1}^{k} = \frac{{θ}_{C , 1}^{k}}{{\sum }_{j = 1}^{21} [ {θ}_{A , 1}^{j} \times 1 \{ {α}^{j} = f ( {κ}^{k} ) \} ]} ∀ k ∈ \{ 1 , 2 , … , 64 \} \\ {θ}_{A , 0}^{j} = {\sum }_{i = 1}^{{n}^{′}} 1 \{ {τ}_{i , 0} = {α}^{j} \} ∀ j ∈ \{ 1 , 2 , … , 21 \} \\ {θ}_{C , 0}^{k} = {\sum }_{i = 1}^{n} 1 \{ {λ}_{i , 0} = {κ}^{k} \} ∀ k ∈ \{ 1 , 2 , … , 64 \} \\ {p}_{0}^{k} = \frac{{θ}_{C , 0}^{k}}{{\sum }_{j = 1}^{21} [ {θ}_{A , 0}^{j} \times 1 \{ {α}^{j} = f ( {κ}^{k} ) \} ]} ∀ k ∈ \{ 1 , 2 , … , 64 \} \\ {θ}_{AA , 1}^{j} = {\sum }_{i = 1}^{n - 1} 1 \{ g ( {τ}_{i , 1} , {τ}_{( i + 1 ) , 1} ) = {β}^{j} \} ∀ j ∈ \{ 1 , 2 , … , 420 \} \\ {θ}_{CC , 1}^{k} = {\sum }_{i = 1}^{n - 1} 1 \{ {γ}_{i , 1} = {ρ}^{k} \} ∀ k ∈ \{ 1 , 2 , … , 3904 \} \\ {q}_{1}^{k} = \frac{{θ}_{CC , 1}^{k}}{{\sum }_{j = 1}^{420} [ {θ}_{AA , 1}^{j} \times 1 \{ {β}^{j} = f ( {ρ}^{k} ) \} ]} ∀ k ∈ \{ 1 , 2 , … , 3904 \} \\ {θ}_{AA , 0}^{j} = {\sum }_{i = 1}^{{n}^{′} - 1} 1 \{ g ( {τ}_{i , 0} , {τ}_{( i + 1 ) , 0} ) = {β}^{j} \} ∀ j ∈ \{ 1 , 2 , … , 420 \} \\ {θ}_{CC , 0}^{k} = {\sum }_{i = 1}^{{n}^{′} - 1} 1 \{ {γ}_{i , 0} = {ρ}^{k} \} ∀ k ∈ \{ 1 , 2 , … , 3904 \} \\ {q}_{0}^{k} = \frac{{θ}_{CC , 0}^{k}}{{\sum }_{j = 1}^{420} [ {θ}_{AA , 0}^{j} \times 1 \{ {β}^{j} = f ( {ρ}^{k} ) \} ]} ∀ k ∈ \{ 1 , 2 , … , 3904 \} \\ {Ψ}_{ICU} = - \frac{{\sum }_{k = 1}^{64} \vert {p}_{0}^{k} - {p}_{1}^{k} \vert}{64} \\ {Ψ}_{CC} = - \frac{{\sum }_{k = 1}^{3904} \vert {q}_{0}^{k} - {q}_{1}^{k} \vert}{3904} \qquad ( P6 )$$

Due to the complexity attributed to CC optimization, solution to (P6) will also require a heuristic method. In this case, the nondominated sorting genetic algorithm-II (NSGA-II) is used to solve the nonlinear multi-objective optimization problem. The procedure for NSGA-II is similar to that presented for CC optimization except for additional steps required to identify the nondominated solution sets and the ranking of these sets to identify the pareto optimum front. The NSGA-II procedure for solving the MOCO problem is as follows:
M1. Randomly initialize a population of coding sequences for target protein.
M2. Evaluate ICU and CC fitness of each sequence in the population.
M3. Group the sequences into nondominated sets and rank the sets.
M4. Check termination criterion.
M5. If termination criterion is not satisfied, select the “fittest” sequences (top 50% of the population) as the parents for creation of offspring via recombination and mutation.
M6. Combine the parents and offspring to form a new population.
M7. Repeat steps 2 to 5 until termination criterion is satisfied.

The identification and ranking of nondominated sets in step 3 is performed via pair-wise comparison of the sequences' ICU and CC fitness. For a given pair of sequences with fitness values expressed as (Ψ_{ICU}¹, Ψ_{ICU}¹) and Ψ_{ICU}², Ψ_{ICU}²), the domination status can be evaluated as follows:
If (Ψ_{ICU}¹>Ψ_{ICU}²) and (Ψ_{ICU}¹≧Ψ_{ICU}²), sequence 1 dominates sequence 2.
If (Ψ_{ICU}¹≧Ψ_{ICU}²) and (Ψ_{ICU}¹>Ψ_{ICU}²), sequence 1 dominates sequence 2.
If (Ψ_{ICU}¹<Ψ_{ICU}²) and (Ψ_{ICU}¹≦Ψ_{ICU}²), sequence 2 dominates sequence 1.
   If (Ψ_{ICU}¹≦Ψ_{ICU}²) and (Ψ_{ICU}¹<Ψ_{ICU}²), sequence 2 dominates sequence 1.

Whenever a particular sequence is found to be dominated by another sequence, the domination rank of the former sequence is lowered. As such, the grouping and sorting of the nondominated sets are performed simultaneously in step 3 using the pseudo code:

Initialize domination ranks of all individuals to zero;
For every individual i where i loops from 1 to (n−1),

For every individual j where j loops from i to n,

If individual i dominates individual j,

Increment domination value of j;

Else if individual j dominates individual I,

Increment domination value of i;

Sort individuals based on domination ranks;

In the original nondominated sorting algorithm, the set of individuals that is dominated by every individual is stored in the memory. Therefore, for a total population of n, the total storage requirement is O(n²). However, for the abovementioned algorithm, only O(n) storage is required for storing the domination value of each individual. In terms of computational complexity, both the original and modified algorithm requires at most O(mn²) computations for m objective values since all the n individuals have to be compared pair-wise for every objective to be optimized. Therefore, the nondominated sorting algorithm presented in the present disclosure is superior on the whole, especially with regards to computational storage requirement which can become an important issue when dealing with long coding sequences.

### Example 2

### Codon Optimization of Another Set of High-Expression Genes in E. coli

ICO, CCO and MOCO were carried out using the set of high-expression genes to evaluate the relative performance of the methods.

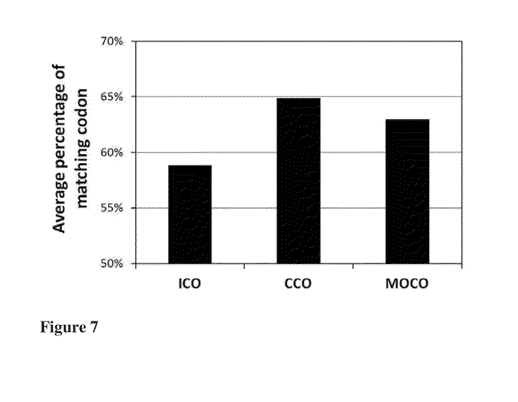

A list of 27 high-expression genes (Table 4) has been used to establish a correlation between codon usage bias and gene expression. Note, Table 4A provides a full description of the sequences according to the instant subject matter. Using these genes, the in silico leave-one-out cross validation was performed to evaluate the performance of ICO, CCO and MOCO methods. Results showed that CCO generally produces sequences that best matches the wild-type highly expressed sequences, followed by the MOCO and ICO methods (FIG. 7). The optimized sequences are compared pairwise in a tournament style based on their percentage of matching codons with the respective wild-type sequences to generate the tournament matrix (Table 5). It was observed that CCO performed better than ICO and MOCO in at least 70% of the instances. This result is consistent with that presented in the main manuscript, indicating that CC fitness is a more important design criterion than ICU fitness for gene optimization.

TABLE 4
List of high-expression genes

| Gene | Locus tag | Product |
|---|---|---|
| rpsU | b3065 | 30S ribosomal subunit protein S21 |
| rpsJ | b3321 | 30S ribosomal subunit protein S10 |
| rpsL | b3342 | 30S ribosomal subunit protein S12 |
| rpsT | b0023 | 30S ribosomal subunit protein S20 |
| rpsA | b0911 | 30S ribosomal subunit protein S1 |
| rpsB | b0169 | 30S ribosomal subunit protein S2 |
| rpsO | b3165 | 30S ribosomal subunit protein S15 |
| rpsG | b3341 | 30S ribosomal subunit protein S7 |
| rpmB | b3637 | 50S ribosomal subunit protein L28 |
| rpmG | b3636 | 50S ribosomal subunit protein L33 |
| rpmH | b3703 | 50S ribosomal subunit protein L34 |
| rplK | b3983 | 50S ribosomal subunit protein L11 |
| rplJ | b3985 | 50S ribosomal subunit protein L10 |
| rplA | b3984 | 50S ribosomal subunit protein L1 |
| rplL | b3986 | 50S ribosomal subunit protein L7/L12 |
| rplQ | b3294 | 50S ribosomal subunit protein L17 |
| rplC | b3320 | 50S ribosomal subunit protein L3 |
| lpp | b1677 | murein lipoprotein |
| ompA | b0957 | outer membrane protein A (3a; II*; G;d) |
| ompC | b2215 | outer membrane porin protein C |
| ompF | b0929 | outer membrane porin 1a (Ia; b; F) |
| tufA | b3339 | protein chain elongation factor EF-Tu (duplicate |
| | | of tufB) |
| tufB | b3980 | protein chain elongation factor EF-Tu (duplicate |
| | | of tufA) |
| tsf | b0170 | protein chain elongation factor EF-Ts |
| fusA | b3340 | protein chain elongation factor EF-G, GTP- |
| | | binding |
| recA | b2699 | DNA strand exchange and recombination protein |
| | | with protease and nuclease activity |
| dnaK | b0014 | chaperone Hsp70, co-chaperone with DnaJ |

TABLE 4A
Descriptions of Sequence Listings

SEQ ID NO. 1 to SEQ ID NO. 180:
High expression genes with Locus Tag of b0008, b0014, b0095, b0114, b0115, b0116,
b0126, b0169, b0170, b0179, b0197, b0220, b0407, b0474, b0525, b0565, b0605,
b0623, b0727, b0728, b0741, b0742, b0755, b0811, b0812, b0814, b0880, b0884,
b0889, b0903, b0911, b0912, b0928, b0929, b0953, b0957, b1051, b1088, b1089,
b1091, b1092, b1093, b1094, b1101, b1136, b1237, b1243, b1324, b1480, b1583,
b1603, b1641, b1656, b1677, b1712, b1713, b1716, b1717, b1719, b1761, b1779,
b1818, b1823, b1824, b1920, b2007, b2029, b2093, b2094, b2095, b2096, b2175,
b2185, b2215, b2285, b2296, b2323, b2414, b2415, b2416, b2417, b2478, b2528,
b2572, b2597, b2606, b2607, b2608, b2609, b2696, b2697, b2741, b2742, b2779,
b2780, b2891, b2904, b2913, b2926, b3065, b3097, b3098, b3169, b3186, b3212,
b3213, b3230, b3231, b3236, b3255, b3261, b3294, b3295, b3296, b3297, b3299,
b3300, b3301, b3302, b3303, b3304, b3305, b3306, b3307, b3308, b3309, b3310,
b3311, b3312, b3313, b3314, b3315, b3316, b3317, b3318, b3319, b3320, b3321,
b3340, b3341, b3342, b3357, b3433, b3460, b3495, b3510, b3610, b3636, b3637,
b3649, b3672, b3703, b3730, b3733, b3734, b3735, b3737, b3738, b3751, b3766,
b3781, b3829, b3936, b3983, b3984, b3985, b3986, b3987, b4000, b4014, b4015,
b4142, b4171, b4172, b4200, b4201, b4202, b4243, b4245, b4255,
in Escherichia coli correspondingly.
SEQ ID NO. 181 to SEQ ID NO. 349:
Low expression genes with Locus Tag of b0136, b0278, b0279, b0295, b0303, b0326,
b0375, b0517, b0531, b0535, b0544, b0554, b0558, b0564, b0566, b0603, b0645,
b0647, b0702, b0716, b0769, b1001, b1007, b1023, b1024, b1043, b1058, b1121,
b1137, b1139, b1140, b1159, b1161, b1167, b1168, b1309, b1346, b1347, b1351,
b1352, b1353, b1357, b1363, b1409, b1445, b1455, b1470, b1497, b1499, b1502,
b1503, b1527, b1549, b1551, b1552, b1555, b1557, b1575, b1580, b1581, b1673,
b1690, b1691, b1696, b1730, b1788, b1968, b2055, b2056, b2108, b2110, b2111,
b2190, b2273, b2274, b2275, b2334, b2339, b2345, b2363, b2367, b2370, b2376,
b2448, b2483, b2623, b2625, b2626, b2642, b2646, b2778, b2846, b2847, b2849,
b2850, b2851, b2852, b2853, b2854, b2858, b2870, b2934, b3014, b3027, b3047,
b3048, b3119, b3120, b3121, b3138, b3144, b3215, b3264, b3442, b3443, b3482,
b3483, b3488, b3504, b3563, b3577, b3578, b3587, b3593, b3594, b3596, b3720,
b3721, b3723, b3817, b3818, b3875, b3876, b3896, b4017, b4038, b4047, b4048,
b4066, b4120, b4128, b4133, b4181, b4204, b4215, b4253, b4257, b4268, b4279,
b4311, b4365, b4494, b4519, b4524, b4526, b4533, b4541, b4559, b4586, b4588,
b4589, b4590, b4593, b4601, b4604, b4612, b4621, b4655, b4660,
in Escherichia coli correspondingly.
SEQ ID NO.350 to SEQ ID NO. 544:
High expression genes with Locus Tag of acmA, acmB, acmD, acpA, adhE, ahpC,
aldB, als, amyL, apl, arcD1, arcT, aroH, bar, bcaT, bmpA, choS,
citC, citD, citE, citF, cmk, codZ, comGD, cpsM, cspE, ctrA,
ctsR, cysS, dacA, dacB, dltC, dnaH, dpsA, efp, enoA, folC, frdC,
ftsE, fusA, gapB, gidA, glnR, gltD, grpE, gyrA, hsdS, icaA, ileS,
ilvC, ilvN, infA, kdgK, kinC, leuB, leuC, leuD, mtlD, mtsA, obgL,
oppB, optA, optD, pabB, pacL, pepT, pi115, pi116, pi125, pi129, pi135,
pi218, pi231, pi237, pi245, pi246, pi303, pi318, pi319, pi330, pi331, pi338,
pmpA, potB, potD, ppiB, prfA, proS, ps219, ptnC, ptsH, pyk, rbsD,
rcfA, recM, rgpE, rheA, rliB, rluB, rmaH, rmeA, rmlC, rnc, rnhA,
rnhB, rnpA, rplQ, rplT, rplV, rpmE, rpmH, rpmJ, rpoA, rpoE, rpsA,
rpsF, rpsI, rpsJ, rpsN, rpsO, rpsQ, rpsS, rpsU, serA, serB, serC,
thiE, tra905, trpD, tuf, usp45, ybaA, ybcG, ybeF, ybjD, ycdC, ycgD,
ychE, yddC, ydgC, ydhB, ydiD, ydjB, yedA, yhgD, yhjA, yhjE, yiiG,
yjaJ, yjfI, yjjB, ykbA, ykdB, ykjA, yliD, ymbC, ymcC, ymeB, yogL,
yohD, yoiB, ypdD, yphH, ypiA, ypjA, yraA, yrbB, yrbD, yrbF, yrcB,
yrjE, ysdB, ysdC, ysfG, ysxL, ytdA, ytdB, ytdF, ytgC, ytgG, ytgH,
yuaE, yueC, yueE, yuhC, yvcA, yvcC, yvdB, yvdF, yveC, yveH, ywdB,
ywfH, ywhA, yxbC,
in Lactococcus lactis correspondingly.
SEQ ID NO.545 to SEQ ID NO. 751:
Low expression genes with Locus Tag of aldC, cdd, ceo, chiA, coiA, comC,
comFC, copB, fabG2, fbp, glpT, hisZ, hprT, lmrA, menD, menE,
metB1, metB2, metE, metF, mleR, mtlF, mtlR, noxE, oppA, pbuX, pdc,
phnC, pi109, pi130, pi138, pi143, pi147, pi203, pi204, pi205, pi207, pi209,
pi210, pi211, pi215, pi216, pi223, pi225, pi229, pi235, pi240, pi241, pi248,
pi301, pi316, pi321, pi341, pi345, pi347, pi354, plpA, plpC, ps111, ps211,
ps307, ps309, ps311, ps312, ps314, ptcA, purK, pyrR, rbsB, rlrC, rmaD,
rplC, rplF, rplJ, rplK, rplL, rpmGA, rpmGC, sigX, ssbA,
sugE, tagB, tagF, tagR, tagY, trpE, trxB2, udk, uxuA, uxuB, xpt,
xylB, xylH, xynB, yabA, yaiI, yajB, ybcC, ybdG, ybhD, ybiI, ycdF,
yceG, yceJ, ycfI, ycgB, yciF, ycjG, ydaF, ydiG, yeaB, yebA, yeeD,
yeeG, yeiF, yejC, yfbB, yfbI, yfbK, yfcA, yfcD, yfdC, yfgC, yfgQ,
yfhC, yfhF, yfhL, yfiA, yfiD, yfiG, yfjE, yfjG, yfjH, ygdD, ygdF,
ygfC, ygfE, yhbE, yhdA, yhdC, yhjB, yhjG, yieF, yigC, yihB, yihD,
yiiD, yijF, yjdi, yjfB, ykaE, ykcB, ykhE, ykhJ, ykhK, ykjC, ylgB,
yliC, yliF, yljC, yljD, yljH, ymaB, ymbG, ymfD, yneE, yniI, ynjD,
ynjF, yohH, yoiC, ypaG, ypbB, yphK, ypiE, ypiH, ypiK, yqbH, yqbI,
yqbJ, yqcB, yqcD, yqfC, yqfG, yqhA, yqjA, yqjE, yrbE, yrbH, yrgE,
yseA, yseC, yseE, ysgA, yshA, ytbA, yteD, yteE, ytjD, yveD, yvfB,
ywaC, ywfB, ywiC, yxbF, yxdE, zitS,
in Lactococcus lactis correspondingly
SEQ ID NO. 752 to SEQ ID NO. 1002:
High expression genes with Locus Tag of
PAS_c131_0011, PAS_c131_0017, PAS_chr1-1_0002, PAS_chr1-
1_0008, PAS_chr1-1_0030, PAS_chr1-1_0037, PAS_chr1-1_0072, PAS_chr1-
1_0107, PAS_chr1-1_0118, PAS_chr1-1_0171, PAS_chr1-1_0180, PAS_chr1-
1_0183, PAS_chr1-1_0200, PAS_chr1-1_0216, PAS_chr1-1_0218, PAS_chr1-1_0226,
PAS_chr1-1_0257, PAS_chr1-1_0283, PAS_chr1-1_0302, PAS_chr1-1_0307,
PAS_chr1-1_0315, PAS_chr1-1_0319, PAS_chr1-1_0378, PAS_chr1-1_0407,
PAS_chr1-1_0417, PAS_chr1-1_0432, PAS_chr1-1_0433, PAS_chr1-1_0448,
PAS_chr1-1_0475, PAS_chr1-3_0034, PAS_chr1-3_0059, PAS_chr1-3_0102,
PAS_chr1-3_0104, PAS_chr1-3_0115, PAS_chr1-3_0172, PAS_chr1-3_0191,
PAS_chr1-3_0202, PAS_chr1-3_0229, PAS_chr1-3_0253, PAS_chr1-4_0003,
PAS_chr1-4_0027, PAS_chr1-4_0042, PAS_chr1-4_0043, PAS_chr1-4_0049,
PAS_chr1-4_0063, PAS_chr1-4_0090, PAS_chr1-4_0130, PAS_chr1-4_0239,
PAS_chr1-4_0249, PAS_chr1-4_0264, PAS_chr1-4_0275, PAS_chr1-4_0292,
PAS_chr1-4_0294, PAS_chr1-4_0303, PAS_chr1-4_0339, PAS_chr1-4_0352,
PAS_chr1-4_0367, PAS_chr1-4_0412, PAS_chr1-4_0422, PAS_chr1-4_0426,
PAS_chr1-4_0465, PAS_chr1-4_0481, PAS_chr1-4_0491, PAS_chr1-4_0504,
PAS_chr1-4_0516, PAS_chr1-4_0546, PAS_chr1-4_0547, PAS_chr1-4_0569,
PAS_chr1-4_0570, PAS_chr1-4_0586, PAS_chr1-4_0589, PAS_chr1-4_0659,
PAS_chr1-4_0699, PAS_chr2-1_0022, PAS_chr2-1_0023, PAS_chr2-1_0072,
PAS_chr2-1_0136, PAS_chr2-1_0210, PAS_chr2-1_0218, PAS_chr2-1_0238,
PAS_chr2-1_0254, PAS_chr2-1_0308, PAS_chr2-1_0313, PAS_chr2-1_0324,
PAS_chr2-1_0362, PAS_chr2-1_0363, PAS_chr2-1_0365, PAS_chr2-1_0376,
PAS_chr2-1_0428, PAS_chr2-1_0429, PAS_chr2-1_0437, PAS_chr2-1_0454,
PAS_chr2-1_0472, PAS_chr2-1_0481, PAS_chr2-1_0483, PAS_chr2-1_0486,
PAS_chr2-1_0489, PAS_chr2-1_0502, PAS_chr2-1_0522, PAS_chr2-1_0543,
PAS_chr2-1_0584, PAS_chr2-1_0624, PAS_chr2-1_0661, PAS_chr2-1_0701,
PAS_chr2-1_0728, PAS_chr2-1_0748, PAS_chr2-1_0758, PAS_chr2-1_0769,
PAS_chr2-1_0785, PAS_chr2-1_0809, PAS_chr2-1_0812, PAS_chr2-1_0853,
PAS_chr2-1_0887, PAS_chr2-2_0019, PAS_chr2-2_0048, PAS_chr2-2_0054,
PAS_chr2-2_0059, PAS_chr2-2_0062, PAS_chr2-2_0064, PAS_chr2-2_0109,
PAS_chr2-2_0127, PAS_chr2-2_0131, PAS_chr2-2_0148, PAS_chr2-2_0165,
PAS_chr2-2_0186, PAS_chr2-2_0199, PAS_chr2-2_0200, PAS_chr2-2_0220,
PAS_chr2-2_0266, PAS_chr2-2_0267, PAS_chr2-2_0301, PAS_chr2-2_0326,
PAS_chr2-2_0337, PAS_chr2-2_0380, PAS_chr2-2_0419, PAS_chr3_0040,
PAS_chr3_0054, PAS_chr3_0059, PAS_chr3_0082, PAS_chr3_0091,
PAS_chr3_0099, PAS_chr3_0167, PAS_chr3_0188, PAS_chr3_0227,
PAS_chr3_0230, PAS_chr3_0277, PAS_chr3_0287, PAS_chr3_0361,
PAS_chr3_0362, PAS_chr3_0372, PAS_chr3_0374, PAS_chr3_0393,
PAS_chr3_0408, PAS_chr3_0456, PAS_chr3_0494, PAS_chr3_0505,
PAS_chr3_0528, PAS_chr3_0535, PAS_chr3_0567, PAS_chr3_0576,
PAS_chr3_0595, PAS_chr3_0640, PAS_chr3_0648, PAS_chr3_0694,
PAS_chr3_0722, PAS_chr3_0731, PAS_chr3_0744, PAS_chr3_0762,
PAS_chr3_0808, PAS_chr3_0815, PAS_chr3_0836, PAS_chr3_0837,
PAS_chr3_0841, PAS_chr3_0868, PAS_chr3_0870, PAS_chr3_0932,
PAS_chr3_0951, PAS_chr3_0955, PAS_chr3_0957, PAS_chr3_0965,
PAS_chr3_1028, PAS_chr3_1057, PAS_chr3_1071, PAS_chr3_1087,
PAS_chr3_1111, PAS_chr3_1162, PAS_chr3_1167, PAS_chr3_1169,
PAS_chr3_1199, PAS_chr3_1200, PAS_chr3_1209, PAS_chr4_0018,
PAS_chr4_0043, PAS_chr4_0080, PAS_chr4_0102, PAS_chr4_0139,
PAS_chr4_0151, PAS_chr4_0164, PAS_chr4_0180, PAS_chr4_0185,
PAS_chr4_0210, PAS_chr4_0246, PAS_chr4_0248, PAS_chr4_0255,
PAS_chr4_0284, PAS_chr4_0287, PAS_chr4_0292, PAS_chr4_0330,
PAS_chr4_0342, PAS_chr4_0348, PAS_chr4_0405, PAS_chr4_0412,
PAS_chr4_0414, PAS_chr4_0431, PAS_chr4_0433, PAS_chr4_0456,
PAS_chr4_0488, PAS_chr4_0516, PAS_chr4_0524, PAS_chr4_0550,
PAS_chr4_0552, PAS_chr4_0578, PAS_chr4_0624, PAS_chr4_0627,
PAS_chr4_0680, PAS_chr4_0684, PAS_chr4_0688, PAS_chr4_0720,
PAS_chr4_0733, PAS_chr4_0762, PAS_chr4_0783, PAS_chr4_0785,
PAS_chr4_0786, PAS_chr4_0815, PAS_chr4_0828, PAS_chr4_0832,
PAS_chr4_0840, PAS_chr4_0842, PAS_chr4_0883, PAS_chr4_0943,
PAS_chr4_0947, PAS_chr4_0953, PAS_chr4_0981, PAS_FragB_0052,
PAS_FragB_0061, PAS_FragB_0064, PAS_FragB_0065, PAS_FragB_0074,
PAS_FragD_0013, PAS_FragD_0014, PAS_FragD_0026,
in Pichia pastoris correspondingly
SEQ ID NO.1003 to SEQ ID NO. 1253:
Low expression genes with Locus Tag of
PAS_c121_0014, PAS_c121_0016, PAS_chr1-1_0021, PAS_chr1-
1_0026, PAS_chr1-1_0047, PAS_chr1-1_0068, PAS_chr1-1_0082, PAS_chr1-
1_0093, PAS_chr1-1_0126, PAS_chr1-1_0149, PAS_chr1-1_0178, PAS_chr1-
1_0207, PAS_chr1-1_0210, PAS_chr1-1_0228, PAS_chr1-1_0242, PAS_chr1-
1_0251, PAS_chr1-1_0256, PAS_chr1-1_0261, PAS_chr1-1_0263, PAS_chr1-
1_0288, PAS_chr1-1_0306, PAS_chr1-1_0325, PAS_chr1-1_0334, PAS_chr1-
1_0347, PAS_chr1-1_0365, PAS_chr1-1_0379, PAS_chr1-1_0386, PAS_chr1-
1_0437, PAS_chr1-1_0477, PAS_chr1-1_0483, PAS_chr1-1_0492, PAS_chr1-
3_0003, PAS_chr1-3_0021, PAS_chr1-3_0058, PAS_chr1-3_0073, PAS_chr1-
3_0091, PAS_chr1-3_0120, PAS_chr1-3_0129, PAS_chr1-3_0146, PAS_chr1-
3_0213, PAS_chr1-3_0247, PAS_chr1-3_0278, PAS_chr1-3_0290, PAS_chr1-
3_0303, PAS_chr1-3_0304, PAS_chr1-3_0308, PAS_chr1-3_0311, PAS_chr1-
4_0001, PAS_chr1-4_0076, PAS_chr1-4_0097, PAS_chr1-4_0129, PAS_chr1-
4_0143, PAS_chr1-4_0157, PAS_chr1-4_0189, PAS_chr1-4_0216, PAS_chr1-
4_0228, PAS_chr1-4_0251, PAS_chr1-4_0272, PAS_chr1-4_0301, PAS_chr1-
4_0373, PAS_chr1-4_0374, PAS_chr1-4_0377, PAS_chr1-4_0388, PAS_chr1-
4_0402, PAS_chr1-4_0444, PAS_chr1-4_0473, PAS_chr1-4_0483, PAS_chr1-
4_0495, PAS_chr1-4_0520, PAS_chr1-4_0521, PAS_chr1-4_0525, PAS_chr1-
4_0554, PAS_chr1-4_0568, PAS_chr1-4_0578, PAS_chr1-4_0581, PAS_chr1-
4_0582, PAS_chr1-4_0583, PAS_chr1-4_0665, PAS_chr1-4_0673, PAS_chr1-
4_0680, PAS_chr1-4_0687, PAS_chr1-4_0690, PAS_chr2-1_0004, PAS_chr2-
1_0010, PAS_chr2-1_0012, PAS_chr2-1_0020, PAS_chr2-1_0035, PAS_chr2-
1_0084, PAS_chr2-1_0148, PAS_chr2-1_0179, PAS_chr2-1_0195, PAS_chr2-
1_0198, PAS_chr2-1_0224, PAS_chr2-1_0252, PAS_chr2-1_0268, PAS_chr2-
1_0275, PAS_chr2-1_0296, PAS_chr2-1_0306, PAS_chr2-1_0312, PAS_chr2-
1_0317, PAS_chr2-1_0328, PAS_chr2-1_0332, PAS_chr2-1_0334, PAS_chr2-
1_0364, PAS_chr2-1_0381, PAS_chr2-1_0382, PAS_chr2-1_0386, PAS_chr2-
1_0420, PAS_chr2-1_0441, PAS_chr2-1_0443, PAS_chr2-1_0452, PAS_chr2-
1_0462, PAS_chr2-1_0471, PAS_chr2-1_0474, PAS_chr2-1_0493, PAS_chr2-
1_0515, PAS_chr2-1_0579, PAS_chr2-1_0586, PAS_chr2-1_0587, PAS_chr2-
1_0607, PAS_chr2-1_0618, PAS_chr2-1_0632, PAS_chr2-1_0653, PAS_chr2-
1_0654, PAS_chr2-1_0686, PAS_chr2-1_0822, PAS_chr2-1_0860, PAS_chr2-
1_0883, PAS_chr2-2_0003, PAS_chr2-2_0010, PAS_chr2-2_0012, PAS_chr2-
2_0031, PAS_chr2-2_0098, PAS_chr2-2_0180, PAS_chr2-2_0190, PAS_chr2-
2_0194, PAS_chr2-2_0224, PAS_chr2-2_0255, PAS_chr2-2_0308, PAS_chr2-
2_0336, PAS_chr2-2_0351, PAS_chr2-2_0376, PAS_chr2-2_0408,
PAS_chr3_0001, PAS_chr3_0005, PAS_chr3_0018, PAS_chr3_0025,
PAS_chr3_0049, PAS_chr3_0101, PAS_chr3_0138, PAS_chr3_0146,
PAS_chr3_0164, PAS_chr3_0171, PAS_chr3_0179, PAS_chr3_0184,
PAS_chr3_0185, PAS_chr3_0192, PAS_chr3_0198, PAS_chr3_0219,
PAS_chr3_0229, PAS_chr3_0247, PAS_chr3_0272, PAS_chr3_0302,
PAS_chr3_0315, PAS_chr3_0326, PAS_chr3_0338, PAS_chr3_0351,
PAS_chr3_0429, PAS_chr3_0446, PAS_chr3_0455, PAS_chr3_0470,
PAS_chr3_0476, PAS_chr3_0492, PAS_chr3_0496, PAS_chr3_0501,
PAS_chr3_0560, PAS_chr3_0563, PAS_chr3_0588, PAS_chr3_0601,
PAS_chr3_0639, PAS_chr3_0759, PAS_chr3_0794, PAS_chr3_0860,
PAS_chr3_0864, PAS_chr3_0872, PAS_chr3_0889, PAS_chr3_0902,
PAS_chr3_1000, PAS_chr3_1082, PAS_chr3_1128, PAS_chr3_1214,
PAS_chr3_1237, PAS_chr4_0003, PAS_chr4_0028, PAS_chr4_0039,
PAS_chr4_0048, PAS_chr4_0051, PAS_chr4_0062, PAS_chr4_0079,
PAS_chr4_0104, PAS_chr4_0117, PAS_chr4_0132, PAS_chr4_0133,
PAS_chr4_0145, PAS_chr4_0155, PAS_chr4_0159, PAS_chr4_0166,
PAS_chr4_0170, PAS_chr4_0230, PAS_chr4_0244, PAS_chr4_0286,
PAS_chr4_0296, PAS_chr4_0299, PAS_chr4_0304, PAS_chr4_0353,
PAS_chr4_0357, PAS_chr4_0358, PAS_chr4_0360, PAS_chr4_0365,
PAS_chr4_0385, PAS_chr4_0397, PAS_chr4_0417, PAS_chr4_0452,
PAS_chr4_0467, PAS_chr4_0477, PAS_chr4_0480, PAS_chr4_0481,
PAS_chr4_0502, PAS_chr4_0538, PAS_chr4_0556, PAS_chr4_0588,
PAS_chr4_0611, PAS_chr4_0620, PAS_chr4_0638, PAS_chr4_0676,
PAS_chr4_0691, PAS_chr4_0696, PAS_chr4_0718, PAS_chr4_0735,
PAS_chr4_0752, PAS_chr4_0878, PAS_chr4_0914, PAS_chr4_0919,
PAS_chr4_0929, PAS_chr4_0949, PAS_chr4_0957, PAS_chr4_0959,
PAS_chr4_0975, PAS_chr4_0995, PAS_FragB_0026, PAS_FragB_0032,
in Pichia pastoris correspondingly
SEQ ID NO. 1254 to SEQ ID NO. 1528:
High expression genes with Locus Tag of
YAL003W, YAL005C, YAL038W, YAL044C, YBL003C, YBL027W,
YBL072C, YBL087C, YBL092W, YBR010W, YBR011C,
YBR039W, YBR048W, YBR067C, YBR078W, YBR082C,
YBR106W, YBR191W, YBR196C, YBR286W, YCL018W, YCL030C,
YCL035C, YCL040W, YCL043C, YCR012W, YDL055C, YDL061C,
YDL067C, YDL075W, YDL081C, YDL082W, YDL125C,
YDL130W, YDL130W-A, YDL137W, YDL182W, YDL191W,
YDL192W, YDL208W, YDR012W, YDR032C, YDR033W, YDR050C,
YDR064W, YDR077W, YDR155C, YDR177W, YDR178W, YDR224C,
YDR225W, YDR226W, YDR233C, YDR276C, YDR322C-A, YDR341C,
YDR342C, YDR343C, YDR382W, YDR418W, YDR454C,
YDR471W, YDR497C, YDR500C, YDR529C, YEL009C, YEL017C-
A, YEL024W, YEL027W, YEL034W, YEL054C, YER011W, YER056C-
A, YER074W, YER091C, YER094C, YER177W, YFL014W, YFL038C,
YFL039C, YFL045C, YFR031C-A, YFR032C-A, YFR053C, YGL008C,
YGL030W, YGL031C, YGL037C, YGL055W, YGL076C,
YGL103W, YGL123W, YGL148W, YGL189C, YGL200C, YGR037C,
YGR060W, YGR085C, YGR118W, YGR148C, YGR180C, YGR183C,
YGR192C, YGR204W, YGR214W, YGR254W, YGR279C, YGR282C,
YHL015W, YHL033C, YHR007C, YHR018C, YHR021C, YHR053C,
YHR143W, YHR162W, YHR174W, YHR183W, YHR193C, YIL043C,
YIL052C, YIL133C, YIL177C, YJL034W, YJL052W, YJL079C,
YJL130C, YJL136C, YJL138C, YJL151C, YJL177W, YJL189W,
YJL190C, YJR009C, YJR016C, YJR025C, YJR077C, YJR085C,
YJR094W-A, YJR104C, YJR105W, YJR123W, YJR139C, YJR145C,
YKL001C, YKL006W, YKL056C, YKL060C, YKL085W,
YKL141W, YKL152C, YKL156W, YKL164C, YKL180W,
YKL181W, YKR042W, YKR057W, YLL024C, YLL041C, YLL045C,
YLL050C, YLL066C, YLR038C, YLR043C, YLR044C,
YLR056W, YLR060W, YLR061W, YLR075W, YLR109W, YLR110C,
YLR150W, YLR155C, YLR167W, YLR185W, YLR249W, YLR259C,
YLR264W, YLR286C, YLR287C-A, YLR303W, YLR304C, YLR325C,
YLR340W, YLR342W, YLR344W, YLR355C, YLR388W, YLR395C,
YLR406C, YLR441C, YLR448W, YML008C, YML012W,
YML024W, YML026C, YML028W, YML063W, YML073C,
YML081C-A, YMR116C, YMR122W-A, YMR142C, YMR186W,
YMR194W, YMR202W, YMR205C, YMR226C, YMR242C,
YMR251W-A, YMR256C, YMR295C, YMR307W, YNL031C,
YNL055C, YNL064C, YNL069C, YNL071W, YNL104C, YNL135C,
YNL145W, YNL162W, YNL178W, YNL208W, YNL209W,
YNL220W, YNL301C, YNL302C, YNL305C, YNL336W, YNR001C,
YNR016C, YOL038W, YOL039W, YOL040C, YOL058W, YOL086C,
YOL109W, YOL120C, YOL127W, YOR020C, YOR045W,
YOR063W, YOR096W, YOR122C, YOR133W, YOR136W, YOR182C,
YOR230W, YOR234C, YOR247W, YOR270C, YOR285W,
YOR293W, YOR303W, YOR332W, YOR369C, YOR375C, YPL028W,
YPL037C, YPL079W, YPL090C, YPL131W, YPL143W, YPL154C,
YPL220W, YPR035W, YPR043W, YPR080W, YPR102C,
YPR103W, YPR132W, YPR149W, YPR165W, YPR204W,
in Saccharomyces cerevisiae correspondingly
SEQ ID NO. 1529 to SEQ ID NO. 1802:
Low expression genes with Locus Tag of
YAL037C-A, YAL047C, YAL048C, YAL064C-A, YAL064W, YAL065C,
YAL067C, YAR031W, YBL013W, YBL026W, YBL044W,
YBL059W, YBL063W, YBL097W, YBR013C, YBR020W,
YBR076W, YBR093C, YBR098W, YBR114W, YBR132C, YBR138C,
YBR148W, YBR152W, YBR180W, YBR184W, YBR186W,
YBR203W, YCL001W-A, YCL048W, YCL064C, YCL066W,
YCR020W-B, YCR045C, YCR050C, YCR091W, YCR092C, YCR095C,
YCR097W, YCR101C, YCR106W, YDL037C, YDL105W,
YDL186W, YDR020C, YDR034C, YDR038C, YDR039C, YDR042C,
YDR106W, YDR114C, YDR125C, YDR131C, YDR217C, YDR218C,
YDR240C, YDR259C, YDR285W, YDR295C, YDR314C,
YDR371W, YDR374C, YDR386W, YDR421W, YDR446W, YDR470C,
YDR501W, YDR522C, YDR523C, YDR532C, YEL019C,
YEL033W, YEL061C, YER038C, YER044C-A, YER078C, YER085C,
YER111C, YFL003C, YFL011W, YFL012W, YFL024C, YFL040W,
YFL056C, YFL067W, YFR012W, YFR035C, YFR057W,
YGL006W-A, YGL015C, YGL033W, YGL089C, YGL090W, YGL138C,
YGL158W, YGL168W, YGL170C, YGL175C, YGL183C,
YGL192W, YGL194C, YGL230C, YGL232W, YGL235W,
YGL249W, YGL251C, YGL258W, YGR006W, YGR016W,
YGR059W, YGR081C, YGR089W, YGR109C, YGR126W,
YGR153W, YGR212W, YGR218W, YGR225W, YGR273C, YHL009C,
YHL010C, YHL012W, YHL022C, YHL044W, YHL047C,
YHL048W, YHR014W, YHR021W-A, YHR022C, YHR044C,
YHR073W, YHR079C-A, YHR118C, YHR123W, YHR153C, YHR160C,
YHR185C, YIL029C, YIL060W, YIL072W, YIL073C, YIL084C,
YIL095W, YIL102C, YIL139C, YIL144W, YIL150C, YIL159W,
YJL038C, YJL058C, YJL106W, YJL107C, YJL127C, YJL165C,
YJL216C, YJR043C, YJR053W, YJR079W, YJR108W, YJR153W,
YKL070W, YKR015C, YKR041W, YKR103W, YKR105C,
YKR106W, YLL010C, YLL013C, YLL063C, YLR012C,
YLR013W, YLR039C, YLR047C, YLR148W, YLR287C,
YLR318W, YLR329W, YLR341W, YLR385C, YLR393W, YLR415C,
YLR445W, YML003W, YML047C, YML066C, YMR018W,
YMR052W, YMR066W, YMR070W, YMR084W, YMR094W,
YMR101C, YMR117C, YMR133W, YMR137C, YMR159C,
YMR192W, YMR230W, YMR251W, YMR268C, YMR299C,
YMR317W, YNL020C, YNL033W, YNL093W, YNL126W, YNL196C,
YNL204C, YNL210W, YNL234W, YNL249C, YNL260C, YNL318C,
YNR004W, YNR019W, YNR047W, YNR062C, YNR063W, YNR064C,
YNR066C, YNR069C, YNR070W, YNR071C, YNR074C,
YOL013W-A, YOL017W, YOL024W, YOL047C, YOL057W,
YOL069W, YOL104C, YOL131W, YOL141W, YOL165C,
YOR008C-A, YOR022C, YOR030W, YOR049C, YOR180C,
YOR183W, YOR195W, YOR214C, YOR255W, YOR295W,
YOR298W, YOR339C, YOR349W, YOR351C, YOR365C,
YOR378W, YOR384W, YOR387C, YOR394W, YPL018W, YPL021W,
YPL033C, YPL068C, YPL121C, YPL130W, YPL165C, YPL166W,
YPL200W, YPL216W, YPL253C, YPL277C, YPR027C, YPR045C,
YPR054W, YPR089W, YPR116W, YPR156C,
YPR186C, YPR200C, YPR201W,
in Saccharomyces cerevisiae correspondingly

SEQ ID NO. 1803 to SEQ ID NO. 1982: optimized genes corresponding to the native genes in SEQ ID NO. 1 to SEQ ID NO. 180, the corresponding native gene is selected from the entire set of high-expression genes in Escherichia coli (i.e. SEQ ID NO. 1 to SEQ ID NO. 180) for optimization using “codon context optimization (CCO)” approach in this invention while the rest of the genes are used as the training set.
SEQ ID NO. 1983 to SEQ ID NO. 2162: optimized genes corresponding to the native genes in SEQ ID NO. 1 to SEQ ID NO. 180, the corresponding native gene is selected from the entire set of high-expression genes in Escherichia coli (i.e. SEQ ID NO. 1 to SEQ ID NO. 180) for optimization using “individual codon usage optimization (ICO)” approach in this invention while the rest of the genes are used as the training set.
SEQ ID NO. 2163 to SEQ ID NO. 2342: optimized genes corresponding to the native genes in SEQ ID NO. 1 to SEQ ID NO. 180, the corresponding native gene is selected from the entire set of high-expression genes in Escherichia coli (i.e. SEQ ID NO. 1 to SEQ ID NO. 180) for optimization using “multi-objective codon optimization (MOCO)” approach in this invention while the rest of the genes are used as the training set.
SEQ ID NO. 2343 to SEQ ID NO. 2522: optimized genes corresponding to the native genes in SEQ ID NO. 1 to SEQ ID NO. 180, the corresponding native gene is selected from the entire set of high-expression genes in Escherichia coli (i.e. SEQ ID NO. 1 to SEQ ID NO. 180) for optimization using “random codon assignment (RCA)” approach.
SEQ ID NO. 2523 to SEQ ID NO. 2717: optimized genes corresponding to the native genes in SEQ ID NO. 350 to SEQ ID NO. 544, the corresponding native gene is selected from the entire set of high-expression genes in Lactococcus lactis (i.e. SEQ ID NO. 350 to SEQ ID NO. 544) for optimization using “codon context optimization (CCO)” approach in this invention while the rest of the genes are used as the training set.
SEQ ID NO. 2718 to SEQ ID NO. 2912: optimized genes corresponding to the native genes in SEQ ID NO. 350 to SEQ ID NO. 544, the corresponding native gene is selected from the entire set of high-expression genes in Lactococcus lactis (i.e. SEQ ID NO. 350 to SEQ ID NO. 544) for optimization using “individual codon usage optimization (ICO)” approach in this invention while the rest of the genes are used as the training set.
SEQ ID NO. 2913 to SEQ ID NO. 3107: optimized genes corresponding to the native genes in SEQ ID NO. 350 to SEQ ID NO. 544, the corresponding native gene is selected from the entire set of high-expression genes in Lactococcus lactis (i.e. SEQ ID NO. 350 to SEQ ID NO. 544) for optimization using “multi-objective codon optimization (MOCO)” approach in this invention while the rest of the genes are used as the training set.
SEQ ID NO. 3108 to SEQ ID NO. 3302: optimized genes corresponding to the native genes in SEQ ID NO. 350 to SEQ ID NO. 544, the corresponding native gene is selected from the entire set of high-expression genes in Lactococcus lactis (i.e. SEQ ID NO. 350 to SEQ ID NO. 544) for optimization using “random codon assignment (RCA)” approach.
SEQ ID NO. 3303 to SEQ ID NO. 3553: optimized genes corresponding to the native genes in SEQ ID NO. 752 to SEQ ID NO. 1002, the corresponding native gene is selected from the entire set of high-expression genes in Pichia pastoris (i.e. SEQ ID NO. 752 to SEQ ID NO. 1002) for optimization using “codon context optimization (CCO)” approach in this invention while the rest of the genes are used as the training set.
SEQ ID NO. 3554 to SEQ ID NO. 3804: optimized genes corresponding to the native genes in SEQ ID NO. 752 to SEQ ID NO. 1002, the corresponding native gene is selected from the entire set of high-expression genes in Pichia pastoris (i.e. SEQ ID NO. 752 to SEQ ID NO. 1002) for optimization using “individual codon usage optimization (ICO)” approach in this invention while the rest of the genes are used as the training set.
SEQ ID NO. 3805 to SEQ ID NO. 4055: optimized genes corresponding to the native genes in SEQ ID NO. 752 to SEQ ID NO. 1002, the corresponding native gene is selected from the entire set of high-expression genes in Pichia pastoris (i.e. SEQ ID NO. 752 to SEQ ID NO. 1002) for optimization using “multi-objective codon optimization (MOCO)” approach in this invention while the rest of the genes are used as the training set.
SEQ ID NO. 4056 to SEQ ID NO. 4306: optimized genes corresponding to the native genes in SEQ ID NO. 752 to SEQ ID NO. 1002, the corresponding native gene is selected from the entire set of high-expression genes in Pichia pastoris (i.e. SEQ ID NO. 752 to SEQ ID NO. 1002) for optimization using “random codon assignment (RCA)” approach.
SEQ ID NO. 4307 to SEQ ID NO. 4581: optimized genes corresponding to the native genes in SEQ ID NO. 1254 to SEQ ID NO. 1528, the corresponding native gene is selected from the entire set of high-expression genes in Saccharomyces cerevisiae (i.e. SEQ ID NO. 1254 to SEQ ID NO. 1528) for optimization using “codon context optimization (CCO)” approach in this invention while the rest of the genes are used as the training set.
SEQ ID NO. 4582 to SEQ ID NO. 4856: optimized genes corresponding to the native genes in SEQ ID NO. 1254 to SEQ ID NO. 1528, the corresponding native gene is selected from the entire set of high-expression genes in Saccharomyces cerevisiae (i.e. SEQ ID NO. 1254 to SEQ ID NO. 1528) for optimization using “individual codon usage optimization (ICO)” approach in this invention while the rest of the genes are used as the training set.
SEQ ID NO. 4857 to SEQ ID NO. 5131: optimized genes corresponding to the native genes in SEQ ID NO. 1254 to SEQ ID NO. 1528, the corresponding native gene is selected from the entire set of high-expression genes in Saccharomyces cerevisiae (i.e. SEQ ID NO. 1254 to SEQ ID NO. 1528) for optimization using “multi-objective codon optimization (MOCO)” approach in this invention while the rest of the genes are used as the training set.
SEQ ID NO. 5132 to SEQ ID NO. 5406: optimized genes corresponding to the native genes in SEQ ID NO. 1254 to SEQ ID NO. 1528, the corresponding native gene is selected from the entire set of high-expression genes in Saccharomyces cerevisiae (i.e. SEQ ID NO. 1254 to SEQ ID NO. 1528) for optimization using “random codon assignment (RCA)” approach.
SEQ ID NO. 5407: native IFN-γ genes.
SEQ ID NO. 5408: codon context optimized (CCO) coding sequences using the protein sequence of human IFN-γ as the input for the codon optimization algorithms with respect to the highly-expressed genes of Chinese hamster ovary (CHO) cells.
SEQ ID NO. 5409: codon context optimized (CCO) coding sequences using the protein sequence of human IFN-γ as the input for the codon optimization algorithms with respect to the lowly-expressed genes of Chinese hamster ovary (CHO) cells.
SEQ ID NO. 5410: codon context optimized (CCO) coding sequences using the protein sequence of human IFN-γ as the input for the codon optimization algorithms with respect to the moderately-expressed genes of Chinese hamster ovary (CHO) cells.
SEQ ID NO. 5411: Individual codon usage optimized (ICO) coding sequences using the protein sequence of human IFN-γ as the input for the codon optimization algorithms with respect to the highly-expressed genes of Chinese hamster ovary (CHO) cells.
SEQ ID NO. 5412: Individual codon usage optimized (ICO) coding sequences using the protein sequence of human IFN-γ as the input for the codon optimization algorithms with respect to the lowly-expressed genes of Chinese hamster ovary (CHO) cells.
SEQ ID NO. 5413: Individual codon usage optimized (ICO) coding sequences using the protein sequence of human IFN-γ as the input for the codon optimization algorithms with respect to the moderately-expressed genes of Chinese hamster ovary (CHO) cells.
SEQ ID NO. 5414 to SEQ ID NO. 5417: coding sequences with different minor mutation to SEQ ID NO. 5411.

TABLE 5
Tournament matrix

| | ICO | CCO | MOCO |
|---|---|---|---|
| ICO | | 3 | 2 |
| CCO | 23 | | 19 |
| MOCO | 25 | 7 | |

Each cell indicates the number of wins by the method in the leftmost column over a total of 27 tournaments. Whenever the numbers of wins and losses (i.e. cells diagonally opposite of each other) do not sum up to 27, the shortfall will be equal to the number of draws.

### Example 3

### Enhanced Expression of Codon Optimized Interferon Gamma in CHO Cells

The human interferon-gamma (IFN-γ) is a potential drug candidate for treating various diseases due to its immunomodulatory properties. The efficient production of this protein can be achieved through a popular industrial host, Chinese hamster ovary (CHO) cells. However, recombinant expression of foreign proteins is typically suboptimal possibly due to the usage of non-native codon patterns within the coding sequence. Therefore, the application of the developed codon optimization approach in the present disclosure to design synthetic IFN-γ coding sequences for enhanced heterologous expression in CHO cells is demonstrated in the present example. For codon optimization, earlier studies suggested to establish the target usage distribution pattern in terms of selected design parameters such as individual codon usage (ICU) and codon context (CC), mainly based on the host's highly expressed genes. However, the RNA-Seq based transcriptome profiling indicated that the ICU and CC distribution patterns of different gene expression classes in CHO cell are relatively similar, unlike other microbial expression hosts, E. coli and S. cerevisiae. This finding was further corroborated through the in vivo expression of various ICU and CC optimized IFN-γ in CHO cells. Interestingly, the CC-optimized genes exhibited at least 13-fold increase in expression level compared to the wild-type IFN-γ while a maximum of 10-fold increase was observed for the ICU-optimized genes. Although design criteria based on individual codons, such as ICU, have been widely used for gene optimization, the results in the present example suggested that codon context is relatively more effective parameter for improving recombinant IFN-γ expression in CHO cells.

Interferon-gamma (IFN-γ) is a cytokine with diverse roles in the regulation of innate and adaptive immunity. It has been explored as an immunomodulatory drug for the clinical application due to its pleiotropic effects on the immune system. In addition, IFN-γ has been studied as a potential drug candidate for treating many diseases such as cancer, hepatitis and tuberculosis. Notably, a bioengineered form of IFN-γ, known as IFN-γ-1b or Actimmune, has been licensed by Intermune and approved by FDA for the treatment of chronic granulomatous disease and severe malignant osteopetrosis. Although Actimmune has been commercially produced in the unglycosylated form using the Escherichia coli expression host, the glycosylation of IFN-γ was experimentally shown to exhibit higher protease resistance allowing the protein to remain in the bloodstream for a longer period of time. Indeed, the production of IFN-γ using a mammalian expression host can potentially improve the drug's therapeutic efficacy through human-like glycosylation of the protein. Thus, developing technologies for efficient recombinant production of glycoproteins in mammalian cell lines, especially the industrially relevant Chinese hamster ovary (CHO) cells, is an important area of biotechnology research.

However, the bottleneck at protein translation has been recognized as an important issue in the design of heterologous gene for recombinant expression. The poor translation of heterologous protein may be due to the difference in codon usage bias between the expression host and recombinant gene. As a result of random mutation and selection pressure, different organisms may have evolved to utilize the synonymous codons with disparate frequencies. Accordingly, when attempting to express a foreign gene (e.g. human IFN-γ) in a particular host organism (e.g. CHO cell), the differences in codon bias can hinder the protein translation process in a manner whereby the host is unable to efficiently translate the rare codons that may occur frequently in the recombinant gene. As such, coding sequence re-design via codon optimization has been practically employed to adapt the foreign gene for efficient heterologous expression. Previous studies have demonstrated that the correlation between expression level and codon usage patterns implicates the existence of an optimal codon bias for achieving high protein expression. The coding sequences of highly expressed genes, which were reported to exhibit a distinct codon usage bias or distribution pattern compared to the other genes, are selectively used to calculate this “preferred” codon usage as a reference for codon optimization in microbial cells. In this respect, it is relevant to examine if such distinct codon biases are also observed among high-, moderate- and low-expression genes in CHO cells. To do so, the RNA-Seq based transcriptome data of CHO cells has been profiled to examine the relationship between codon distribution patterns and gene expressivity.

It is recognized that recombinant protein expression can be collectively affected by several factors such as transcriptional regulation, mRNA stability and translation initiation. In the present example, it is assumed that the only determinant of natural protein expression levels is translational elongation as determined by codon choice. Although the codon adaptation index (CAI) has been considered to characterize codon usage bias, optimizing CAI to obtain a “one amino acid-one codon” design may not improve heterologous expression. This is presumably due to the rapid depletion of certain tRNA species, potentially leading to tRNA pool imbalance and increased translational error. To avoid these problems, a computational algorithm is used to perform codon optimization of IFN-γ genes on the basis of two design parameters, individual codon usage (ICU) and codon pair usage, also known as codon context (CC). In synthetic gene design, there is a trade-off between ICU and CC fitness as shown in the present disclosure. Therefore, the relative importance of ICU and CC fitness of IFN-γ synthetic genes for expression in CHO cells is examined.

3.1 Material and methods

### 3.1.1 Calculation of Codon Distributions

The ICU distribution refers to a vector of occurrence frequency values for all the 64 codons. Each codon frequency can be calculated using the following expression:

$${p}^{k} = \frac{{θ}_{C}^{k}}{{θ}_{A}^{j ( k )}} ∀ k ∈ \{ 1 , 2 , … , 64 \}$$

where p^{k} is the frequency of codon k calculated as the total number of occurrences of codon k, θ_{C}^{k}, divided by the total number occurrences of amino acid j that is encoded by codon k, denoted as θ_{A}^{j(k)}. Since amino acid j can be encoded by two or more codons, the range of codon frequency is 0≦p^{k}≦1. Similarly, the codon pair frequency for the 3,904 possible combinations of codon pairs can be computed as follows:

$${q}^{k} = \frac{{θ}_{CC}^{k}}{{θ}_{AA}^{j ( k )}} ∀ k ∈ \{ 1 , 2 , … , 3904 \}$$

For codon pair frequency, k and j(k) denote codon pair and the corresponding amino acid, respectively. The resulting vectors p=(p¹, p¹, . . . , p⁶⁴)^{T} and q=(q¹, q², . . . , q³⁹⁰⁴)^{T} indicate the ICU and CC distributions respectively. Apart from CHO, the vectors p and q are also calculated for other species including E. coli and S. cerevisiae to examine the differences in codon usage bias for various organisms. Principal component analysis (PCA) are performed on the p and q vectors to illustrate the differences in ICU and CC distributions for all the genes in the phylogenetically distinct expression hosts.

### 3.1.2 Coding Sequence Design by Codon Optimization

The codon optimized sequences can be designed by maximizing the ICU and CC fitness values, which are evaluated as follows:

$$ICU fitness \text{:} {Ψ}_{ICU} = - \frac{{\sum }_{{k}_{1} = 1}^{64} \vert {p}_{0}^{{k}_{1}} - {p}_{1}^{{k}_{1}} \vert}{64}$$

$$CC fitness \text{:} {Ψ}_{CC} = - \frac{{\sum }_{{k}_{2} = 1}^{3904} \vert {q}_{0}^{{k}_{2}} - {q}_{1}^{{k}_{2}} \vert}{3904}$$

In the above expressions, fitness values are formulated as the negative of the Manhattan distance of the ICU and CC distributions between the host (subscript 0) and the recombinant gene (subscript 1) normalized with the total number of codon and codon pair combinations. By computationally maximizing the above objective functions, coding sequences that are ICU- and CC-optimized can be generated. Due to the discrete and nonlinear nature of the CC optimization problem, complex nonlinear optimization algorithms are required to obtain a solution. In order to get a reasonably good solution for CC optimization within a moderate amount of computational time, the naturally inspired metaheuristic method of genetic algorithm has been used. On the other hand, the ICU optimization problem can be solved by assigning relevant codons to the coding sequence according to the optimal ICU distribution. The computational implementation of ICU and CC optimization has been shown in the present disclosure.

### 3.1.3 Characterization of CHO Gene Expression Using RNA-Seq

Suspension-adapted CHO K1 cells were grown in protein-free media comprising of 50% HyQ PF-CHO (HyClone) and 50% CD CHO (Life Technologies, Carlsbad, Calif.), supplemented with 1 g/L sodium bicarbonate, 6 mM L-glutamine and 0.05% Pluronic F-68 (Invitrogen). The cells were grown at 37° C. in 8% CO₂, subcultured every 3-4 days and harvested during the exponential phase. Total RNA was isolated using Trizol reagent (Invitrogen) and quantified using Nanodrop ND-2000 (Thermo Scientific). RNA quality was assessed using the Agilent 2100 Bioanalyzer. RNA-Seq sequencing was performed using pair-end Illumina sequencing. More than 9 Gbp of sequences was generated for this sample. A custom software pipeline was used to remove low quality reads before gene expression analysis was performed. Annotations of genes for the reference CHO-K1 genome were obtained from http://www.ncbi.nlm.nih.gov/Taxonomy/Browser/wwwtax.cgi?id=10029. Only those genes that were present in the reference annotation were considered for gene expression analysis. The Cufflinks software package was used to calculate absolute gene expression for genes expressed in the CHO-K1 sample.

### 3.1.4 Plasmid Construction

Genes encoding the wild type (WT) and codon optimized IFN-γ were synthesized by GenScript (Piscataway, N.J.). They were inserted into the pcDNA3.1 (+) vector (Life Technologies) using NotI and XhoI sites. Restriction enzymes for NotI and XhoI were purchased from New England Biolabs (Ipswitch, Mass., USA).

### 3.1.5 Transient Expression of IFN-γ in CHO Cells

The expression level of WT and codon optimized IFN-γ sequences were compared in transient transfections in adherent CHO K1 cells (ATCC, VA). CHO K1 cells were routinely maintained in the Dulbecco's modified Eagle's medium (DMEM)+GlutaMax™ (Life Technologies) supplemented with 10% fetal bovine serum (Sigma, St. Louis, Mo.). Transient transfections were carried out using Fugene 6 transfection reagent (Roche, Ind.) in 6-well tissue culture plates (NUNC™, Nalge Nunc International, Roskilde, Denmark). One day prior to transfection, 2 mL of exponentially growing cells at a cell density of 3×105 cells/mL were seeded into each well of the 6-well plates. Each culture was co-transfected with 2.0 μg of the appropriate IFN-γ vector and 0.2 μg of a pMax-GFP vector (Lonza) by using 6 μL of Fugene 6. Co-transfection of the pMax-GFP vector expressing green fluorescence protein (GFP) was to normalize the transfection efficiency. Transfection of each plasmid was done in duplicates and repeated once by using independently prepared plasmids and cultures. At 48 hour post-transfection, supernatant from 6-well plate cultures was collected and analyzed for IFN-γ concentration using an Enzyme-linked immunosorbent assay (ELISA) kit (Hycult Biotechnology, Uden, Netherlands). In parallel, the cell pellet was also collected for analysis of GFP expression using a FACS Calibur (Becton Dickinson, Mass.). The expression levels of optimized IFN-γ were presented as the IFN-γ concentration normalized with respect to the GFP expression and relative to the control, WT IFN-γ.

### 3.2 Results & Discussion

### 3.2.1 RNA-Seq-Based Gene Expression Profiling in CHO Cells

Prior to implementing the codon optimization, the desirable reference codon usage patterns for CHO cells needs to established first. In earlier studies, highly expressed genes were typically used to calculate the reference codon patterns as they have been reported to exhibit a distinct codon usage bias compared to the other genes. Furthermore, the correlation between expression level and the use of selective codons implicates the existence of an optimal codon usage for achieving high protein expression, which is based on the codon patterns of the host's highly expressed genes. In this aspect, the analysis of genomic and transcriptomic data can help to elucidate the codon patterns of highly expressed genes. Moreover, to directly assess translational efficiency, translatome and proteome profiling will also be relevant to measure the degree of ribosome association to mRNA and the concentration of proteins. Interestingly, earlier CHO codon optimization studies only considered the codon usage of highly expressed genes from human and yeast as the reference for codon optimization of recombinant genes in CHO cells. Although not explicitly clarified, the reason for not using the more relevant highly expressed CHO genes is most likely due to the unavailability of CHO genomic and transcriptomic data at that time.

Incidentally, the CHO genome sequence was recently published. Following the genome sequencing, the transcriptome of CHO can now be characterized through either microarray or RNA-Seq experiments. Therefore, in the present example, the CHO genomic and transcriptomic data is used as the basis for calculating the reference codon patterns for codon optimization. For transcriptome analysis, the expression levels of CHO genes using RNA-Seq has been profiled rather than microarray experiments because the former has been reported to provide better estimates of absolute transcript levels than the latter method. The sequencing was performed on a parental untransfected CHO-K1 cell line and a list of gene expression values was obtained using the Cufflinks software. Out of the approximately 25,000 genes present in the CHO-K1 annotation the inventors were able to detect expression of 10,067 genes. Based on the RNA-Seq reads, the CHO genes can be sorted in a descending order such that the gene with highest transcript abundance are placed at the top and the lowest at the bottom. Classifying the sorted list of CHO genes into highly-expressed (H), moderately-expressed (M) and lowly-expressed (L) genes is followed by establishing the reference codon distribution patterns for subsequent codon optimization. In the present example, the H and L genes constitute the top 10% and bottom 10% of the sorted list respectively while the rest of the genes is considered M genes.

### 3.2.2 Comparison of Codon Distributions

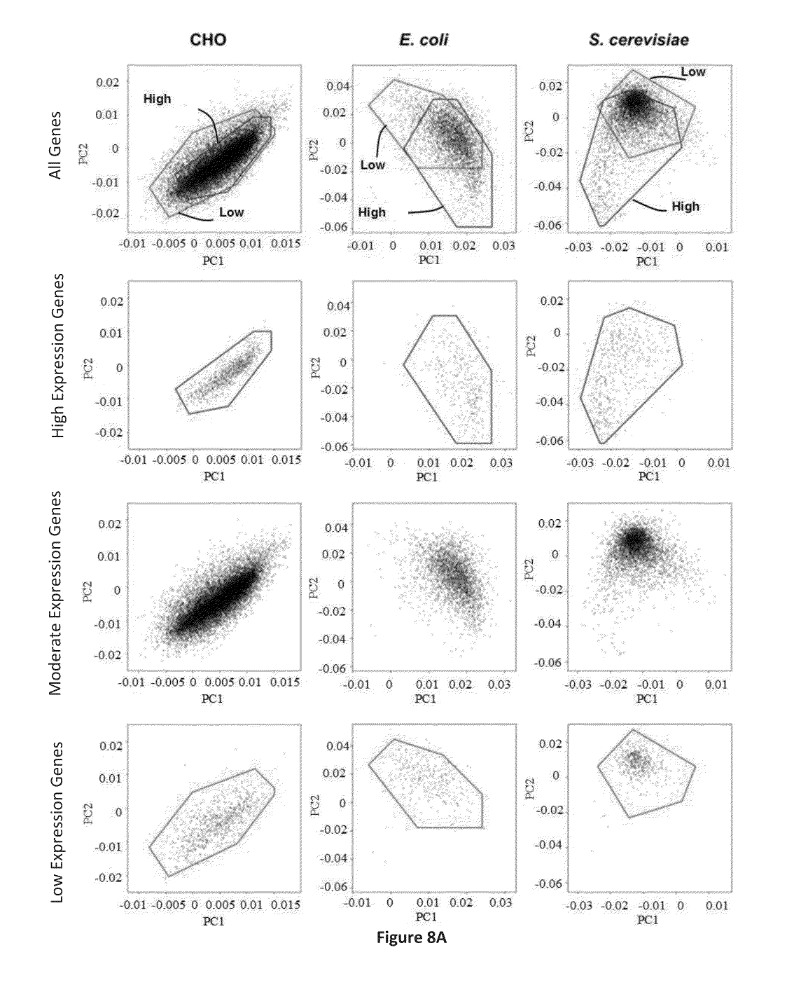

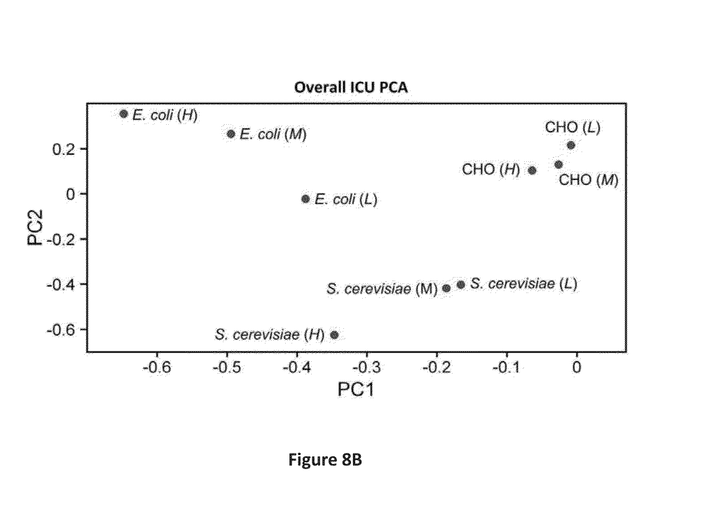

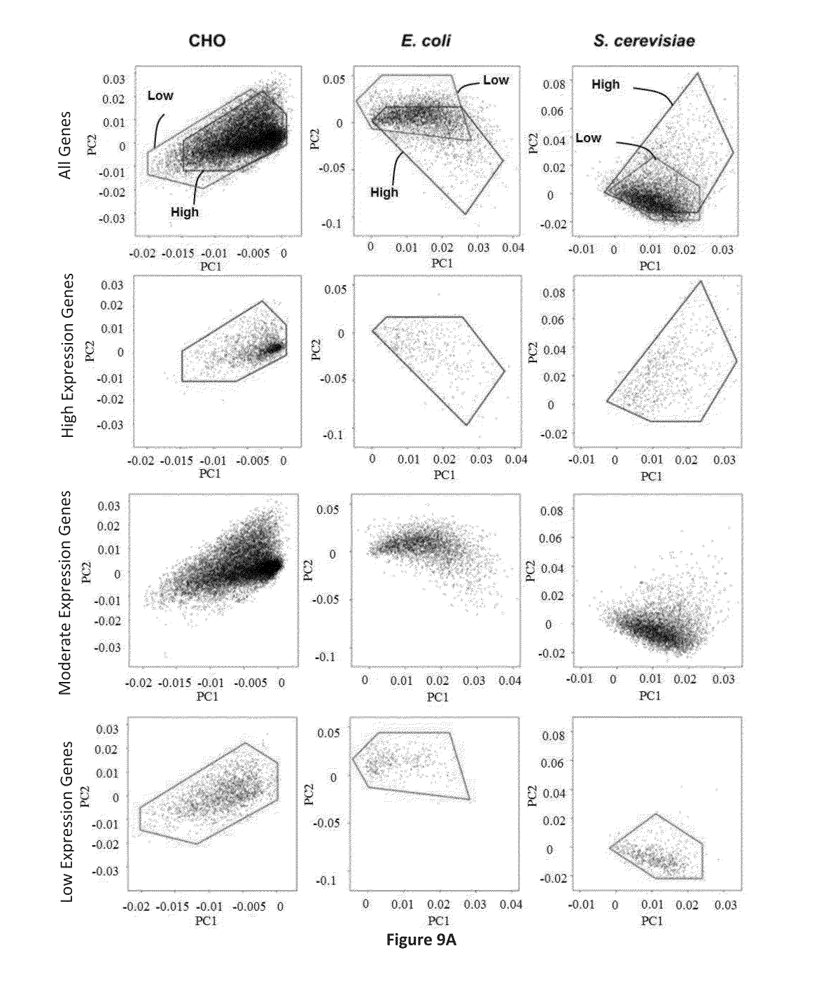

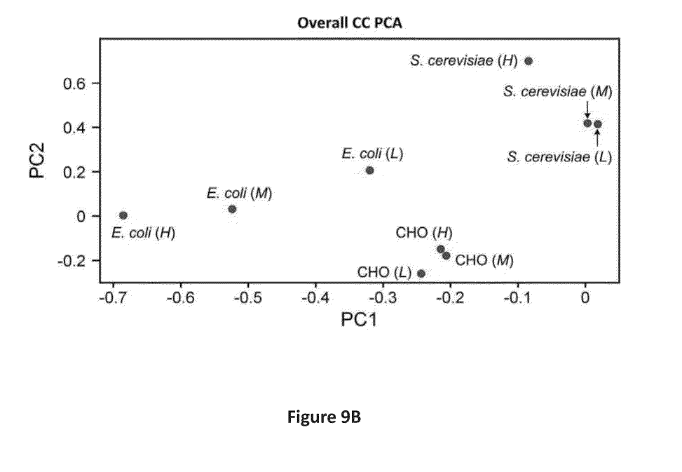

Many of the earlier studies selected the codon patterns of high-expression genes, instead of all the host's native genes, as the reference for codon optimization: the codon usage bias of high-expression genes has been shown to be different from low-expression genes in various organisms. Nonetheless, this step of selecting high-expression genes to identify preferred codon patterns may not be necessary if the codon usage bias is similar for all genes. In order to explore this hypothesis in CHO cells, the codon patterns of H, M and L genes were quantified and compared using the ICU and CC distribution calculations. Since ICU and CC distributions are vectors with high dimensions of 64 and 3904, the principal component analysis (PCA) method was used to visualize their differences. Since PCA is a statistical method that can capture the largest possible variance among the multidimensional variables and map them into a lower dimensional space for easy visualization, the variation in ICU and CC distributions of the different expression genes can be illustrated on a two-dimensional plot. In the present example, the ICU and CC distributions of H, M and L genes in CHO cells were compared with those in well-studied microbial expression hosts, E. coli and S. cerevisiae to evaluate the differences in codon usage bias among different genes (FIGS. 8 and 9). The PCA plots show that the degree of overlap between H and L genes was the greatest for CHO, followed by S. cerevisiae and E. coli, indicating that the differences in codon usage bias between H and L genes were more significant in the S. cerevisiae and E. coli. The average ICU and CC distributions of the H, M and L genes for all the expression hosts were also calculated and analyzed. The resultant PCA plot clearly illustrated the differences in codon usage patterns among the different classes of genes for three expression hosts (FIGS. 8 and 9). Interestingly, the H, M and L genes of CHO were found to exhibit rather similar ICU and CC profiles, indicated by their close proximities on the plot, in contrast to the genes from E. coli and S. cerevisiae. This suggests that using the ICU and CC distributions of either H, M or L genes as the reference for codon optimization in CHO cells will most likely give rise to genes with similar in vivo expression capabilities. To ascertain the validity of this hypothesis, ICU and CC optimization was applied using these different codon distributions as references to design the human IFN-γ synthetic genes for heterologous expression in CHO.

### 3.2.3 Expression of Codon Optimized IFN-γ

The expression of CC optimized interferon genes in Chinese hamster ovary (CHO) cells, indicating that sequences designed by CCO are likely to be exhibit high protein expression levels.

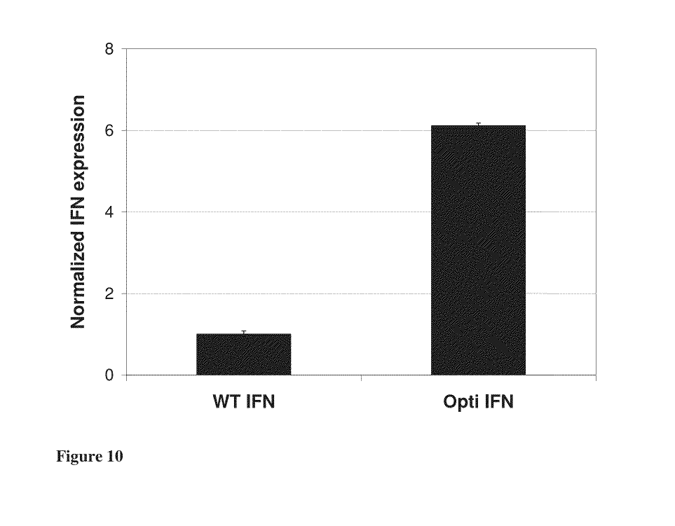

The wild-type interferon (WT IFN) and CC optimized Interferon γ (Opti IFN) were compared for expression level in transient transfections in CHO K1 cells (ATCC, VA). CHO K1 cells were routinely maintained in the Dulbecco's modified Eagle's medium (DMEM)+GlutaMax™ (Invitrogen, Carlsbad, Calif.) supplemented with 10% fetal bovine serum (Sigma, St. Louis, Mo.). The WT IFN and Opti IFN cDNAs were inserted into pcDNA3.1(+) vector (Invitrogen, Carlsbad, Calif.) using NotI and XhoI sites. The Opti IFN cDNA was synthesized by GeneScript (Vendor). Transient transfections were carried out using Fugene 6 transfection reagent (Roche, Ind.) in 6-well tissue culture plates (NUNC™, Nalge Nunc International, Roskilde, Denmark). One day prior to transfection, 2 mL of exponentially growing cells at a cell density of 3×10⁵ cells/mL were seeded into each well of the 6-well plates. Each culture was co-transfected with 2.0 μg of the appropriate IFN vector and 0.2 μg of a pMax-GFP vector (Lonza) by using 6 μL of Fugene 6. Co-transfection of the pMax-GFP vector expressing green fluorescence protein (GFP) was to normalize the transfection efficiency. Transfection of each plasmid was done in duplicates and repeated once by using independently prepared plasmids and cultures. At 48 hour post-transfection, supernatant from 6-well plate cultures was collected and analyzed for IFN concentration using an ELISA kit (Hycult Biotechnology, Uden, Netherlands). In parallel, the cell pellet was also collected for analysis of GFP expression using FACS. The expression level of Opti IFN and WT IFN, presented as the IFN concentration normalized to the GFP expression (FIG. 10), clearly shows about six-fold improvement in heterologous expression as a consequence of CC optimization.

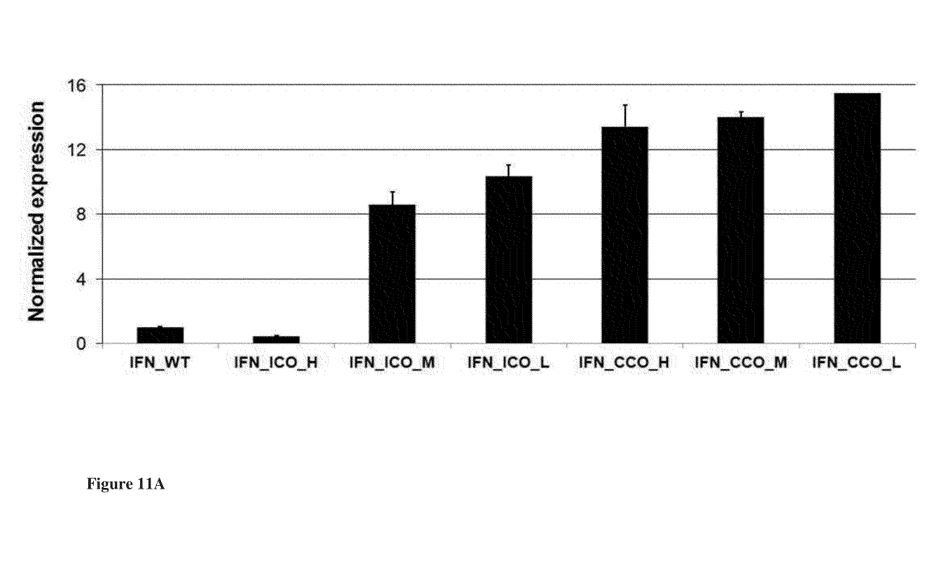

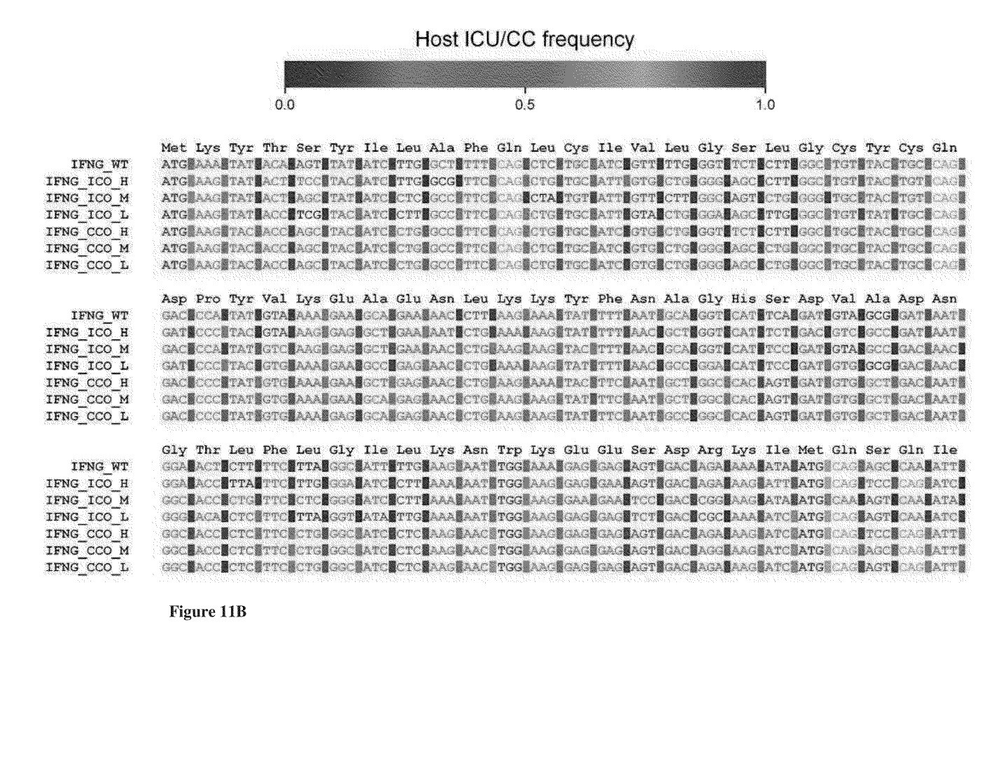

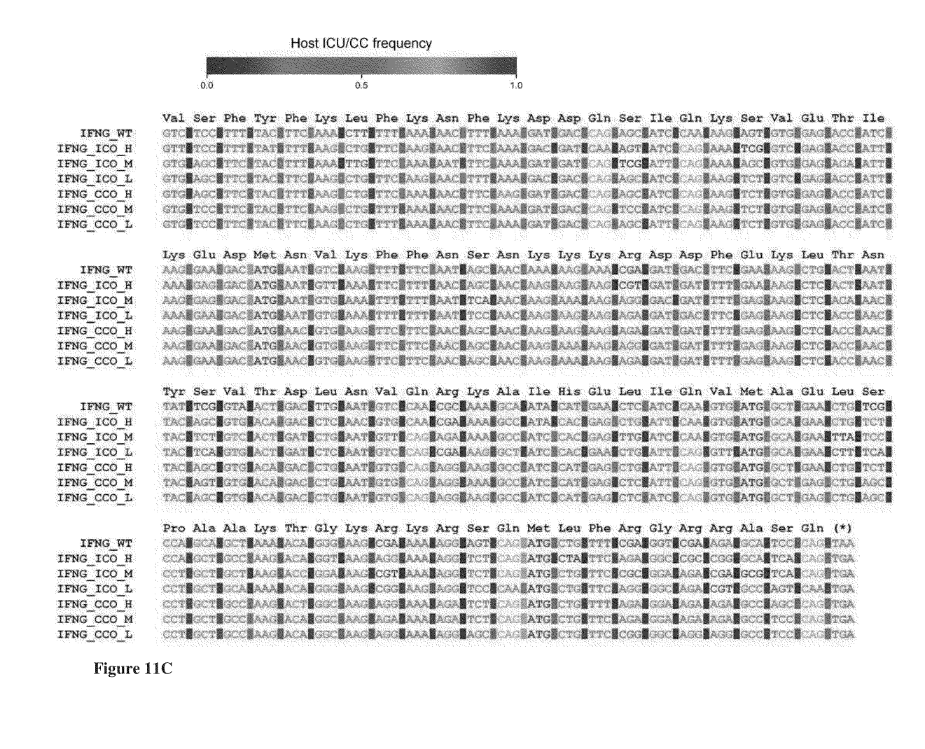

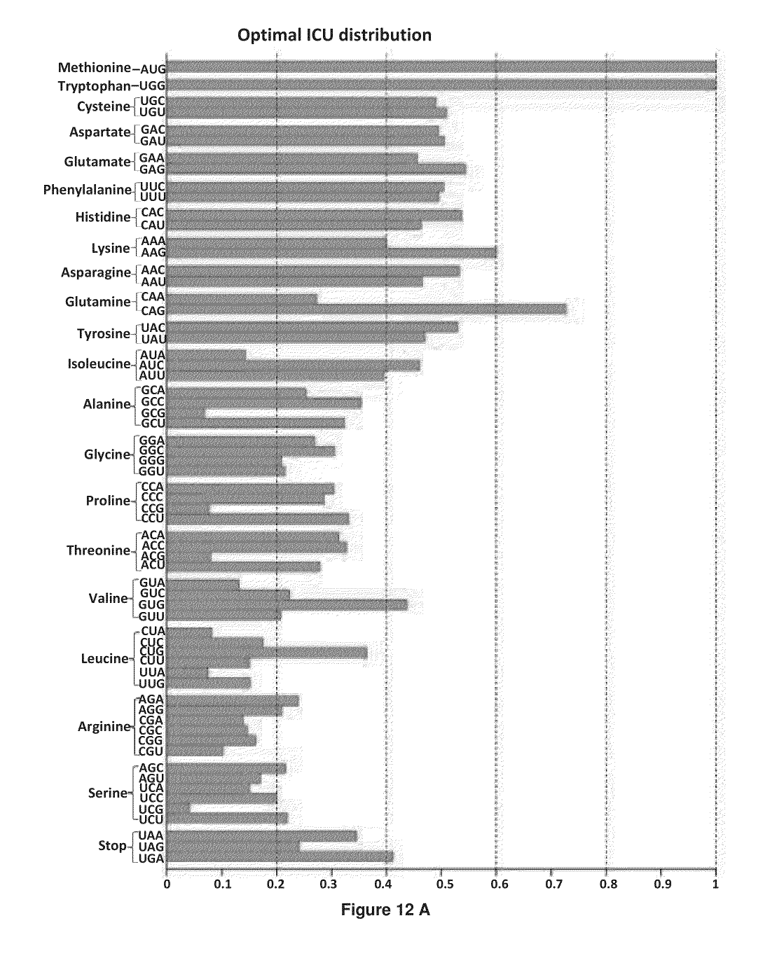

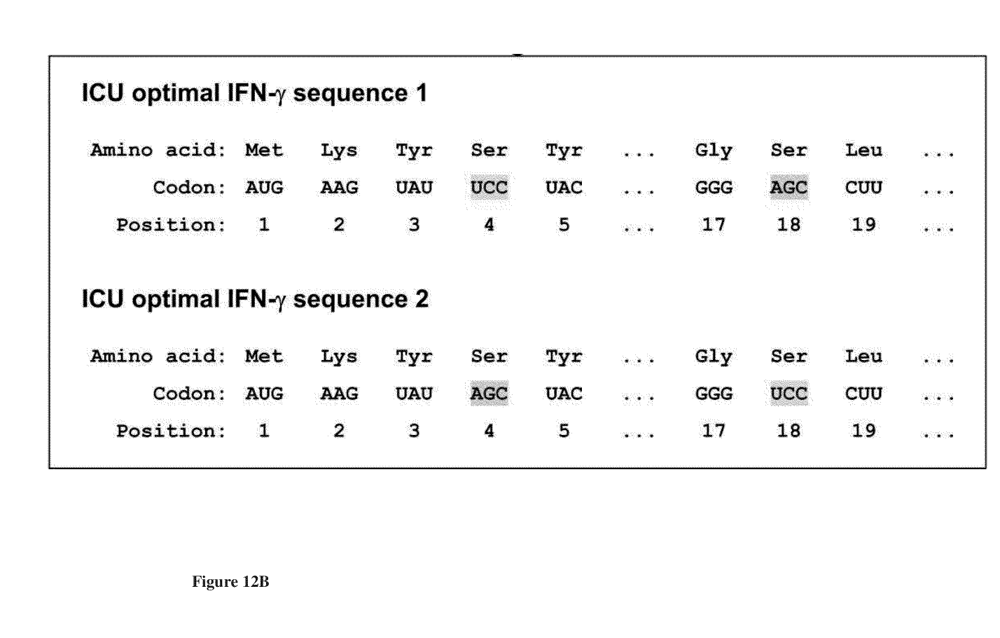

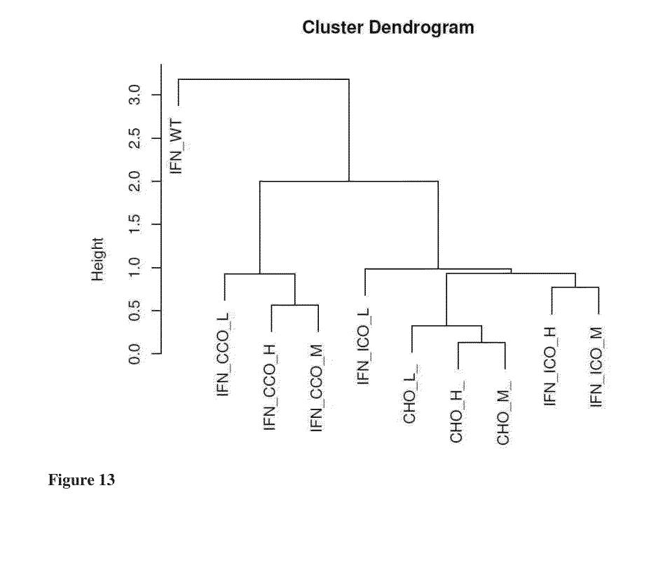

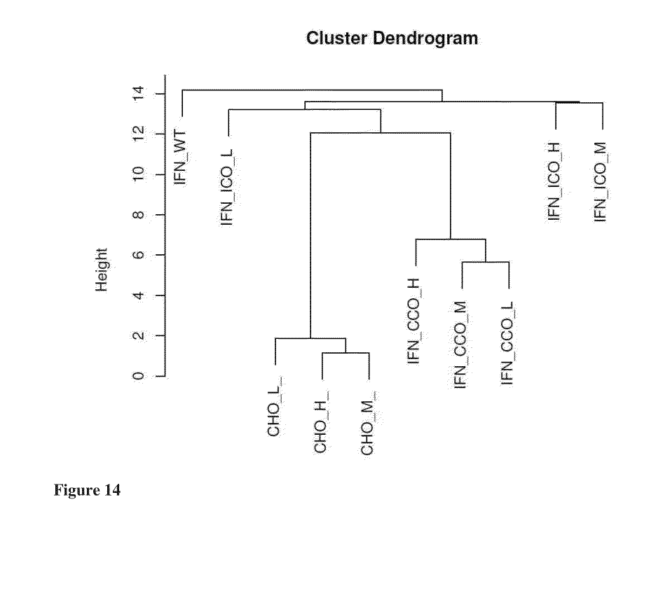

The protein sequence of human IFN-γ was used as the input for the codon optimization algorithms where various codon distributions calculated from the previous section were set as the target reference to obtain the ICU-optimized (IFN_ICO) and CC-optimized (IFN_CCO) coding sequences. The IFN-γ synthetic genes were labeled as “IFN_ICO_H” (or “IFN_CCO_H”), “IFN_ICO_M” (or “IFN_CCO_M”) or “IFN_ICO_L” (or “IFN_CCO_L”) depending on whether they were ICU-optimized (or CCO-optimized) with respect to the H, M or L genes respectively. The nucleotide sequences of these genes can be found in the sequence list 9 and FIGS. 11A-11C. Then, the codon optimized synthetic genes and wild-type IFN-γ genes were expressed transiently in CHO cells. In order to investigate the effects of using H, M or L genes as the reference for codon optimization, the expression activity of the recombinant human IFN-γ synthesized by the various genes were compared. Remarkably, results from ELISA showed that the CC optimized genes (IFN_CCO) produced the best performance with at least 13-fold improvement in protein expression compared to wild-type (IFN_WT) (FIGS. 11A-11C). The differences in expression level among the CC optimized genes are comparable. This corroborates the similar codon patterns of the H, M and L genes, indicating that the selection of H genes to establish the reference codon usage pattern is not necessary applicable to CHO cells. The IFN_ICO_M and IFN_ICO_L genes also showed improved protein expression on an average of 9-fold higher than IFN_WT (FIGS. 11A-11C). Surprisingly, the protein expression of IFN_ICO_H was lower than IFN_WT even though its sequence properties are very similar to those for IFN_ICO_M and IFN_ICO_L (Table 6). It is also found that even after single nucleotide mutations the expression level of the IFN_ICO_H gene still remains low, indicating that the expression of IFN_ICO_H is not sensitive to minor alterations of the coding sequence (see sequence list 10). This anomaly of IFN_ICO_H's in vivo expression can be understood by examining the potential ICU optimized sequence candidates. FIGS. 12A and 12B suggests two possible candidates sharing the same optimal ICU fitness via the interchange of synonymous codons within the sequence. For the entire IFN-γ sequence, there can be more than 100 optimal ICU fitness candidates, of which current IFN_ICO_H may contain undesirable codon context, thus significantly hindering recombinant expression. As such, the IFN_ICO_M and IFN_ICO_L sequences could coincidentally be one of the better ICU optimal sequences while IFN_ICO_H remains poorer recombinant expression. This clearly highlights the major disadvantage of using individual codon-based design parameters such as ICU fitness and CAI.

### Sequence Properties

The fitness and CAI values are calculated using the respective classes of genes as the reference for the host's ICU and CC distributions.

TABLE 6
Sequence properties

| | | ICU | CC | | G + |
|---|---|---|---|---|---|
| Gene | Reference | fitness | fitness | CAI | C (%) |
| IFNG_WT | H | −0.173 | −0.151 | 0.762 | 38.7 |
| | M | −0.177 | −0.151 | 0.754 | |
| | L | −0.189 | −0.151 | 0.670 | |
| IFNG_ICO_H | H | −0.059 | −0.148 | 0.825 | 43.3 |
| IFNG_ICO_M | M | −0.054 | −0.149 | 0.809 | 43.1 |
| IFNG_ICO_L | L | −0.064 | −0.144 | 0.769 | 45.3 |
| IFNG_CCO_H | H | −0.193 | −0.129 | 0.949 | 48.7 |
| IFNG_CCO_M | M | −0.185 | −0.129 | 0.941 | 49.3 |
| IFNG_CCO_L | L | −0.177 | −0.123 | 0.911 | 51.1 |

### 3.3 Conclusions

A practical application of gene optimization to enhance the expression of IFN-γ, a potential immunomodulatory drug, in CHO cells which are widely used in the biopharmaceutical industry for producing therapeutic proteins has been demonstrated in this example. Through the computation of ICU and CC distributions, it is found that the highly, moderately and lowly expressed genes in CHO cells exhibit similar codon usage patterns, unlike the E. coli and S. cerevisiae microbial hosts. This finding was further confirmed by experimental expression of IFN-γ genes optimized with three different classes of genes based on CC fitness. In general, CC-optimized genes exhibit the highest expression levels of at least 13-fold higher than the wild-type IFN-γ, while ICU-optimized genes can only achieve a maximum of 10-fold improvement. Interestingly, one of the ICU-optimized genes had even lower expression than the wild-type IFN-γ, highlighting the drawback of the ICU optimization approach as well as the advantage of using CC fitness as the primary design criterion. Of several factors affecting heterologous protein expression, the recoding of DNA sequence through CC optimization may presumably remove RNA cleavage sites and/or improve mRNA stability, thus giving rise to enhanced recombinant protein expression. Hence, further refinement of the codon optimization technique based on CC fitness can lead to better gene design strategies for efficient heterologous protein expression, which is especially relevant to the field of synthetic biology.

### Normalized Expression of IFN_ICO_H Variants

The entire experiment is repeated together with the IFN_ICO_H variants. Similar to the experiment presented in the present disclosure, the expression levels were normalized with respect to the wild-type IFN-gamma.

TABLE 7
Normalized expression of IFN_ICO_H variants

| Gene | Normalized expression | Standard deviation |
|---|---|---|
| IFNG_WT | 1.000 | 0.241 |
| IFNG_CCO_H | 14.418 | 0.457 |
| IFNG_CCO_M | 12.032 | 0.849 |
| IFNG_CCO_L | 14.515 | 1.021 |
| IFNG_ICO_H | 0.407 | 0.177 |
| IFNG_ICO_H_v1 | 0.466 | 0.068 |
| IFNG_ICO_H_v2 | 0.646 | 0.000 |
| IFNG_ICO_H_v3 | 0.529 | 0.038 |
| IFNG_ICO_H_v4 | 0.435 | 0.028 |
| IFNG_ICO_M | 9.064 | 1.876 |
| IFNG_ICO_L | 12.323 | 0.085 |

### Example 4

### Comparison of Relative Importance of Codon Usage and Codon-Pair Context as Gene Design Parameters for Improving Protein Expression in Pichia pastoris

Codon optimization has been considered as an effective strategy to improve the levels of heterologous protein production in organisms. Two important parameters (individual codon usage (ICU) and codon-pair context (CC)) have been proposed as design parameters for codon optimization. In the present example, the relative importance of ICU and CC toward designing gene sequences for codon optimization was investigated, using Saccharomyces cerevisiae-derived mating factor α prepro-leader sequence (MFLS) as a model system.

Three variant MFLSs were designed with respect to ICU and CC distribution of the highly expressed genes found in Pichia pastoris: MFLS_{ICO} for ICU-optimum, MFLS_{CCO} for CC-optimum and MFLS_{MOCO} for both ICU-/CC-optimum. The effects of three variants on secretory production of Candida antarctica-derived lipase B (CalB) as reporter from P. pastoris were compared. All codon-optimized MFLS variants markedly improved secretory production of CalB as a reporter in P. pastoris, compared with the wild-type MFLS. However, MFLS_{CCO} improved the secretary production of CalB in P. pastoris to 1.7-fold that of MFLS_{ICO}.

These results could indicate that CC fitness may be a more relevant design parameter for optimizing the sequence for improvement of heterologous protein expression than ICU fitness, which has been adopted as a key element of the conventional practice for codon optimization.

Codon preferences in organisms have been generally acknowledged to reflect a balance between the action of mutation, selection, and gentry drift for translational optimization. It has been demonstrated that codon usage correlates to gene expression level, especially in fast-growing microorganisms. Consequently, codon optimization has been considered as an effective strategy to improve the levels of heterologous protein production in organisms.

Two typical gene primary structure features have been proposed as design parameters for codon optimization: the first one is the individual codon usage (ICU) bias, which refers to the difference in the frequency of occurrence of synonymous codons in individual genes, and the second one is the codon-pair context (CC) bias, which implicates some rules for organizing neighboring codons as a result of potential tRNA-tRNA steric interactions within the ribosomes. An ICU-based codon optimization (ICO) algorithm has been implemented in many of the sequence design software tools, such as Codon optimizer, Gene Designer and OPTIMIZER. ICO has been applied to the codon optimization of numerous genes, leading to enhanced protein expression levels in many cases. It has also been demonstrated in synthetic attenuated virus engineering that the manipulation of CC bias affects the translation elongation rate such that the usage of rare codon pairs decreased protein translation rates. This suggests that CC-based codon optimization (CCO) can be a promising approach to design synthetic genes for recombinant expression.

A multi-objective codon optimization (MOCO) method which simultaneously considers both ICU and CC is introduced in the present disclosure. The relative importance of ICO, CCO, and MOCO strategies is evaluated in enhancing protein expression in four different microbial hosts: Escherichia coli, Lactobacillus lactis, Pichia pastoris and Saccharomyces cerevisiae, using novel computational procedures. The in silico validation of the optimized genes suggested that CC is a more relevant design criterion than ICU, contrary to much speculation. Furthermore, the consideration of ICU in addition to CC is detrimental to the sequence design, since the MOCO sequence has a lower performance than the CCO sequence.

In the present example, to experimentally investigate the relative importance of ICU and CC towards designing sequences for improved protein expression, Saccharomyces cerevisiae-derived mating factor α prepro-leader sequence (MFLS), widely used for secretion of correctly folded heterologous proteins to the fermentation medium in yeast species, was codon-optimized by Pichia pastoris-preferred ICU, CC and MOCO strategies. The effects of the three variants on secretory heterologous protein expression from P. pastoris were then compared.

### 4.1 Three Alternative Strategies for Codon Optimization of MFLS

To compare the relative importance of ICU and CC towards gene design for improving protein expression, S. cerevisiae-derived mating factor α prepro-leader sequence (MFLS) was chosen as a model system. Three alternative strategies for codon optimization were applied to P. pastoris, designing MFLS by three computational procedures: the individual codon usage optimization (ICO) method for ICU-optimal sequence; the codon context optimization (CCO) method for CC-optimal sequence; and the multi-objective codon optimization (MOCO) method for ICU-/CC-optimal sequence. The ICU and CC were optimized with respect to the ICU and CC distribution of the highly expressed genes found in P. pastoris expression host.

### 4.2 Codon-Optimized Sequences of MFLS

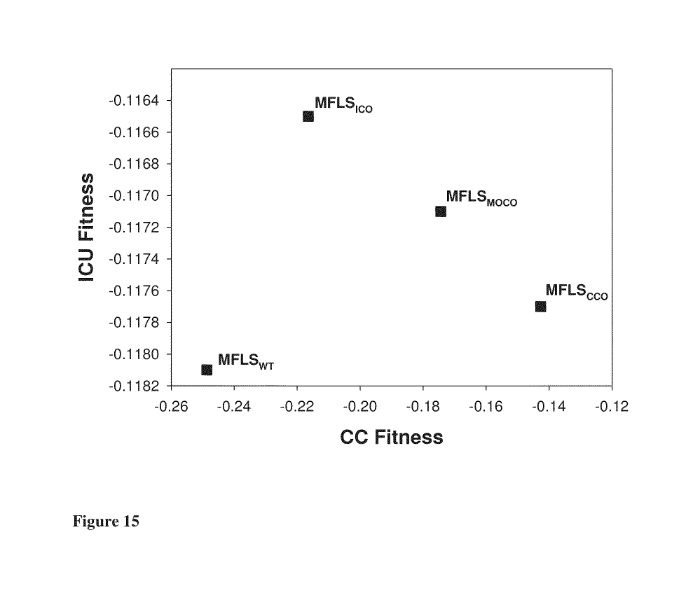

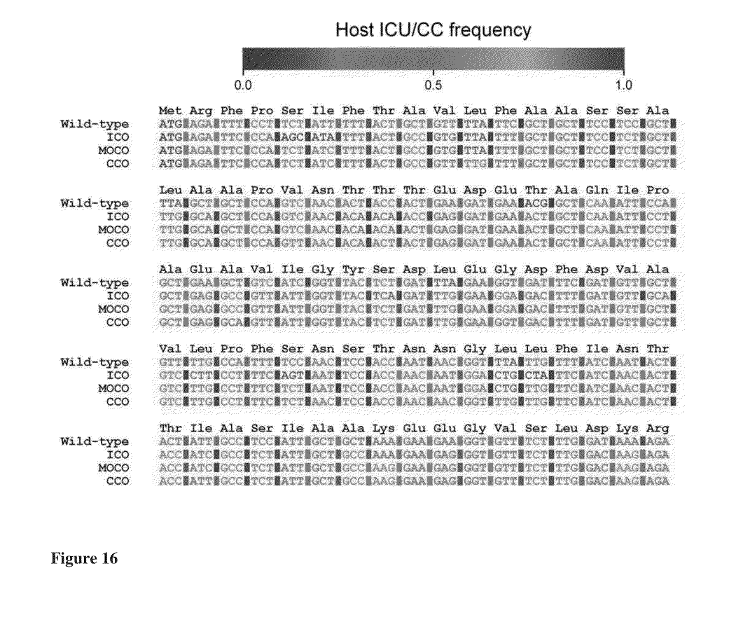

Among sequences in the pareto optimum front generated by the strategies applied in the present example, the MFLS_{ICO} sequence has the best ICU fitness, but the worst CC fitness; the MFLS_{MOCO} sequence has median ICU fitness and median CC fitness; the MFLS_{CCO} has the best CC fitness but has the worst ICU fitness (FIG. 15). A comparison of the codon usage patterns of the wild-type and three codon-optimized MFLS variants are shown in FIG. 16.

### 4.3 Comparison of Effects of Codon-Optimized MFLS on Protein Expression Level

To examine the effect of the applied codon optimization strategies on protein expression in P. pastoris, wild-type and three codon-optimized MFLS variants were fused to the N-terminus of CalB as a reporter, and were placed under the control of the constitutive P_{TEF}. Each constructed expression vector was transformed into P. pastoris GS115 and the lipase activities in the culture supernatant of two corresponding transformants were then analyzed. As shown in Table 8, all codon-optimized MFLS variants markedly improved the secretory production of CalB from P. pastoris compared to that of the wild-type MFLS (MFLS_{WT}). However, MFLS_{CCO} increased the secretory production of CalB by 3.95-fold, while MFLS_{CCO} increased it by 2.32-fold, as the lowest observed increase of any variant. These results suggest that sequences with higher CC fitness are more likely to exhibit higher in vivo expression than sequences with higher ICU fitness.

TABLE 8
Comparison of secreted lipase activity of the variants of MFLS

| | Cell density¹ | CalB activity² | Normalized |
|---|---|---|---|
| Sequence | (A600) | (U/mL) | activity (%) |
| Wild-type | 12.2 ± 0.4 | 3.03 ± 0.20 | 100 |
| MFLS_{ICO} | 11.9 ± 0.5 | 7.02 ± 1.08 | 232 |
| MFLS_{MOCO} | 12.4 ± 0.2 | 10.33 ± 0.20 | 341 |
| MFLS_{CCO} | 11.9 ± 0.3 | 11.97 ± 0.09 | 395 |

^{1,2}Cell density and CalB activity were measured at the end of culture (48 h).

At the mRNA translation level, ICU and CC are expected to be under selective pressure, because it has been demonstrated that they affect mRNA decoding speed and accuracy. However, there have been no studies which compare the relative importance of ICU and CC as the gene design parameter for codon optimization, used to achieve optimum expression of a foreign gene based on the specific nature of the host system, although it is evaluated through in silico validation of highly expressed genes in four microbial hosts with novel computational procedures. Nevertheless, ICU has been considered to be a key parameter of the conventional practice for codon optimization of many heterologous genes. In the present example, to experimentally investigate their relative importance, MFLS genes are chosen as a model due to their wide use as signal sequences for protein secretion in heterologous yeast species, as well as the suspected improved secretory production of heterologous proteins due to its codon-optimization.

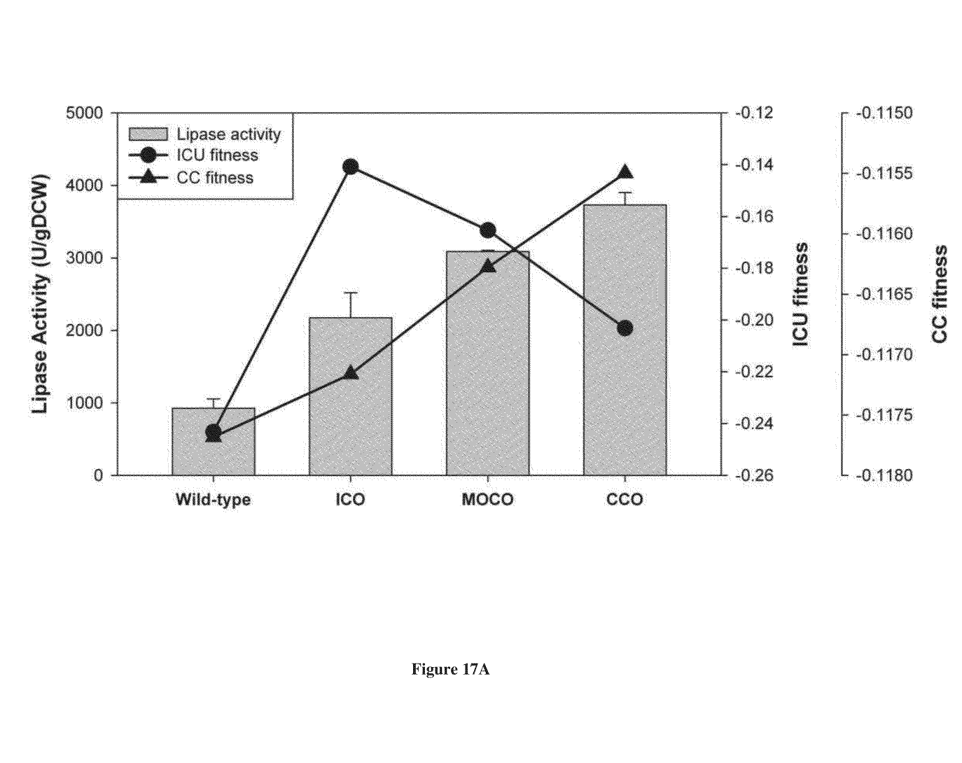

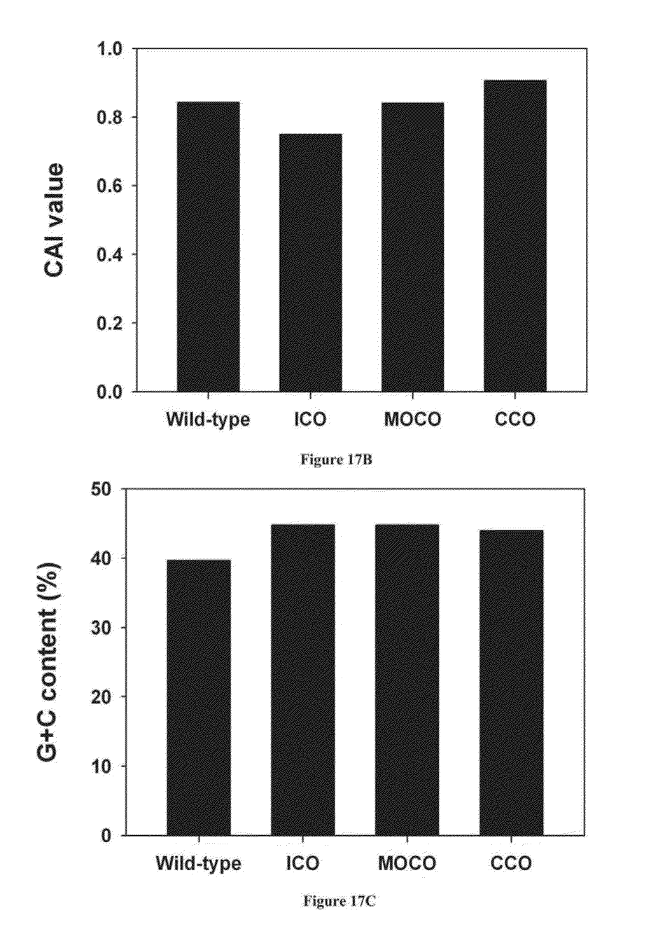

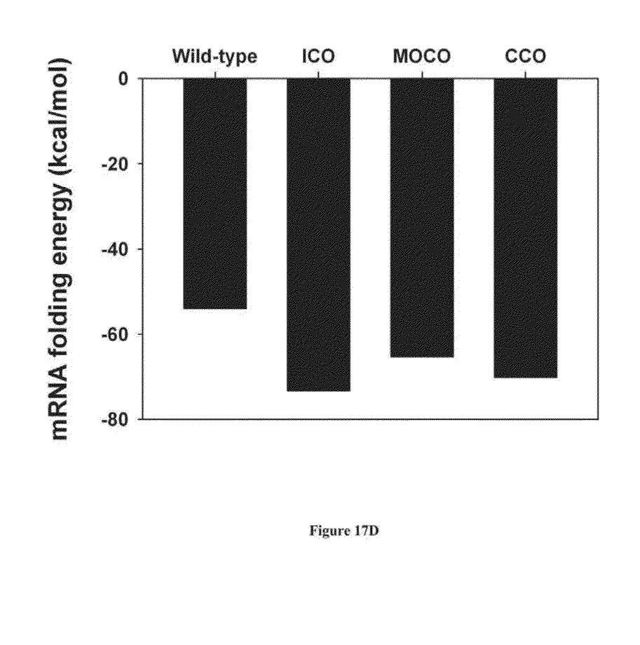

Three variants were designed and synthesized to evaluate the effect of three gene design strategies (ICO, CCO and MOCO) on the secretory production of a heterologous protein in P. pastoris. In all cases, the sequences created using three codon optimization strategies provided significantly more protein than the non-optimized sequence. However, the comparison of three codon-optimized strategies on the protein expression level demonstrated that CCO produced a 1.7-fold greater increase in protein expression than ICO. Also, it was observed that consideration of both ICU and CC fitness did not synergistically improve the protein expression levels. To further examine the correlation between various coding sequence properties and gene expressivity, the G+C content, codon adaptation index (CAI) and mRNA folding energy is also evaluated. G+C contents showed almost the same values in three variants (43.92% for MFLS_{CCO} and 44.71% for MFLS_{ICO} and MFLS_{MOCO}). CAI values have been considered as a design parameter for codon optimization in earlier studies. Although a positive relationship between CAI and gene expressivity can be observed for MFLS_{CCO}, MFLS_{ICO} and MFLS_{MOCO}, this correlation fails when considering the CAI of wild-type MFLS which is similar to that of MFLS_{MOCO} (FIGS. 17A and 17B). The mRNA folding energy predicted by the mfold web server indicated that the potential secondary structures of the codon optimized sequences are more stable that the wild-type MFLS (FIG. 17D). This suggests that the inhibition of translation attributed to more stable mRNA secondary structures may be negligible in these gene variants. Therefore, only CC fitness in MFLS variants correlated well to gene expressivity (FIGS. 17A-17D). These results are consistent with previous in silico validation, through implementation of ICO and CCO with high-expression genes of four microbial hosts. Thus, the present example supports the previous suggestion, that contrary to the conventional practice which adopts ICU optimization as a key element of gene design, CC fitness is a more relevant design parameter for optimizing sequences for improvement of heterologous protein expression.

Additionally, it should be noted that, codon optimized signal peptides can enhance the overall expression of heterologous protein in P. pastoris several-fold. It is thought that the MFLS_{CCO} designed in the present example will be useful in the secretory production of heterologous proteins in P. pastoris. Furthermore, the present example provides valuable information towards the understanding of the mode of translational selection of protein coding genes, as well as gene design for codon optimization.

Three alternative strategies (ICO, CCO and MOCO) for codon optimization were compared in P. pastoris, using MFLS as a model system. By determining the relative importance of the three strategies using the secretary production of CalB as a reporter, CC fitness was determined to be a more relevant design parameter for optimizing the sequence improvement in heterologous protein expression, than ICU fitness, which has been adopted as a key element in the conventional practice for codon optimization. The present example provides valuable information towards the understanding of the mode of translational selection of protein coding genes, as well as gene design for codon optimization.

### 4.4 Methods

### 4.4.1 Microorganisms

E. coli DH5α [F⁻, endA1, hsdR17 (r_{K}⁻ m_{K}⁻), supE44, thi-l, λ⁻, recA1, gyrA96, 80d lacZDM15] was used as a host strain for the cloning and maintenance of plasmids. P. pastoris GS115 [his4] (Invitrogen, USA) was used as host strain for secretory heterologous protein expression.

### 4.4.2 Codon Optimization, Gene Synthesis and Cloning

Three variants of MFLSs were designed with respect to ICU and CC distribution of the highly expressed genes found in Pichia pastoris, using previously presented computational codon optimization program, and they were synthesized by Bioneer corp. (Republic of Korea). To verify and characterize three variant MFLSs, a lipase gene, a variant (CALB14) of lipase B from Candida antarctica (CALB), was used as a reporter. The CALB14 structural gene was previously synthesized according to the preferred codon usage of P. pastoris (data not shown). The wild-type and three codon-optimized MFLSs, the strong constitutive TEF promoter (P_{TEF}) and CALB14 were amplified by PCR with the corresponding templates and primers which are listed in Table 9, respectively. Then, overlapping PCRs were performed to generate a fragment sequentially containing the P_{TEF}, MFLS and CALB14. Each aligned gene was inserted into the SmaI/NotI-digested pPIC9 (Invitrogen, USA) by infusion kit (In-Fusion® Advantage PCR Cloning Kit, Clontech, USA). In each constructed plasmid, the CALB14 structural gene, fused to the MFLS, was placed under the control of P_{TEF}.

TABLE 9
Primers used in the present example

| Target | | |
|---|---|---|
| gene | Primer Sequence (F: forward, R: reverse) | Template |
| P_{TEF} | F: 5′- [symbol] ATAACTGTCGCCTCTTTTATC-3′ | pTEF-AM- |
| | R: 5′-GTAAAGATAGATGGGAATCTCATGTTGGCGAATAACTAAAATG-3′ | CLLip |
| | (for fusion of MFLS_{CCO} and MFLS_{MOCO}) | |
| | 5′-GTAAAGATAGATGGGAATCTCATGTTGGCGAATAACTAAAATG-3′ | |
| | (for fusion of MFLS_{ICU}) | |
| MFLS | F: 5′-CATTTTAGTTATTCGCCAACATGAGATTCCCATCTATCTTTAC-3′ | The MFLSs |
| | (for MFLS_{CCO} and MFLS_{MOCO}), | synthesized in |
| | 5′-CATTTTAGTTATTCGCCAACATGAGATTCCCAAGCATATTTAC-3′ | the present |
| | (for MFLS_{ICU}) | disclosure |
| | R: 5′-GAAAGCTGGGTCGGAACCGGATGGCAATCTCTTGTCCAAAGAAACACC-3′ | |
| CALB14 | F: 5′-GTGTTTCTTTGGACAAGAGATTGCCATCCGGTTCCGACCCAGCTTTC-3′ | pGAL-MFa- |
| | R: 5′-CATGTCTAAGGCGAATTAATTC [symbol] TTATGGAGTAACGATACCGGA- | CALB14 |
| | 3′ | |

4.4.3 Expression of CalB as a Reporter in P. pastoris

The constructed plasmids were linearized by StuI which digests the sole restriction site present in the HIS4 gene, and the linearized plasmids were integrated into the genome of the P. pastoris GS115 using a lithium chloride transformation method (Invitrogen, USA). Selection of transformants was performed using His⁻ agar plates containing (per liter): 20 g of glycerol, 6.7 g of yeast nitrogen base without amino acids, 0.77 g of His⁻ DO supplement (BD Biosciences, USA), and 20 g of agar. A single colony of each transformant grown on a His⁻ agar plate was inoculated into 10 mL of YPD medium in a 250 ml baffled flask, and was incubated for 14 h at 30° C. Five ml of the culture was transferred to a 500 mL baffled flask containing 100 mL of YPD broth and was incubated overnight at 30° C. for 48 h. The growth of yeast cells was monitored by measuring the optical density at 600 nm (OD₆₀₀) (UVICON930, Switzerland). The lipase activities of the culture supernatants were determined by measuring the release of p-nitrophenol by the action of an enzyme on the substrate p-nitrophenyl palmitate (pNPP). One unit of lipase activity was defined as the amount of enzyme releasing one μmole of p-nitrophenol per min.

### 4.4.4 Calculation of ICU and CC Fitness

The host's ICU frequency of codon k₁ (p₀^{k}^{₁}) and CC frequency of codon pair k₂ (q₀^{k}^{₂}) are calculated as follows:

$${p}_{0}^{{k}_{1}} = \frac{{θ}_{C , 0}^{{k}_{1}}}{{θ}_{A , 0}^{{j}_{1}}} ∀ {k}_{1} ∈ \{ 1 , 2 , … , 64 \} ; {k}_{1} \to {j}_{1}$$

$${q}_{0}^{{k}_{1}} = \frac{{θ}_{CC , 0}^{{k}_{2}}}{{θ}_{AA , 0}^{{j}_{2}}} ∀ {k}_{2} ∈ \{ 1 , 2 , … , 3904 \} ; {k}_{2} \to {j}_{2}$$

The symbols θ_{C,0}^{K}^{₁} and θ_{CC,0}^{k}^{₂} refer to the numbers of occurrences of codon k₁ and codon pair k₂, respectively. θ_{A,0}^{j}^{₁} and θ_{AA,0}^{j}^{₂} indicate the number of occurrences of the corresponding amino acid and amino acid pairs encoded by k₁ and k₂, respectively. In the above mathematical expression, k₁→j₁ and k₂→j₂ indicates that codon k₁ codes for amino acid j₁ and codon pair k₂ codes for amino acid pair j₂. The subscript 0 indicates that the frequencies are calculated based on the expression host's wild-type gene sequences. On the other hand, subscript 1 was used to indicate the recombinant gene's frequencies. Based on the above quantification of codon frequencies, the ICU and CC fitness values were computed by taking the normalized Manhattan distance between the host's frequencies (p₀^{k}^{₁} and q₀^{k}^{₂}) and the recombinant gene's frequencies (p₁^{k}^{₁} and q₁^{k}^{₂}) as follows:

$$ICU fitness \text{:} {Ψ}_{ICU} = - \frac{{\sum }_{{k}_{1} = 1}^{64} \vert {p}_{0}^{{k}_{1}} - {p}_{1}^{{k}_{1}} \vert}{64}$$

$$CC fitness \text{:} {Ψ}_{CC} = - \frac{{\sum }_{{k}_{2} = 1}^{3904} \vert {q}_{0}^{{k}_{2}} - {q}_{1}^{{k}_{2}} \vert}{3904}$$

The multi-objective optimization of ICU and CC fitness was performed using the non-dominated sorting genetic algorithm (NSGA-II). The detailed implementation of the algorithm has been described in an earlier paper.

While various aspects and embodiments have been disclosed herein, it will be apparent that various other modifications and adaptations of the invention will be apparent to the person skilled in the art after reading the foregoing disclosure without departing from the spirit and scope of the invention and it is intended that all such modifications and adaptations come within the scope of the appended claims. The various aspects and embodiments disclosed herein are for purposes of illustration and are not intended to be limiting, with the true scope and spirit of the invention being indicated by the appended claims.

1. A computer implemented method of optimization of a nucleotide coding sequence coding for a predetermined amino acid sequence, wherein the nucleotide coding sequence is optimized for expression in a predetermined host cell, the method comprising:
automatically generating at least two initial nucleotide coding sequences coding for the predetermined amino acid sequence to form a first population of initial nucleotide coding sequences coding for the predetermined amino acid sequence; and
automatically dividing the first population of initial nucleotide coding sequences.

2. The method of claim 1, further comprising:
automatically determining a fitness value for each of the initial nucleotide coding sequences of the first population using a fitness function that determines codon context fitness for the predetermined host cell.

3. The method claim 2, further comprising:
automatically ranking each of the initial nucleotide coding sequences of the first population according to the fitness value of each of the initial nucleotide coding sequences of the first population.

4. The method of claim 3,
wherein the dividing comprises automatically dividing the first population of initial nucleotide coding sequences according to the fitness value ranking of each of the initial nucleotide coding sequences of the first population, wherein the top fifty percent of the initial nucleotide coding sequences having the highest fitness value ranking are selected as first parent nucleotide coding sequences.

5. The method of claim 4, further comprising:
automatically producing first offspring nucleotide coding sequences via recombination and/or mutation of the first parent nucleotide coding sequences.

6. The method of claim 5, further comprising:
automatically combining the first offspring nucleotide coding sequences and the first parent nucleotide coding sequences to form a second population of nucleotide coding sequences.

7. The method of claim 6, further comprising:
automatically determining a fitness value for each of the nucleotide coding sequences of the second population using a fitness function that determines codon context fitness for the predetermined host cell;
automatically ranking each of the nucleotide coding sequences of the second population according to the fitness value of each of the nucleotide coding sequences of the second population;
automatically dividing the second population of nucleotide coding sequences according to the fitness value ranking of each of the nucleotide coding sequences of the second population, wherein the top fifty percent of the nucleotide coding sequences of the second population having the highest fitness value ranking are selected as a second parent nucleotide coding sequences;
automatically producing second offspring nucleotide coding sequences via recombination and/or mutation of the second parent nucleotide coding sequences; and
automatically combining the second offspring nucleotide coding sequences and the second parent nucleotide coding sequences to form a third population of nucleotide coding sequences.

8. The method of claim 7, wherein the optimization of the nucleotide coding sequence coding for the predetermined amino acid sequence is automatically repeated until a predetermined termination criterion is met.

9. A system comprising:
a processing unit;
a memory unit comprising an optimizing module, wherein the optimizing module comprises a set of program instructions executable by the processing unit;
wherein execution of the set of program instructions causes the processing unit to optimize a nucleotide coding sequence coding for a predetermined amino acid sequence, wherein the nucleotide coding sequence is optimized for expression in a predetermined host cell, the optimization comprising:
automatically generating at least two initial nucleotide coding sequences coding for the predetermined amino acid sequence to form a first population of initial nucleotide coding sequences coding for the predetermined amino acid sequence; and
automatically dividing the first population of initial nucleotide coding sequences.

10. The system of claim 9, wherein the optimization further comprises:
automatically determining a fitness value for each of the initial nucleotide coding sequences of the first population using a fitness function that determines codon context fitness for the predetermined host cell.

11. The system of claim 10, wherein the optimization further comprises:
automatically ranking each of the initial nucleotide coding sequences of the first population according to the fitness value of each of the initial nucleotide coding sequences of the first population.

12. The system of claim 11, wherein the optimization further comprises:
wherein the dividing comprises automatically dividing the first population of initial nucleotide coding sequences according to the fitness value ranking of each of the initial nucleotide coding sequences of the first population, wherein the top fifty percent of the initial nucleotide coding sequences having the highest fitness value ranking are selected as first parent nucleotide coding sequences.

13. The system of claim 12, wherein the optimization further comprises:
automatically producing first offspring nucleotide coding sequences via recombination and/or mutation of the first parent nucleotide coding sequences.

14. The system of claim 13, wherein the optimization further comprises:
automatically combining the first offspring nucleotide coding sequences and the first parent nucleotide coding sequences to form a second population of nucleotide coding sequences.

15. The system of claim 14, wherein the optimization further comprises:
automatically determining a fitness value for each of the nucleotide coding sequences of the second population using a fitness function that determines codon context fitness for the predetermined host cell;
automatically ranking each of the nucleotide coding sequences of the second population according to the fitness value of each of the nucleotide coding sequences of the second population;
automatically dividing the second population of nucleotide coding sequences according to the fitness value ranking of each of the nucleotide coding sequences of the second population, wherein the top fifty percent of the nucleotide coding sequences of the second population having the highest fitness value ranking are selected as a second parent nucleotide coding sequences;
automatically producing second offspring nucleotide coding sequences via recombination and/or mutation of the second parent nucleotide coding sequences; and
automatically combining the second offspring nucleotide coding sequences and the second parent nucleotide coding sequences to form a third population of nucleotide coding sequences.

16. The system of claim 15, wherein the optimization of the nucleotide coding sequence coding for the predetermined amino acid sequence is automatically repeated until a predetermined termination criterion is met.
